(19) United States
(12) Patent Application Publication
(10) Pub. No.: US 2007/0292680 A1
(43) Pub. Date: Dec. 20, 2007

(54) Optical film, production method of optical film, polarizing plate and liquid crystal display device

(75) Inventors: Hajime Nakayama, Kanagawa (JP); Susumu Sugiyama, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM CORPORATION, Tokyo (JP)

(21) Appl. No.: 11/808,703

(22) Filed: Jun. 12, 2007

(30) Foreign Application Priority Data
Jun. 12, 2006 (JP) 2006-162451
Jun. 12, 2006 (JP) 2006-162531

(51) Int. Cl. G11B 11/105

(52) U.S. Cl. 428/332

(57) ABSTRACT

An optical film having a value of 1.6 or more, wherein the value is obtained by dividing a larger value by a smaller value of the maximum X-ray diffraction intensity within a range 2θ=10 to 40° in a longitudinal direction of the film and the maximum X-ray diffraction intensity within a range 2θ=10 to 40° in a direction approximately vertical to the longitudinal direction of the film, and an optical film having a value of 1.3 or more, wherein the value is obtained by dividing a larger value by a smaller value of a tensile elastic modulus in a longitudinal direction of the film and a tensile elastic modulus in a direction approximately vertical to the longitudinal direction of the film.

### BACKGROUND OF THE INVENTION

1. Field of the Invention

The present invention relates to an optical film, a method for producing the optical film, a polarizing plate and a liquid crystal display device.

2. Description of the Related Art

A liquid crystal display device (sometimes abbreviated as LCD hereinafter) comprises a liquid cell and a polarizing plate. The polarizing plate comprises an optical film, namely a protective film generally comprising cellulose acetate and a polarizing film, and is produced for example by dying a polarizing film comprising a polyvinyl alcohol film with iodine and then stretching the resulting film, and laminating a protective film on both the surfaces thereof. In some transmission-type liquid crystal display device, a polarizing plate may be mounted on both the sides of a liquid crystal cell, on which one or more sheets of an optically compensatory film may be arranged. In a reflection-type liquid crystal display device, generally, there are arranged a reflection plate, a liquid crystal cell, one or more sheets of an optically compensatory film, and a polarizing plate in this order. The liquid crystal cell comprises a liquid crystal molecule, two sheets of a substrate for sealing the molecule therein, and an electrode layer for applying an electric voltage to the liquid crystal molecule. Depending on the difference in the aligned state of the liquid crystal molecule, the liquid crystal cell switches ON- and OFF displays and is applicable to any liquid crystal cell apparatuses of transmission type and reflection type. Display modes such as TN (twisted nematic) mode, IPS (in-plane switching) mode, OCB (optically compensatory bend) mode, VA (vertically aligned) mode, and ECB (electrically controlled birefringence) mode have been proposed.

Among such LCDs, a liquid crystal display device of 90-degree twisted nematic mode (referred to as TN mode hereinafter) using a nematic liquid crystal molecule with a positive dielectric anisotropy and operating with a thin-film transistor is mainly used for applications requiring high-quality display. Although the TN mode has a great display profile when observed in the front direction, the TN mode is at a decreased contrast when observed in a slanting direction, so that the TN mode has such a viewing angle feature that the display profile is deteriorated due to the occurrence of gradation inversion involving the inversion of brightness on gradation display. Thus, it has been desired strongly to improve the feature.

In the related arts, further, it has been known that a retardation plate for polymer-aligned films, particularly a ¼-wavelength plate should satisfy the formulas 0.6<Δn·d (450)/Δn·d (550)<0.97 and 1.01<Δn·d (650)/Δn·d (550)<1.35 (where Δn·d (λ) represents the retardation of a polymer-aligned film at a wavelength λ unit: nm)(See JP-A-2000-137116).

### SUMMARY OF THE INVENTION

JP-A-2000-137116 discloses an art of increasing an in-plane retardation (Re) in accordance with increase of a wavelength, but the art cannot control a retardation in a thickness direction (Rth) within a desirable range. For the optical film used for the recent liquid crystal display, the control of both Re and Rth at respective wavelengths is desired. Also, the control of physical properties of the film in the stretch direction and the direction vertical to the stretch direction after stretching the film is desired. Following the recent increase of demands toward liquid crystal TV sets, the liquid crystal modes with wide viewing angles such as the IPS mode, the OCB mode and the VA mode have increasingly been marketed and distributed. The individual modes have got improved display quality year by year. However, the problem of color shift emerging when observed in a slanting direction cannot be overcome yet.

Following the spread of liquid crystal TV sets, the larger display assembly therein and the highly bright preparation of the backlights thereof, in recent years, display unevenness and optical slip have also drawn concerns disadvantageously. It is strongly desired to overcome unevenness generated in the periphery of pictures after exposure to a severe change of temperature or humidity. In the above-mentioned JP-A-2000-137116, these problems are not presented and the solutions for the problems are not proposed.

In such circumstances, the invention has been achieved. The invention provides an optical film particularly for use in the VA, IPS and OCB modes, which yields a high contrast and has got improvement in color shift emerging in a manner dependent on the viewing angle direction during black display; a method for producing an optical film, and the optical film produced by the method; a polarizing plate and a liquid crystal display device, using the same.

The invention also provides an optical film particularly for use in the VA, IPS and OCB modes, which yields a high contrast and has got the improvement in color shift emerging in a manner dependent on the viewing angle direction during black display, never involving any change of the display level even with the occurrence of a change in temperature, humidity, etc.; a method for producing an optical film, and the optical film produced by the method; and a polarizing plate and a liquid crystal display device using the same.

So as to securely permit an optically compensatory potency sufficiently enough as an optically film, an optical film should have desired retardation so as to compensate the retardation of a liquid crystal cell. Generally, the retardation more readily develops, as the alignment level of a polymer in an optical film is higher.

Alternatively, the direction involving a high in-plane level of X-ray diffraction intensity is approximately parallel to the stretch direction of the film. This corresponds to the in-plane alignment of a polymer molecule in the film in a direction approximately parallel to the stretch direction. In other words, the value of the X-ray diffraction intensity reflects the alignment level of the polymer in the film in a specific direction.

The present inventors found that by determining which one of the X-ray diffraction intensity in the longitudinal direction of the film and the X-ray diffraction intensity in a direction approximately vertical to the longitudinal direction of the film is a larger value and which one thereof is a smaller value, then dividing the larger value with the smaller value and then bringing the resulting value to a specific value or more, the retardation of an optical film could more readily be preset at a value close to a desired value, and that a high contrast level could be obtained in a liquid crystal display device equipped with such optical film. Additionally, the inventors found that the color shift depending on the viewing angle during black display in the liquid crystal display device could be improved.

The approaches for achieving the objects of the invention are specifically described below.

[1] An optical film having a value of 1.6 or more,

wherein the value is obtained by dividing a larger value by a smaller value of the maximum X-ray diffraction intensity within a range 2θ=10 to 40° in a longitudinal direction of the film and the maximum X-ray diffraction intensity within a range 2θ=10 to 40° in a direction approximately vertical to the longitudinal direction of the film.

[2] The optical film as described in [1], which satisfies the following formulas (I) to (III):

0.4<|(Re(450)/Rth(450))/(Re(550)/Rth(550))|<0.95 (I):

and

1.05<{(Re(650)/Rth(650))/(Re(550)/Rth(550))}<1.9

0.1<(Re(450)/Re(550))<0.95 (II):

1.03<(Re(650)/Re(550))<1.93, (III):

wherein Re(λ) represents an in-plane retardation Re (unit: nm) at a λ nm wavelength; and

Rth(λ) represents a retardation in a thickness direction Rth (unit: nm) at a λ nm wavelength.

A production method of the optical film as described in [1], comprising:

a stretch step of stretching a film having a thickness of 40 to 150 μm; and

a shrink step of shrinking the film in a direction approximately vertical to the stretch direction.

[4] An optical film produced by the production method as described in [3], having a value of 1.6 or more,

wherein the value is obtained by dividing a larger value by a smaller value of the maximum X-ray diffraction intensity within a range 2θ=10 to 40° in a longitudinal direction of the film and the maximum X-ray diffraction intensity within a range 2θ=10 to 40° in a direction approximately vertical to the longitudinal direction of the film.

[5] The optical film as described in [1],

wherein Re(550) is within a range of 20 to 150 nm; and

Rth(550) is within a range of 100 to 300 nm.

[6] An optical film having a value of 1.3 or more,

wherein the value is obtained by dividing a larger value by a smaller value of a tensile elastic modulus in a longitudinal direction of the film and a tensile elastic modulus in a direction approximately vertical to the longitudinal direction of the film.

[7] The optical film as described in [6], which satisfies the following formulas (I) to (III):

0.4<|(Re(450)/Rth(450))/(Re(550)/Rth(550))|<0.95 (I):

and

1.05<{(Re(650)/Rth(650))/(Re(550)/Rth(550))}<1.9

0.1<(Re(450)/Re(550))<0.95 (II):

1.03<(Re(650)/Re(550))<1.93, (III):

wherein Re(λ) represents an in-plane retardation Re (unit: nm) at a λ nm wavelength; and

Rth(λ) represents a retardation in a thickness direction Rth (unit: nm) at a λ nm wavelength.

[8] A production method of the optical film as described in [6], comprising:

a stretch step of stretching a film having a thickness of 40 to 150 μm; and

a shrink step of shrinking the film in a direction approximately vertical to the stretch direction.

[9] An optical film produced by the production method as described in [8], having a value of 1.3 or more,

wherein the value is obtained by dividing a larger value by a smaller value of a tensile elastic modulus in a longitudinal direction of the film and a tensile elastic modulus in a direction approximately vertical to the longitudinal direction of the film.

[10] The optical film as described in [6],

wherein Re(550) is within a range of 20 to 150 nm; and

Rth(550) is within a range of 100 to 300 nm.

[11] The optical film as described in [1], comprising a cellulose acylate.

[12] The optical film as described in [6], comprising a cellulose acylate.

[13] The optical film as described in [11], which satisfies the following formulas (IV) and (V):

2.0≦(DS2+DS3+DS6)≦3.0 (IV):

DS6/(DS2+DS3+DS6)≧0.315, (V):

wherein DS2 represents a degree of substitution of a hydroxyl group by an acyl group at a 2-position in a glucose unit of the cellulose acylate;

DS3 represents a degree of substitution of a hydroxyl group by an acyl group at a 3-position in a glucose unit of the cellulose acylate; and

DS6 represents a degree of substitution of a hydroxyl group by an acyl group at a 6-position in a glucose unit of the cellulose acylate.

[14] The optical film as described in [12], which satisfies the following formulas the following formulas (IV) and (V):

2.0≦(DS2+DS3+DS6)≦3.0 (IV):

DS6/(DS2+DS3+DS6)≧0.315, (V):

wherein DS2 represents a degree of substitution of a hydroxyl group by an acyl group at a 2-position in a glucose unit of the cellulose acylate;

DS3 represents a degree of substitution of a hydroxyl group by an acyl group at a 3-position in a glucose unit of the cellulose acylate; and

DS6 represents a degree of substitution of a hydroxyl group by an acyl group at a 6-position in a glucose unit of the cellulose acylate.

[15] The optical film as described in [11], substantially comprising a cellulose acylate satisfying the formulas (VI) and (VII):

2.0≦A+B≦3.0 (VI):

0<B, (VII):

wherein A represents a degree of substitution of a hydroxyl group by an acetyl group in a glucose unit of the cellulose acylate; and

B represents a degree of substitution of a hydroxyl group by a propionyl group, butyryl group or benzoyl group in a glucose unit of the cellulose acylate.

[16] The optical film as described in [12], substantially comprising a cellulose acylate satisfying the formulas (VI) and (VII):

2.0≦A+B≦3.0 (VI):

0<B, (VII):

wherein A represents a degree of substitution of a hydroxyl group by an acetyl group in a glucose unit of the cellulose acylate; and

B represents a degree of substitution of a hydroxyl group by a propionyl group, butyryl group or benzoyl group in a glucose unit of the cellulose acylate.

[17] The optical film as described in [1], comprising a retardation developer.

[18] The optical film as described in [6], comprising a retardation developer.

[19] A polarizing plate comprising:

a pair of protective films; and

a polarizing film sandwiched between the pair of protective films,

wherein at least one of the protective films is the optical film as described in [1].

[20] A polarizing plate comprising:

a pair of protective films; and

a polarizing film sandwiched between the pair of protective films,

wherein at least one of the protective films is the optical film as described in [6].

[21] A liquid crystal display device comprising the optical film as described in [1].

[22] A liquid crystal display device comprising the optical film as described in [6].

[23] A liquid crystal display device of IPS, OCR or VA mode, comprising

a liquid crystal cell; and

a pair of polarizing plates arranged on both sides of the liquid crystal cell,

wherein the pair of the polarizing plates are the polarizing plates as described in [19].

[24]. A liquid crystal display device of IPS, OCR or VA mode, comprising

a liquid crystal cell; and

a pair of polarizing plates arranged on both sides of the liquid crystal cell,

wherein the pair of the polarizing plates are the polarizing plates as described in [20].

[25] A liquid crystal display device of VA mode, comprising the polarizing plate as described in [19] on a backlight side.

[26] A liquid crystal display device of VA mode, comprising the polarizing plate as described in [20] on a backlight side.

### DETAILED DESCRIPTION OF THE INVENTION

In accordance with the invention, preferably, the optical film of the invention is allowed to have such an optical property that the retardation wavelength dispersion varies between in the vertical direction of incident beam and in a direction slanting toward the vertical direction thereof, for example a direction at a polar angle of 60 degrees. The optical property is actively used for optical compensation. The scope of the invention is never limited to the display mode of the liquid crystal layer and can be used in liquid crystal display devices with liquid crystal layers in any display modes such as the VA mode, the IPS mode, OCB mode, the ECB mode, the TN mode.

In the present specification, the term “45°”, “parallel” or “orthogonal” means that the angle or the state is within a range of the exactly accurate angle ± less than 5°. The error from the exactly accurate angle is preferably less than 4°, more preferably 3°. The term “approximately vertical state” means a vertical state within a range of the exactly accurate angle ± less than 5°. Regarding the angle, further, the symbol “+” means a clockwise direction, while the symbol “−” means an anti-clockwise direction. Additionally, the term “slow axis” means a direction with the maximum refractive index. Further, the term “visible ray region” means the region at wavelengths 380 nm to 780 nm. Unless otherwise stated, the refractive index is measured at a wavelength λ=550 nm in the visible ray region.

In this specification, the term “polarizing plate” is used for meaning both a polarizing plate of a long size and a polarizing plate cut into a piece to be integrated in a liquid crystal display device (in this specification, the term “cutting” includes “blanking” and “cutting”), unless otherwise stated. In this specification, further, the terms “polarizing film” and “polarizing plate” are used in a discriminative manner from each other. The term “polarizing plate” means a laminate with a transparent protective film functioning to protect the polarizing film, as arranged on at least one face of a “polarizing film”.

In this specification, Re(λ) and Rth(λ) represent an in-plane retardation and a retardation in a thickness direction, respectively at a wavelength λ. Re(λ) is measured with KOBRA 21ADH or WR (manufactured by Oji Scientific Instruments Co., Ltd.), by allowing a beam at a λ-nm wavelength incident in the film vertical direction.

In case that a film to be measured is expressed by an ellipse with a uniaxial or biaxial refractive index, Rth(λ) is calculated by the following method.

KOBRA 21ADH or WR calculates Rth(λ) by measuring Re(λ) at six points in total by allowing a beam at a λ-nm wavelength incident in individual directions slanting at every 10-degree interval starting from the film vertical direction up to 50 degrees unilaterally, while the in-plane slow axis (as judged by KOBRA 21ADH or WR) is used as the slanting axis (rotation axis) (without any slow axis, an arbitrary in-plane direction is used as the rotation axis), and subsequently using the measured retardation values, an assumed value of the mean refractive index and the input film thickness value as the basis for calculating Rth(λ).

In case of a film where the retardation value is zero at a certain angle slanting toward the vertical direction in one direction when the in-plane slow axis is the rotation axis, the retardation value at a slanting angel larger than the aforementioned slanting angle is calculated by KOBRA 21ADH or WR after the sign is replaced with the negative sign.

Using the slow axis as the slanting axis (rotation axis) (without any slow axis, an arbitrary in-plane direction is defined as the rotation axis), the retardation value is measured in arbitrary two slanting directions; based on the resulting values, an assumed value of the mean refractive index and the input film thickness value, then, Rth may also be calculated according to the following formulas (1) and (2).

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Formula ( 1 )$$

The Re(θ) represents the retardation value in a direction slanting at an angle θ from the vertical direction.

The term “nx” in the formula (1) represents the refractive index in the in-plane slow axis direction, while the term “ny” represents the refractive index in an in-plane direction orthogonal to nx; and “nz” represents the refractive index in a direction orthogonal to both nx and ny.

Rth=[(nx+ny)/2−nz]×d Formula (2)

For a film never expressed by any ellipse with a uniaxial or biaxial refractive index, namely a film without any so-called optic axis, Rth(λ) can be calculated by the following process.

By KOBRA 21ADH or WR, Rth(λ) is calculated by measuring Re(λ) at 11 points in total by allowing a beam at a λnm wavelength incident in individual slanting directions at an interval of every 10 degrees in a range of −50 degrees to +50 degrees toward the film vertical direction, when the in-plane slow axis (as judged by KOBRA 21ADH or WR) is used as the slanting axis (rotation axis) and subsequently using the measured retardation values, an assumed value of the mean refractive index and the input film thickness value as the calculation basis for calculating Rth(λ).

For the measurement, a value listed in the Polymer Handbook (John Wiley & Sons, Inc.) and various optical film catalogs is used as the assumed value of the mean refractive index. The mean refractive index of an optical film without any known mean refractive index value can be measured with an Abbe refractometer. The mean refractive index values of main optical films are listed below: cellulose acylate (1.48), cycloolefin polymer (1.52), polycarbonate (1.59), polymethyl methacrylate (1.49) and polystyrene (1.59). By inputting these assumed values of mean refractive indices and the film thickness, “nx”, “ny” and “nz” are calculated by KOBRA 21ADH or WR. Using the calculated “nx”, “ny” and “nz”, “Nz” can further be calculated as follows: Nz=(nx−nz)/(nx−ny)

The invention is now described below in detail.

A firs embodiment of the optical film of the invention has a characteristic feature that by determining which one of the maximum X-ray diffraction intensity within a range 2θ=10 to 40° in the longitudinal direction of the film and the maximum X-ray diffraction intensity within a range 20θ=10 to 40° in a direction approximately vertical to the longitudinal direction of the film has a larger value and which one thereof has a smaller value and then dividing the larger value with the smaller value, the resulting value is 1.6 or more.

By determining which one of the maximum X-ray diffraction intensity within a range 2θ=10 to 40° in the longitudinal direction of the film and the maximum X-ray diffraction intensity within a range 2θ=10 to 40° in a direction approximately vertical to the longitudinal direction of the film has a larger value and which one thereof has a smaller value and then dividing the larger value with the smaller value, in accordance with the invention, the resulting value is preferably 1.6 or more to 3.0 or less, more preferably 1.7 or more to 2.9 or less, and still more preferably 1.8 or more to 2.8 or less. When the value obtained by determining which one of the maximum X-ray diffraction intensity within a range 2θ=10 to 40° in the longitudinal direction of the film and the maximum X-ray diffraction intensity within a range 2θ=10 to 40° in a direction approximately vertical to the longitudinal direction of the film has a larger value and which one thereof has a smaller value and then dividing the larger value with the smaller value is smaller than 1.6, polymer molecules in the film are insufficiently aligned so that the film cannot get desired optical properties. When the value is larger than 3.0, the optical film has larger anisotropies in terms of dimensional stability and elastic modulus, so that the usefulness of the film for liquid crystal display devices is reduced, unpreferably.

### [X-Ray Diffraction Measurement of Optical Film]

When a diffraction pattern is recorded on an imaging plate by allowing an X-ray beam incident in-plane from the vertical direction of the optical film of the invention, various diffraction patterns of the film over the full peripheries around 360 degrees can be obtained. With a transmission-type X-ray diffraction apparatus, in particular, a diffraction pattern corresponding to the film direction can be obtained.

The term “maximum X-ray diffraction intensity within a range 2θ=10 to 40° in a longitudinal direction of the film” in accordance with the invention is defined as an X-ray diffraction pattern with the maximal peak in a direction corresponding to the longitudinal direction of the film, particularly within the range 2θ=10 to 40°, which is selected from X-ray diffraction patterns recorded on the imaging plate.

The term “maximum X-ray diffraction intensity within a range 2θ=10 to 40° in a direction approximately vertical to the longitudinal direction of the film” in accordance with the invention is defined as an X-ray diffraction pattern with the maximal peak in a direction approximately vertical to the longitudinal direction of the film, particularly within the range 2θ=10 to 40°, which is selected from X-ray diffraction patterns recorded on the imaging plate.

In the X-ray diffraction spectrometry, the film of the invention is cut into a sample of 10 cm×10 cm, onto which an X-ray beam from CuKα is projected using the X-ray diffraction apparatus R-AXIS IV manufactured by Rigaku Co., Ltd. to record a sample image through the beam diffraction as a diffraction pattern on an imaging plate.

A second embodiment of the optical film of the invention has a characteristic feature that the value obtained by determining which one of the tensile modulus in the longitudinal direction of the film and the tensile modulus in a direction approximately vertical to the longitudinal direction of the film is a larger value and which one thereof is a smaller value and then dividing the resulting larger value with the resulting smaller value is 1.3 or more.

This can reduce the deformation level in the film stretch direction even with a change of the film environment such as temperature or humidity. For liquid crystal display devices, particularly liquid crystal display devices for use in large-type TV sets in recent years, the film deformation should preliminarily be reduced to a lower level even when an environmental change of temperature and humidity around such liquid crystal display devices occurs. It has been revealed that the deformation level has an influence on the display non-uniformity of liquid crystal display devices, which recently has drawn serious concerns as so-called “uneven” disorder. Thus, a liquid crystal display device at a constant display level can be provided by using the film with less deformation in accordance with the invention.

The value obtained by determining which one of the tensile modulus in the longitudinal direction of the film and the tensile modulus in a direction approximately vertical to the longitudinal direction of the film and dividing the resulting larger value with the resulting smaller value, is preferably 1.6 or more, more preferably 1.8 or more.

Through the determination about which one of the tensile modulus in the longitudinal direction of the film and the tensile modulus in a direction approximately vertical to the longitudinal direction of the film is larger, in this case, the resulting larger tensile modulus is preferably 2000 to 8000 MPa, more preferably 3000 to 7000 MPa, still more preferably 3500 to 6000 MPa. Herein, the term “longitudinal direction” means “the roll direction of a film rolled up”.

The elastic modulus of a cellulose acylate film sample of 10 mm×150 mm was measured with a tensile tester “Strograph-R2” (manufactured by Toyo Seiki Co., Ltd.) at an inter-chuck distance of 100 mm, a temperature of 25° C. and a stretch rate of 10 mm/min, after the sample was humidified at 25° C. and 60% RH for 2 hours or longer.

The optical film of the invention additionally satisfies the formulas (I) through (III), preferably.

0.4<|(Re(450)/Rth(450))/(Re(550)/Rth(550))|<0.95 (I):

and

1.05<{(Re(650)/Rth(650))/(Re(550)/Rth(550))}<1.9

0.1<(Re(450)/Re(550))<0.95 (II):

1.03<(Re(650)/Re(550))<1.93 (III):

More preferably, the aforementioned formulas are as follows.

0.5<|(Re(450)/Rth(450))/(Re(550)/Rth(550))|<0.9 (I):

and

1.1<{(Re(650)/Rth(650))/(Re(550)/Rth(550))}<1.7

0.2<(Re(450)/Re(550))<0.9 (II):

1.1<(Re(650)/Re(550))<1.7 (III):

The optical film of the invention may be used as an optically compensatory film or a retardation film. In this case, the optical film has preferably various optical properties, depending on the liquid crystal mode.

In case that the optical film of the invention is to be used for the VA mode, the film is used in the following two forms: each one single sheet is used on both the sides of the cell (therefore, two sheets in total) (two-sheet type) or a singe one sheet is used on either one of the top and lower ends of the cell (one-sheet type).

In case of the two-sheet type, Re(550) is preferably 20 to 150 nm, more preferably 20 to 100 nm, still more preferably 30 to70 nm. Rth(550) is preferably 100 to 300 nm, more preferably 120 to 200 nm.

In case of the one-sheet type, Re(550) is preferably 20 to 150 nm, more preferably 20 to 100 nm, still more preferably 40 to 100 nm. Rth(550) is preferably 100 to 300 nm, more preferably 150 to 250 nm.

For use in the IPS mode, Re(550) is preferably 0 to 5 nm, more preferably 0 to 2 nm. Rth(550) is preferably −20 to 20 nm, more preferably −10 to 10 nm.

For use in the OCB mode, Re(550) is preferably 10 to 100 nm, more preferably 20 to 70 nm. Rth(550) is preferably 50 to 300 nm, more preferably 100 to 250 nm.

For use in the TN mode, Re(550) is preferably 0 to 50 nm, more preferably 2 to 30 nm. Rth(550) is preferably 10 to 200 nm, more preferably 30 to 150 nm.

For the OCB mode and the TN mode, an optically anisotropic layer is coated on a cellulose acylate film with the retardation value described above, for use as an optically compensatory film.

The deviation of Re(550) in the film width direction is preferably ±5 nm, more preferably ±3 nm. The deviation of Rth(550) in the film width direction is preferably ±10 nm, more preferably ±5 nm. Additionally, the deviations of the Re value and the Rth value in the length direction are preferably within the deviations in the width direction.

The deviation of the in-plane slow axis angle on the optical film of the invention is preferably within a range of −2° to +2°, more preferably within a range of −1° to +1°, still more preferably within a range of −0.5° to +0.5° in the reference direction of a roll film. The term “reference direction” means the longitudinal direction of a roll film when the optical film is stretched in a longitudinal direction or means the width direction of a roll film when the optical film is crosswise stretched.

In terms of the reduction of the change of tint over time in liquid crystal display devices, preferably, the optical film of the invention preferably is with a difference ΔRe between the Re value at 25° C. and 10% RH (Re_{10%}) and the Re value at 25° C. and 80% RH (Re_{80%}) (=Re_{10%}−Re_{80%}) being 0 to 10 nm; and with a difference ΔRth between the Rth value at 25° C. and 10% RH (Re_{10%}) and the Rth value at 25° C. and 80% RH (Re_{80%}) (=Rth_{10%}−Rth_{80%}) being 0 to 30 nm.

In terms of the reduction of the change of tint over time in liquid crystal display devices, preferably, the optical film of the invention preferably is at an equilibrium moisture ratio at 25° C. and 80% RH being 3.2% or less.

The moisture ratio is measured by a process comprising measuring the moisture ratio of an optical film sample of 7 mm×35 mm with a moisture counter or a sample drying apparatus [“CA-03” and “VA-05”, both manufactured by Mitsubishi Chemical Corporation] according to the Karl Fisher's method. The moisture ratio is calculated by dividing the moisture content (g) with the sample mass (g).

Furthermore, the optical film of the invention is preferably at a water vapor permeability of 400 g/m²·24 hours or more to 1800 g/m²·24 hours or less, at 60° C. and 95% RH for 24 hours (corrected on a 80-μm film thickness basis) in terms of reducing the change of tint in liquid crystal display devices over time.

The water vapor permeability is smaller as the film thickness of the optical film is larger. It may otherwise be stated that the water vapor permeability is larger as the film thickness thereof is smaller. Therefore, it is needed that a reference film thickness can correct any film thickness of any sample. In accordance with the invention, the reference film thickness is set at 80 μm, for correction on a film thickness basis according to Formula (13).

water vapor permeability on an 80-μm basis=(actually measured water vapor permeability)×(actually measured film thickness in μm)/80 μm. Formula (13):

As the method for measuring water vapor permeability, the methods described in the “Polymer Profiles II” (Experimental Polymer Lecture Series No. 4, Kyoritu Shuppan), Measurement of Water Vapor Permeation Level (mass method, thermometer method, vapor pressure method, and adsorption level method), page 254 to page 294 can be used.

The hygroscopic expansion coefficient was determined by measuring the dimension of a film left to stand alone at 25° C. and 80% RH for 2 hours or more with a pin gauge, which is defined as L_{80%} and then measuring the dimension of a film left to stand alone at 25° C. and 10% RH for 2 hours or more with a pin gauge, which is defined as L_{10%}, and then calculating the hygroscopic expansion coefficient according to the following formula (14).

(L_{80%}−L_{10%})/(80% RH−10% RH)×10⁶ Formula (14):

The optical film of the invention preferably has a haze within a range of 0.01 to 2%. Herein, the haze can be measured as follows.

The haze is determined by measuring the haze of an optical film sample of 40 mm×80 mm at 25° C. and 60% RH with a haze meter “HGM-2DP” [manufactured by Suga Tester Co., Ltd.] according to JIS K-6714.

The mass change of the optical film of the invention is preferably within a range of 0 to 5% by mass, when left to stand alone under conditions of 80° C. and 90% RH for 48 hours.

Furthermore, the dimensional change of the optical film of the invention when left to stand alone at 60° C. and 95% RH for 24 hours and the dimensional change of the optical film of the invention when left to stand alone at 90° C. and 5% RH for 24 hours are both preferably within a range of 0 to 5%.

In terms of reducing the change of tint in liquid crystal display devices over time, the optical elastic modulus is preferably 50×10⁻¹³ cm²/dyne or less.

Specifically, the optical elastic modulus was determined by applying a tensile stress to the longitudinal direction of an optical film sample of 10 mm×100 mm, measuring then the retardation with an ellipsometer “M150” (manufactured by JASCO CORPORATION) and calculating the optical elastic modulus based on the change of the retardation under a stress.

### METHOD OF THE INVENTION

The present inventors made investigations. Consequently, the inventors found that the aforementioned optical film with such preferable physico-chemical properties could be obtained by a method comprising a stretch step for stretching a film and a shrink step for shrinking the film, where the film thickness just before the stretch step was 40 to 150 μm.

The inventive method is now described below in detail.

In accordance with the invention, a method for producing an optical film, comprising a stretch step for stretching a film in the film transfer direction in particular and a shrink step for shrinking the film while retaining the film in a direction approximately vertical to the transfer direction, or a method for producing an optical film comprising a shrink step for shrinking a film in the film transfer direction and a stretch step for stretching the film in a direction approximately vertical to the transfer direction is preferably used. The meaning of “vertical” in the stretch direction or in the shrink direction is the same as “orthogonal” in this specification.

The method for producing an optical film, comprising a stretch step for stretching a film in the film transfer direction and a shrink step for shrinking the film while retaining the film in a direction approximately vertical to the transfer direction is first described.

In this case, the film is stretched in the film transfer direction. As a stretching method in the film transfer direction, preferably, a stretching method in the longitudinal direction is preferably used, where a plurality of rolls with different circumferential velocities is used so as to utilize the different circumferential velocities of the rolls for stretching the film in the longitudinal direction. For making a film by the solution cast process, additionally, preference is also given to a method comprising casting a film on a stainless steel band or drum and adjusting the velocity of a film transfer roller in peeling off the film at a semi-dry state, so as to make the film roll-up velocity larger than the film peel-off velocity.

In a direction approximately vertical to the film transfer direction, the film is transferred with an apparatus called tenter for fixing both the ends of the film with clips or pins; and by gradually decreasing the width of the tenter, the film can shrink in the direction approximately vertical to the film stretch direction.

Additionally, a film may be shrinked in the approximately vertical direction, by retaining the film with a tenter of a tenter type such as the chain mode, the screw mode, the pantograph mode and the linear motor mode, which operates in two axial directions of the film transfer direction and a direction approximately vertical to the film transfer direction, and then gradually decreasing the tenter width while increasing the distance between the clips in the transfer direction under film stretching.

A method for producing an optical film comprising a shrink step for shrinking a film in the film transfer direction and a stretch step for stretching the film in a direction approximately vertical to the transfer direction is now describe below.

In this case, the film shrinks in the film transfer direction. As a method for shrinking a film in the film transfer direction, a method comprising providing different circumferential velocities to a plurality of rolls and then utilizing the different circumferential velocities of the rolls for shrinkage in the longitudinal direction is preferably used. In other words, the film can shrink in the transfer direction by utilizing the thermal shrinkage of the film, by reducing the circumferential velocities of rolls on the downstream of the transfer while heating the film to a temperature of Tg or more.

In a direction approximately vertical to the film transfer direction, the film is transferred with an apparatus called tenter for retaining and fixing the film at both the ends of the film with clips or pins, while gradually increasing the width of the tenter, so that the film can be stretched in the direction approximately vertical to the film stretch direction.

More additionally, a film can shrink in the approximately vertical direction by retaining the film by a tenter of the chain mode, the screw mode, the pantograph mode and the linear motor operating in two axial directions of the film transfer direction and the width direction and then gradually decreasing the distance between the clips in the transfer direction while stretching the film in a direction approximately vertical to the film transfer direction.

The stretching step and the shrink step utilizing different roll circumferential velocities and tenter as described above can be done serially in the order of stretching and shrinkage or in the order of shrinkage and stretching.

According to the method using a tenter operating in a biaxial direction in the film transfer direction and the width direction as described above, the stretch step and the shrink step may at least partially be conducted simultaneously.

The research works made by the inventors consequently indicated that such simultaneous process could adjust the timings for stretching and shrinkage, the ratio thereof and velocities thereof advantageously to readily reduce the non-uniform stretching and shrinkage on the in-plane film, as called bowing.

As a stretching apparatus for specifically stretching such film as described above in one of the longitudinal direction of the film and a direction approximately vertical to the longitudinal direction of the film, simultaneously shrinking the film in the remaining direction, and concurrently raising the film thickness, for example, the FITZ machine manufactured by Ichikin Industry Co., Ltd. can preferably be used. The apparatus is described in the official gazette of JP-A-2001-38802.

As a stretch ratio at the stretching step and a shrink ratio at the shrink step, suitable arbitrary values can be selected, depending on the in-plane retardation Re and the retardation in a thickness direction Rth, as intended. Preferably, the stretch ratio at the stretching step is 10% or more, while the shrink ratio at the shrink step is 5% or more.

The term “stretch ratio” in accordance with the invention means the ratio of the increment of the film length after stretching in the stretch direction compared with the film length before stretching; and the term “stretch ratio” means the ratio of the decrement of the film length after shrinking in the shrink direction compared with the film length before shrinkage.

Further, the stretch ratio is preferably 10 to 45%, particularly preferably 15 to 35%. Meanwhile, the shrink ratio is preferably 5 to 40%, particularly preferably 10 to 35%.

For achieving the desired optical physico-chemical properties, furthermore, the stretching and shrink steps are done, preferably at a temperature by 25 to 100° C. higher than the glass transition temperature of the film at the time of these steps. Additionally, the term “processing temperature” means the temperature of the film surface as measured with a non-contact infrared thermometer.

According to the method for practicing the first embodiment of the invention, particularly, the film thickness just before stretching is 40 to 150 μm. The film thickness just before stretching is preferably 45 to 150 μm, more preferably 50 to 150 μm according to the method of the invention.

According to the method for practicing the second embodiment of the invention, particularly, the film thickness just before stretching is 40 to 150 μm. The film thickness just before stretching is preferably 40 to 120 μm, more preferably 45 to 115 μm, still more preferably 50 to 110 μm according to the method of the invention.

As mentioned above, by controlling the film thickness just before stretching within a particular range, each of the first embodiment and second embodiment of the invention is practiced.

When the film thickness just before stretching is less than 40 μm, the film strength readily falls into insufficiency, sometimes disadvantageously leading to the occurrence of difficulties in handling the film for the transfer thereof. When the film thickness just before stretching is larger than 150 μm, alternatively, the final film thickness of the resulting optical film is so large that the film thickness is generally not preferable as an optical film thickness desired for use in current liquid crystal display devices.

The term “film thickness just before stretching” in accordance with the invention means the film thickness before carrying out the film stretching step. In case that the stretching and shrink steps are to be carried out using a non-stretched film, the term means the film thickness of the original non-stretched film. In case that the stretching and shrink steps are to be carried out continuously, meanwhile, the term means the film thickness just before transferring the film to the stretching and shrink steps.

The invention can be practiced by wet stretching comprising stretching the film prepared by the solution casting process, in the course of drying the film. After drying, additionally, the film may also be continuously stretched; otherwise, a stretching step may also be done separately on the film once the film is rolled up. The invention may also be applicable to stretching the film prepared by the melt process substantially without any solvent. Film stretching or shrinkage may be done in one step or in multiple steps. For the multiple steps, the product from the individual stretch ratios is within the preferable range of the stretch ratio as described above.

The stretch velocity and the shrink velocity are preferably 5%/min to 1000%/min, more preferably 10%/min to 500%/min. Stretching may preferably be done with a heat roll or/and a radiation heat source (such as IR heater) and in hot air.

The optical film satisfying the properties in accordance with the invention preferably comprises a polymer film. The polymer materials mainly constituting the polymer film are specifically described below.

### [Material Properties of Optical Film]

The polymer materials forming the optical film of the invention are preferably a polymer with for example excellent optical transparency, mechanical strength, thermal stability, moisture-shielding property and isotropy. Any such polymer material may be used satisfactorily. The polymer material includes for example polycarbonate-series polymers, polyester-series polymers such as polyethylene terephthalate and polyethylene naphthalate, acrylic polymers such as polymethyl methacrylate, and styrene-series polymers such as polystyrene and acrylonitrile styrene copolymers (AS resins). Additionally, the polymer material includes for example polyolefins such as polyethylene and polypropylene, polyolefin-series polymers such as ethylene propylene copolymers, vinyl chloride polymers, amide-series polymers such as nylon and aromatic polyamide, imide-series polymers, sulfone-series polymers, polyether sulfone-series polymers, polyether ether ketone-series polymers, polyphenylene sulfide-series polymers, vinylidene chloride-series polymers, vinyl alcohol-series polymers, vinyl butyral-series polymers, acylate-series polymers, polyoxymethylene-series polymers, epoxy-series polymers, or polymers prepared by mixing together the polymers described above. The polymer film of the invention may additionally be formed in a cured resin of ultraviolet-cured types or thermally cured types from for example acryl-series, urethane-series, acrylurethane-series, epoxy-series and silicone-series.

As a material for forming a polymer film for use in accordance with the invention, a thermoplastic norbornene-series resin is preferably used. The thermoplastic norbornene-series resin includes for example Zeonex and Zeonor manufactured by Zeon Corporation and Arton manufactured by JSR Co., Ltd.

As a material for forming a polymer film for use in accordance with the invention, a cellulose-series polymer typically including triacetyl cellulose as a transparent protective film for use in polarizing plates in the related art may preferably be used. Cellulose acylate is now first described in detail.

### (Cellulose Acylate)

As the raw material cotton for cellulose acylate, known raw materials may be used (see for example the Japan Institute of Invention and Innovation (JIII), Journal of Technical Disclosure (Kokai Gihou), Technical No. 2001-1745). Known methods may be used for synthetically preparing cellulose acylate [see for example “Wood Chemistry” edited by Migita, et al., page 180 to page 190 (Kyoritsu Shuppan, 1968)]. The viscosity average polymerization degree of cellulose acylate is preferably 200 to 700, more preferably 250 to 500 and most preferably 250 to 350. The number average molecular weight (Mn) of the cellulose acylate for use in accordance with the invention is 10000 or more to 150000 or less, while the weight average molecular weight (Mw) of the cellulose acylate is 20000 or more to 500000 or less and the Z average molecular weight (Mz) of the cellulose acylate is 5000 or more to 550000 or less. Additionally, the distribution of the molecular weights (Mw/Mn) (where Mw represents weight average molecular weight and Mn represents number average molecular weight) as measured by gel permeation chromatography is preferably narrow. Specifically, the value of Mw/Mn is preferably 1.5 to 5.0, more preferably 2.0 to 4.5, most preferably 3.0 to 4.0.

As the acyl group in the cellulose acylate, any of acetyl group, propionyl group or butyryl group or benzoyl group is preferably used, with no specific limitation. The substitution degree of all the acyl groups is preferably 2.0 to 3.0, more preferably 2.2 to 2.95. In this specification, the substitution degree of acyl group is calculated according to ASTM D817.

Preferably, acyl group is most preferably acetyl group. In case of using cellulose acetate with acetyl group as the acyl group therein, the esterification degree is preferably within a range of 57.0 to 62.5%, more preferably within a range of 58.0 to 62.0%. When the esterification degree is within the range, Re never exceeds the desired value even with the transfer tension during casting, involving a small in-plane deviation and a smaller change of the retardation value due to temperature or humidity.

Provided that hydroxyl group in the glucose unit composing the cellulose in cellulose acylate is substituted with an acyl group with two or more carbon atoms; that the substitution degrees of the hydroxyl group at positions 2, 3 and 6 in the glucose unit with such acyl group are defined as DS2, DS3 and DS6, respectively; and additionally that DS2, DS3 and DS6 satisfy the following formulas (IV) and (V), desired Re and Rth can readily be obtained, preferably involving a smaller variation of the Re value due to temperature and humidity.

2.0≦(DS2+DS3+DS6)≦3.0 (IV):

DS6/(DS2+DS3+DS6)≧0.315 (V):

More preferably, the ranges are as follows.

2.2≦(DS2+DS3+DS6)≦2.9 (IV):

DS6/(DS2+DS3+DS6)≧0.322 (V):

Provided that the substitution degree of the hydroxyl group in the glucose unit composing cellulose acylate with acetyl group is defined as “A” and the substitution degree of the hydroxyl group therein with propionyl group or butyryl group or benzoyl group is defined as “B” and additionally when the optical film substantially comprises cellulose acylate where A and B satisfy the formulas (VI) and (VII), preferably, desired Re and Rth can readily be obtained, so that a high stretch ratio can be attained, readily, without any breakage. In this specification, “substantially” means that the optically film comprises the above cellulose acylate in an amount of 90% or more on the basis of mass ratio.

2.0≦A+B≦3.0 (VI):

0<B (VII):

More preferably, the ranges are as follows.

2.6≦A+B≦3.0 (VI):

0.5<B<1.5 (VII):

### (Polymers Other Than Cellulose Acylate)

The inventive method for producing a film with such preferable physico-chemical properties, comprising a stretch step for stretching a film and a shrink step for shrinking the film where the film thickness just before the stretch step is within a specific range, is not only applicable to cellulose acylate but also is applicable in a non-limited manner to all polymers usable as optical films, where the method exerts the same effect as in the case of cellulose acylate.

Such polymers usable as an optical film include for example polycarbonate copolymers and polymer resins with a cyclic olefin structure.

Examples of the polycarbonate copolymers are polycarbonate copolymers comprising the repeat unit represented by the following formula (A) and the repeat unit represented by the following formula (B), where the repeat unit represented by the following formula (A) occupies 80 to 30 mol % of the total mass.

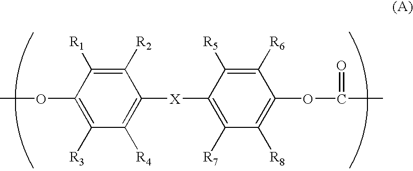

In the formula (A), R₁ through R₈ are independently selected from hydrogen atom, halogen atoms and hydrocarbon groups with one to 6 carbon atoms. Hydrocarbon groups with one to 6 carbon atoms include for example alkyl groups such as methyl group, ethyl group, isopropyl group, and cyclohexyl group; and aryl groups such as phenyl group. Among them, hydrogen atom and methyl group are preferable.

X is represented by the following formula (X), where R₉ and R₁₀ are independently hydrogen atom, halogen atoms or alkyl groups with one to 3 carbon atoms. The halogen atoms and the alkyl groups with one to 3 carbon atoms include those described above.

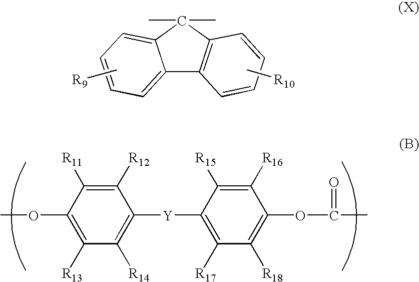

In the formula (B), R₁₁ through R₁₈ are independently selected from hydrogen atom, halogen atoms and hydrocarbon groups with one to 22 carbon atoms. Hydrocarbon groups with one to 22 carbon atoms include for example alkyl groups with one to 9 carbon atoms, such as methyl group, ethyl group, isopropyl group, and cyclohexyl group; and aryl groups such as phenyl group, biphenyl group and terphenyl group. Among them, hydrogen atom and methyl group are preferable.

Y is represented by the following formula group, where R₁₉ through R₂₁, and R₂₃ and R₂₄ are independently at least one group selected from hydrogen atom, halogen atoms and hydrocarbon groups with one to 22 carbon atoms. Such hydrocarbon groups include the same as described above. R₂₂ and R₂₅ are independently selected from hydrocarbon groups with one to 20 carbon atoms, including for example methylene group, ethylene group, propylene group, butylenes group, cyclohexylene group, phenylene group, naphthylene group, and terphenylene group. Ar₁ through Ar₃ include aryl groups with 6 to 10 carbon atoms such as phenyl group and naphthyl group.

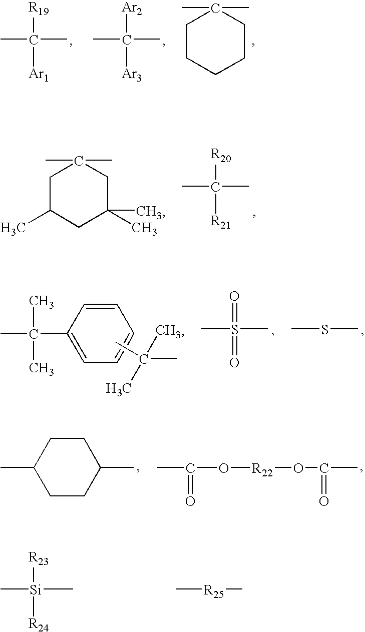

### The polycarbonate copolymer is preferably a polycarbonate copolymer comprising 30 to 60 mol % of a repeat unit represented by the following formula (C) and 70 to 40 mol % of a repeat unit represented by the following formula (D).

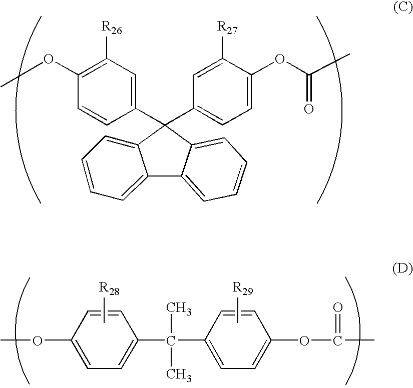

More preferably, the polycarbonate copolymer is preferably a polycarbonate copolymer comprising 45 to 55 mol % of a repeat unit represented by the following formula (C) and 55 to 45 mol % of a repeat unit represented by the following formula (D).

In the formula (C), R₂₆ and R₂₇ are independently hydrogen atom or methyl group, preferably methyl group in terms of handleability.

In the formula (D), R₂₈ and R₂₉ are independently hydrogen atom or methyl group, preferably hydrogen atom in terms of economy, film properties and the like.

The optical film of the invention is preferably an optical film using a polycarbonate copolymer with the fluorein backbone. The polycarbonate copolymer with the fluorein backbone is preferably a blend of polycarbonate copolymers comprising different composition ratios of the repeat unit represented by the formula (A) and the repeat unit represented by the formula (B), where the content of the formula (A) is preferably 80 to 30 mol %, more preferably 75 to 35 mol %, still more preferably 70 to 40 mol % in the total of the polycarbonate copolymers.

The copolymer may be a combination of two types or more of each of the repeat units individually represented by the formula (A) and the formula (B).

Herein, the molar ratio in the total of the polycarbonate bulk composing the optical film can be determined by for example a nuclear magnetic resonance (NMR) apparatus.

The polycarbonate copolymer may be produced by a known method. As the method for producing such polycarbonate copolymer, for example, a polymerization/condensation process between dihydroxy compounds and phosgene and a melt polymerization/condensation process are preferably used.

The intrinsic viscosity of the polycarbonate copolymer is preferably 0.3 to 2.0 dl/g. Below 0.3, disadvantageously, the resulting optical film cannot retain the mechanical strength. Above 2.0, the solution viscosity is raised too high so that problems emerge, including for example the occurrence of die line during solution filming and the occurrence of difficulty in purifying the resulting product on completion of the polymerization.

Additionally, the optical film of the invention is a composition (blend) comprising the polycarbonate copolymer and another polymer compound. In this case, preferably, the polymer compound is compatible with the polycarbonate compound because the resulting blend is essentially transparent optically, or the individual polymers have approximately equal refractive indices. Specific examples of other polymers include poly(styrene-co-maleic anhydride), where the polycarbonate copolymer and the polymer compound are at a composition ratio of 80 to 30% by mass of the polycarbonate copolymer and 20 to 70% by mass of the polymer compound, preferably 80 to 40% by mass of the polycarbonate copolymer and 20 to 60% by mass of the polymer compound. For the blend described above, two types or more of the individual repeat units for the polycarbonate copolymer may be used in combination. In case of the blend, additionally, a compatible blend is preferable. However, even a blend without complete compatibility of the individual components can suppress light scattering between the components therein to improve the transparency, when the refractive indices of the individual components are made almost equal. Herein, the blend may be a combination of three types or more of materials. Plural types of polycarbonate copolymers may be used in combination with other polymer compounds.

The mass average molecular weight of the polycarbonate copolymer is 1000 to 1000000, preferably 5000 to 500000. The mass average molecular weight of other polymer compounds is 500 to 100000, preferably 1000 to 50000.

A polymer resin with a cyclic olefin structure (referred to as “cyclic polyolefin-series resin” or “cyclic polyolefin” hereinbelow) includes for example (1) norbornene-series polymers, (2) monocyclic olefin polymers, (3) cyclic conjugated diene polymers, (4) vinyl alicyclic hydrocarbon polymers and hydrogenated products of the polymer resins (1) through (4). The polymer preferable for use in accordance with the invention is an addition (co)polymer cyclic polyolefin containing at least one of the repeat units represented by the following formula [II], and the addition (co)polymer cyclic polyolefin additionally containing at least one of the repeat units represented by the formula [I], if necessary. Further, an addition (co)polymer (including ring-opened (co)polymer) containing at least one of the cyclic repeat units represented by the formula [III] may also be used preferably. Still additionally, an addition (co)polymer cyclic polyolefin containing at least one of the repeat units represented by the formula [III] and at least one of the repeat units represented by the formula [I], if necessary, may also be used preferably.

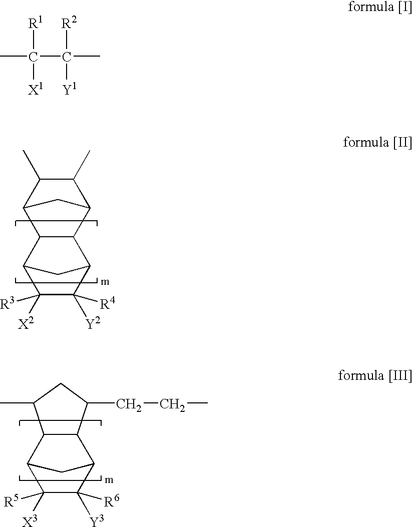

In the formula, “m” represents an integer of 0 to 4; R¹ through R⁶ represent hydrogen atom or a hydrocarbon group with one to 10 carbon atoms; X¹ through X³ and Y¹ through Y³ individually represent hydrogen atom, a hydrocarbon group with one to 10 carbon atoms, a halogen atom, a halogen atom-substituted hydrocarbon group with one to 10 carbon atoms, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ, —(CH₂)ₙW, or —(CO₂)O or —(CO₂)NR¹⁵ composed of a combination of X¹ and Y¹, a combination of X² and Y², or a combination of X³ and Y³. Herein, R¹¹, R¹², R¹³, R¹⁴ and R¹⁵ independently represent hydrogen atom and a hydrocarbon group with one to 20 carbon atoms. Z represents a hydrocarbon group or a hydrocarbon group substituted with a halogen. W represents SiR¹⁶ₚD₃₋ₚ (R¹⁶ represents a hydrocarbon group with one to 10 carbon atoms; and D represents [a halogen atom-OCOR¹⁶] or [a halogen atom-OR¹⁶]; p represents an integer of 0 to 3); and n represents an integer of 0 to 10.

By introducing a functional group with a high polarity level into a substituent for X¹ to X³ and Y¹ to Y³, the retardation in a thickness direction (Rth) can be raised to raise the development of the in-plane retardation (Re). The Re value of a film with a higher Re occurrence can be raised by stretching the film during a film production course.

Norbornene-series addition (co)polymers are disclosed in for example JP-A-Hei 10-7732, Tokuhyo 2002-504184, US 2004 229157A or WO 2004/070463A1. Such norbornene-series addition (co)polymers can be obtained by addition polymerization of norbornene-series polycyclic unsaturated compounds. If necessary, further, norbornene-series polycyclic unsaturated compounds may be addition polymerized with conjugated dienes such as ethylene, propylene, butane, butadiene and isoprene; non-conjugated dienes such as ethylidene norbornene; and linear diene compounds such as acrylonitrile, acrylic acid, methacrylic acid, maleic anhydride, acrylate esters, methacrylate esters, maleimide, vinyl acetate and vinyl chloride. The norbornene-series addition (co)polymers are commercially available from Mitsui Chemical Co., Ltd. under the product name of Apel series with different glass transition temperatures (Tg), including for example APL 8008T (Tg=70° C.), APL6013T (Tg=125° C.) or APL6015T (Tg=145° C.). Pellets of such copolymers are commercially available from Polyplastics Co., Ltd., including for example TOPAS 8007, TOPAS 6013 and TOPAS 6015. Furthermore, Appear 3000 is also commercially available from Ferrania Technologies.

As disclosed in JP-A-Hei 1-240517, JP-A-Hei 7-196736, JP-A-Sho 60-26024, JP-A-Sho 62-19801, JP-A-2003-159767 or JP-A-2004-309979, hydrogenated norbornene-series polymers are produced by addition polymerization or ring opening metathesis polymerization of polycyclic unsaturated compounds and subsequent hydrogenation. In the norbornene-series polymers for use in accordance with the invention, R⁵ and R⁶ are preferably hydrogen atom or —CH₃; X³ and Y³ are preferably hydrogen atom, Cl or —COOCH₃; and other groups are appropriately selected optionally. The norbornene-series resins are commercially available, from JSR under the trade name of Arton G or Arton F and from Zeon Corporation under the trade names of Zeonor ZF14 and ZF 16 or under the trade name of Zeonex 250 or Zeonex 280. These may also be used.

The optical film of the invention preferably contains a retardation developer (sometimes referred to as “retardation-raising agent” hereinbelow). The following descriptions are about methods for controlling Re representing the in-plane retardation and Rth representing the retardation in a thickness direction.

### (Method for Controlling Re and Retardation-Raising Agent With the Peak Absorption Wavelength (λmax) Shorter Than 250 nm)

So as to control the absolute Re value of the optical film of the invention, preferably, a compound with the peak absorption wavelength (λmax) shorter than 250 nm on ultraviolet absorption spectra at a solution state is used as such retardation-raising agent. By using such compound, the absolute value of Re can be controlled without any substantial change of the Re wavelength dependency in the visible region.

Hereinafter, an optical film using a cellulose acylate as the raw material will be explained.

The term “retardation-raising agent” means “an additive” functioning in such a manner that the Re of a cellulose acylate film containing the additive as measured at a wavelength of 550 nm is higher by 20 nm or more than the Re of the cellulose acylate film prepared in absolutely the same manner except for no content of the additive (on the basis of the 80-μm film thickness). The increment of Re is preferably 30 nm or more, more preferably 40 nm or more, most preferably 60 nm or more.

In terms of the functions of the retardation-raising agent, bar-like compounds are preferable; and the bar-like compounds have more preferably at least one aromatic ring, still more preferably at least two aromatic rigs.

Preferably, the bar-like compound has a linear, molecular structure. The term “linear, molecular structure” means that the molecular structure of the bar-like compound at the thermodynamically most stable state is linear. The thermodynamically most stable structure can be determined by crystal structure analysis or molecular orbit calculation. Using for example a molecular orbit calculation software (for example, WinMOPAC 2000 manufactured by Fujitsu, Co., Ltd.) to calculate the molecular orbit, a molecular structure with the smallest heat for forming the compound can be determined. The phrase “linear molecular structure” means that the molecular structure at the thermodynamically most stable structure is at an angle of 140 degrees or more.

The bar-like compound preferably exerts the properties of liquid crystal. The bar-like compound preferably exerts the properties of liquid crystal (the properties of thermotropic liquid crystal) via heating. The liquid crystal phase is preferably a nematic phase or a smectic phase.

Preferable such compounds are described in JP-A-2004-4550. But the bar-like compound is not limited to them. Two types or more of bar-like compounds with the peak absorption wavelength (λmax) shorter than 250 nm may be used in combination.

The bar-like compound can be prepared synthetically with reference to methods described in references. The references include Mol. Cryst. Liq. Cryst., Vol. 53, page 229 (1979); supra., Vol. 89, page 93 (1982); supra, Vol. 145, page 111 (1987); supra., VOl. 170, page 43 (1989); J. Am. Chem. Soc., Vol. 113, page 1349 (1991); supra., Vol. 118, page 5346 (1996); supra., Vol. 92, page 1582 (1970); J. Org. Chem., Vol. 40, page 420 (1975); and Tetrahedron, Vol. 48, No. 16, page 3437 (1992).

The retardation-raising agent is preferably added at an amount of preferably 0.1 to 30 parts by mass, more preferably 0.5 to 20 parts by mass of cellulose acylate. [Method for controlling Rth and retardation-raising agent with the maximum absorption wavelength (λmax) longer than 250 nm] So as to develop a desired Rth, preferably, a retardation-raising agent is used.

Herein, the term “retardation-raising agent” means an “additive” which adjusts the Rth of a cellulose acylate film containing the additive as measured at a wavelength 550 nm to a value higher by 20 nm than the Rth of a cellulose acylate film prepared by the same method except for no addition of the additive (corrected on a film thickness of 80 μm). The Rth is raised by preferably 30 nm or more, more preferably 40 nm and most preferably 60 nm or more.

The retardation-raising agent preferably contains a compound with at least two aromatic rings. The retardation-raising agent is used within a range of preferably 0.01 to 20 parts by mass, more preferably 0.1 to 10 parts by mass, still more preferably 0.2 to 5 parts by mass, most preferably 0.5 to 2 parts by mass to 100 parts by mass of cellulose acylate. Two types or more of such retardation-raising agent may be used in combination.

The retardation-raising agent preferably has the peak absorption in a wavelength region of 250 to 400 nm. More preferably, the retardation-raising agent has substantially no absorption in the visible region.

The retardation-raising agent controlling Rth preferably never affects Re developing via stretching. As the retardation-raising agent, a disk-like compound is preferably used.

Disk-like compounds include aromatic hetero rings in addition to aromatic hydrocarbon rings, where the aromatic hydrocarbon rings are particularly preferably a six-membered ring (namely, benzene ring).

Generally, aromatic hetero rings are unsaturated hetero rings. Aromatic hetero rings are preferably five-membered rings, six-membered rings or seven-membered rings, more preferably five-membered rings or six-membered rings. Generally, the aromatic hetero rings have the largest number of double bonds. Hetero atoms therein include preferably nitrogen atom, oxygen atom and sulfur atom, particularly preferably nitrogen atom. Examples of the aromatic hetero rings include furan ring, thiophen ring, pyrrole ring, oxazole ring, isooxazole ring, thiazole ring, isothiazole ring, imidazole ring, pyrazole ring, furazan ring, triazole ring, pyran ring, pyridine ring, pyridazine ring, pyrimidine ring, pyrazine ring and 1,3,5-triazine ring.

Aromatic rings are preferably benzene ring, furan ring, thiophen ring, pyrrole ring, oxazole ring, thiazole ring, imidazole ring, triazole ring, pyridine ring, pyrimidine ring, pyrazine ring and 1,3,5-triazine. 1,3,5-Triazine ring is particularly preferably used. Specifically, for example, compounds disclosed in JP-A-2001-166144 are preferably used.

Aromatic compounds are used within a range of 0.01 to 20 parts by mass to 100 parts by mass of cellulose acylate. Aromatic compounds are used within a range of preferably 0.05 to 15 parts by mass, more preferably 0.1 to 10 parts by mass to 100 parts by mass of cellulose acylate. Two types or more of such aromatic compounds may be used in combination.

### (Method for Controlling Rth: Method With Optically Anisotropic Layer)

As a method for controlling Rth without any influence on Re developing via stretching, a method comprising coating an optically anisotropic layer with for example a liquid crystal layer is preferably used.

Specific examples of the method with a liquid crystal layer include a method comprising aligning a disk-like liquid crystal within an angle range of 5 degrees between the disk face thereof and the optical film face (JP-A-Hei 10-312166) and a method comprising aligning a bar-like liquid crystal within an angle range of 5 degrees between the longitudinal axis thereof and the optical film face (JP-A-2000-304932).

The cellulose acylate film with an optically anisotropic layer (also referred to as optically compensatory film) makes contributions to the enhancement of the viewing angle contrast in liquid crystal display devices, in particular of the OCB mode and the VA mode, and to the reduction of color shift depending on the viewing angle. The optically compensatory film may be arranged in between the polarizing plate on the side of an observer and the liquid crystal cell, or may be arranged in between the polarizing plate on the back face and the liquid crystal cell, or may be arranged in both. For example, the optical compensatory film may be integrated as an independent member inside a liquid crystal apparatus, or may be integrated as an independent member in a part of a polarizing plate to allow the optically compensatory film to have a function as a transparent film to protect the polarizing film as a protective film. An alignment film controlling the alignment of a liquid crystal compound in the optically anisotropic layer may be arranged in between the cellulose acylate film and the optically anisotropic layer. The cellulose acylate and the optically anisotropic layer may independently comprise two or more layers as long as the cellulose acylate and the optically anisotropic layer satisfy the optical properties described below. The optically anisotropic layer is now described below in detail.

### [Optically Anisotropic Layer]

The optically anisotropic layer may be formed directly on the surface of the cellulose acylate film or may be arranged on an alignment film formed on the cellulose acylate film. Using an adhesive, an adhesive agent and the like, additionally, a liquid crystal compound layer formed on another substrate may be transferred onto the cellulose acylate film.

The liquid crystal compound for use in forming the optically anisotropic layer includes for example bar-like liquid crystal compounds and disk-like liquid crystal compounds (the disk-like liquid crystal compounds are sometimes referred to as “discotic liquid crystal compounds” hereinafter). The bar-like liquid crystal compounds and the discotic liquid crystal compounds may be high-molecular liquid crystals or may be low-molecular liquid crystals. Additionally, compounds finally contained in the optically anisotropic layer is not required to exert the liquid crystal property, which is exemplified in a mode such that in case that a low-molecular liquid crystal compound is used in preparing an optically anisotropic layer, for example, the compound is crosslinked together in the course of preparing the optically anisotropic layer, so that the compound never exerts the liquid crystal property.

### (Bar-Like Liquid Crystal Compounds)

As the bar-like liquid crystal compounds potentially for use in accordance with the invention, there are preferably used azomethines, azo-oxy compounds, cyanobiphenyls, cyanophenyl esters, benzoate esters, cyclohexane carboxylate phenyl esters, cyanophenyl cyclohexanes, cyano-substituted phenyl pyrimidines, alkoxy-substituted phenyl pyrimidines, phenyl dioxanes, tolans and alkenylcyclohexylbenzonitriles. Herein, the bar-like liquid crystal compounds include metal complexes. Additionally, liquid crystal polymers containing a bar-like liquid crystal compound in a repeat unit thereof may also be used. In other words, the bar-like liquid crystal compound may satisfactorily bind to a (liquid crystal) polymer.

The bar-like liquid crystal compounds are described in “Kikan Kagaku Sosetu”, Vol. 22, Liquid Crystal Chemistry (1994), edited by the Chemistry Society of Japan, Sections 4, 7 and 11, and “Liquid Crystal Apparatus Handbook” edited by the Japan Society of the Promotion of Science, Dept. 142, Section 3.

The birefringence of a bar-like liquid crystal compound for use in accordance with the invention is preferably within a range of 0.001 to 0.7.

So as to fix the aligned state of the bar-like liquid crystal compound, the compound preferably has a polymerizable group. The polymerizable group is preferably an unsaturated polymerizable group or epoxy group, more preferably an unsaturated polymerizable group, most preferably ethylenic unsaturated polymerizable group.

### (Discotic Liquid Crystal Compounds)

Discotic liquid crystal compounds include benzene derivatives described in the research report of C. Destrade, et al., Mol. Cryst., Vol. 71, page 111 (1981); torxene derivatives described in the research reports of C. Destrade, et al., Mol. Cryst., Vol. 122, page 141 (1985) and Physics Lett., A, Vol. 78, page 82 (1990); cyclohexane derivatives described in the research report of B. Kohne, et al., Angew. Chem., Vol. 96, page 70 (1984); and Azacrown-series and phenylacetylene-series macrocycle described in the research report of J. M. Lehn, et al., J. Chem. Commun., page 1794 (1985) and the research report of J. Zhang, et al., J. Am. Chem. Soc., Vol. 116, page 2655 (1994).

The discotic liquid crystal compounds also include compounds with the liquid crystal property and in a structure with structural substituents of a linear alkyl group, an alkoxy group or a substituted benzoyloxy group in a radial shape in the side chains of the mother nucleus at the molecular center. The compounds preferably provide a given alignment since the molecule or a molecular assembly is of a rotational symmetry.

As described above, the compounds finally contained in the optically anisotropic layer are not necessarily required to exert the liquid crystal property when the optically anisotropic layer is formed from a liquid crystal compound. When a low-molecular discotic liquid crystal compound has for example a group reactive with heat or light, the low-molecular discotic liquid crystal compound is polymerized or crosslinked together through the reaction of the group via heat or light, so that the discotic liquid crystal compound gets a high-molecular weight. In that case, the compounds contained in the optically anisotropic layer satisfactorily have lost the liquid crystal property. Preferable examples of the discotic liquid crystal compound are described in JP-A-Hei 8-50206. Additionally, the polymerization of discotic liquid crystal compounds is described in JP-A-Hei 8-27284.

So as to fix such discotic liquid crystal compound via polymerization, essentially, a polymerizable group should bind as a substituent to the discotic core of the discotic liquid crystal compound. When a polymerizable group is directly bound to the discotic core, it is difficult to retain the aligned state of the resulting discotic liquid crystal compound in the polymerization reaction. Therefore, a linking group is preferably introduced in between the discotic core and the polymerizable group.

In accordance with the invention, the molecule of the bar-like compound or the discotic compound is fixed at an aligned state in the optically anisotropic layer. The mean alignment direction of the molecular symmetric axis in a liquid crystal compound in the interface on the side of the optical film is at about 45° as a cross angle with the slow axis in the in-plane optical film. In this specification, the term “about 45°” means an angle within a range of 45°±5°, preferably within a range of 42° to 48°, more preferably within a range of 43° to 47°.

The mean alignment direction of the molecular symmetric axis in a liquid crystal compound can be adjusted, generally by selecting the materials for the liquid crystal compound or the alignment film or by selecting a rubbing process.

In preparing an optically compensatory film of the OCB mode in accordance with the invention, an alignment film for forming an optically anisotropic layer is first prepared by a rubbing process comprising rubbing the alignment film in a direction at 45° toward the slow axis of the cellulose acylate film, so that an optically anisotropic layer can be formed, where the mean alignment direction of the molecular symmetric axis in the liquid crystal compound in at least the interface with the cellulose acylate film is at 45° toward the slow axis of the cellulose acylate film.

For example, the optically compensatory film can be prepared continuously, by using the cellulose acylate film in a long size and with the slow axis orthogonal to the longitudinal direction. Specifically, a coating solution for forming an alignment film is continuously coated on the surface of the cellulose acylate film in a long size, to prepare a film; then, the surface of the resulting film is continuously treated for rubbing in a direction at 45° toward the longitudinal direction to prepare an alignment film; subsequently, a coating solution for forming an optically anisotropic layer containing the liquid crystal compound is continuously coated on the alignment film prepared, to align the molecule of the liquid crystal compound; by fixing the molecule at that state, further, an optically anisotropic layer is prepared. In such manner, an optically compensatory film in a long size can be prepared in a continuous way. The optically compensatory film prepared in a long size is cut into a desired shape before integration into a liquid crystal display device.

Regarding the mean alignment direction of the molecular symmetric axis on the side of the surface of the liquid crystal compound, further, the mean alignment direction of the molecular symmetric axis on the side of the atmospheric interface is preferably about 45°, more preferably 42° to 48°, still more preferably 43° to 47° toward the slow axis of the cellulose acylate film. The mean alignment direction of the molecular symmetric axis on the side of the atmospheric interface can be adjusted, by selecting the type of the liquid crystal compound or the type of an additive for use in combination with the liquid crystal compound. Examples of the additive for use in combination with the liquid crystal compound include plasticizers, surfactants, polymerizable monomers and polymers. The level of the change of the alignment direction of the molecular symmetric axis can be adjusted by selecting the types of the liquid crystal compound and an additive in the same manner as described above. Particularly, the surfactants are preferably compatible with the control of the surface tension with the coating solution.

Plasticizers, surfactants and polymerizable monomers for use in combination with the liquid crystal compound are preferably compatible with the discotic liquid crystal compound to give a change to the inclined angle of the liquid crystal compound or to cause no inhibition of the alignment. Polymerizable monomers (for example, compounds with vinyl group, vinyloxy group, acryloyloxy group and methacryloyloxy group) are preferable as such compounds. The compounds are added to an amount within a range of generally 1 to 50% by mass, preferably 5 to 30% by mass of the liquid crystal compound. When monomers with four or more polymerizable and reactive functional groups are used, the adhesion of the alignment film to the optically anisotropic layer can be raised.

When a discotic liquid compound is used as the liquid crystal compound, a polymer at a certain level of compatibility with the discotic liquid crystal compound to give a change to the inclined angle of the liquid crystal compound is preferably used.

Examples of the polymer include cellulose esters. Preferable such cellulose esters include for example cellulose acetate, cellulose acetate propionate, hydroxypropyl cellulose and cellulose acetate butyrate. So as to avoid the inhibition of the alignment of the discotic liquid crystal compound, the polymer is added at an amount within a range of preferably 0.1 to 10% by mass, more preferably 0.1 to 8% by mass, still more preferably 0.1 to 5% by mass of the discotic liquid crystal compound.

The transition temperature of the discotic liquid crystal compound between the phase of the discotic nematic liquid crystal and the solid phase is preferably 70 to 300° C., more preferably 70 to 170° C.

In accordance with the invention, the optically anisotropic layer has Re(550) at preferably 0 to 300 nm, more preferably 0 to 200 nm, still more preferably 0 to 100 nm, while the optically anisotropic layer has Rth(550) at preferably 20 to 400 nm, more preferably 50 to 200 nm. Additionally, the thickness of the optically anisotropic layer is 0.1 to 20 microns, more preferably 0.5 to 15 microns, most preferably 1 to 10 microns.

The cellulose acylate film preferable for use in accordance with the invention can be obtained by using a solution of the specific cellulose acylate and if necessary an additive in an organic solvent and then making a film from the solution.

### [Additives]

In accordance with the invention, the additives for use in the cellulose acylate solution include for example plasticizers, ultraviolet absorbents, agents for preventing deterioration, retardation (optical anisotropy) developers, retardation (optical anisotropy)-reducing agents, wavelength dispersion adjustors, dyes, microparticles, peel-off-accelerating agents and infrared absorbents. In accordance with the invention, retardation developers are preferably used. Additionally, at least one of plasticizers, ultraviolet absorbents and peel-off-accelerating agents may preferably be used.

They may be solid or oily matters. In other words, it is not required for them to have a specific melting point or boiling point. For example, ultraviolet absorbents with melting points of 20° C. or less and those with melting points of 20° C. or more may be used in mixture. A mixture of plasticizers may also be used, as described in for example JP-A-2001-151901.

### [Ultraviolet Absorbents]

Depending on the object, any appropriate type of an ultraviolet absorbent may be selected, which includes for example absorbents of salicylate ester series, benzophenone series, benzotriazole series, benzoate series, cyanoacrylate series, and nickel complex salts. Preferably, the ultraviolet absorbent is of benzophenone series, benzotriazole series or salicylate ester series.

Examples of the benzophenone-series ultraviolet absorbent are 2,4-dihydroxybenzophenone, 2-hydroxy-4-acetoxybenzophenone, 2-hydroxy-4-methoxybenzophenone, 2,2′-dihydroxy-4-methoxybenzophenone, 2,2′-dihydroxy-4,4′-methoxybenzophenone, 2-hydroxy-4-n-octoxybenzophenone, 2-hydroxy-4-dodecyloxybenzophenone, and 2-hydroxy-4-(2-hydroxy-3-methacryloyloxy)propoxybenzophenone.

Ultraviolet absorbents of benzotriazole series include for example 2-(2′-hydroxy-3′-tert-butyl-5′-methylphenyl)-5-chlorobenzotriazole, 2-(2′-hydroxy-5′-tert-butylphenyl)benzotriazole, 2-(2′-hydroxy-3′,5′-di-t-amylphenyl)benzotriazole, 2-(2′-hydroxy-3′,5′-di-t-butylphenyl)-5-chlorobenzotriazole, and 2-(2′-hydroxy-5′-t-octylphenyl)benzotriazole.

Ultraviolet absorbents of salicylate ester series include for example phenyl salicylate, p-octylphenyl salicylate, and p-tert-butylphenyl salicylate.

Among these listed ultraviolet absorbents, particularly preferable are 2-hydroxy-4-methoxybenzophenone, 2,2′-dihydroxy-4,4′-methoxybenzophenone, 2-(2′-hydroxy-3′-tert-butyl-5′-methylphenyl)-5-chlorobenzotriazole, 2-(2′-hydroxy-5′-t-butylphenyl)benzotriazole, 2-(2′-hydroxy-3′,5′-di-t-amylphenyl)benzotriazole, and 2-(2′-hydroxy-3′,5′-di-t-butylphenyl)-5-chlorobenzotriazol.

The use of such ultraviolet absorbents in combination with plural absorbents with different absorption wavelengths is preferable because the use thereof brings about a higher shielding effect within a wide wavelength range. As the ultraviolet absorbent for use in liquid crystals, preference is given to ultraviolet absorbents with excellent ultraviolet absorption potencies at a wavelength of 370 nm or less from the respect of preventing the deterioration of liquid crystal and with less absorption of visible ray at a wavelength of 400 nm or more from the respect of liquid crystal display feature. Particularly preferable ultraviolet absorbents are the benzotriazole-series compounds, benzophenone-series compounds, and salicylate ester-series compounds described above. Among them, the benzotriazole-series compounds are preferable because the compounds less colorize cellulose esters.

As the ultraviolet absorbent, further, there are used compounds described in individual official gazettes of JP-A-Sho 60-235852, JP-A-Hei 3-199201, JP-A-Hei 5-1907073, JP-A-Hei 5-194789, JP-A-Hei 5-271471, JP-A-Hei 6-107854, JP-A-Hei 6-118233, JP-A-Hei 6-148430, JP-A-Hei 7-11056, JP-A-Hei 7-11055, JP-A-Hei 7-11056, JP-A-Hei 8-29619, JP-A-Hei 8-239509, and JP-A-2000-204173.

The ultraviolet absorbent may be added at an amount of preferably 0.001 to 5% by mass, more preferably 0.01 to 1% by mass of the cellulose acylate. When the amount is at 0.001% by mass or more, preferably, the effect of the addition can be exerted sufficiently. When the amount is at 5% by mass or less, preferably, the bleed-out of the ultraviolet absorbent onto the film surface can be suppressed.

Additionally, the ultraviolet absorbent may be added concurrently with the dissolution of the cellulose acylate, or may be added to a dope thereof after dissolution. Using a static mixer and the like, an ultraviolet absorbent solution is preferably added to the dope just before casting, because the spectroscopic absorption profile can readily be adjusted through such addition.

### [Agents for Preventing Deterioration]

The agents for preventing deterioration can prevent the deterioration and decomposition of cellulose triacetate, cellulose acylate and the like. The agents for preventing deterioration include for example butylamine, hindered amine compounds (JP-A-Hei 8-325537), guanidine compounds (JP-A-Hei 5-271471), benzotriazole-series UV absorbents (JP-A-Hei 6-235819), and benzophenone-series UV absorbents (JP-A-Hei 6-118233).

### [Plasticizers]

The plasticizers include for example phosphate esters and carboxylate esters. Phosphate ester-series plasticizers include for example triphenyl phosphate (TPP), tricresyl phosphate (TCP), cresyldiphenyl phosphate, octyldiphenyl phosphate, biphenyldiphenyl phosphate (BDP), trioctyl phosphate, and tributyl phosphate; and the carboxylate ester-series plasticizers include for example dimethyl phthalate (DMP), diethyl phthalate (DEP), dibutyl phthalate (DBP), dioctyl phthalate (DOP), diphenyl phthalate (DPP), diethylhexyl phthalate (DEHP), o-acetylcitrate triethyl ester (OACTE), o-acetylcitrate tributyl ester (OACTB), citrate acetyltriethyl ester, citrate acetyltributyl ester, oleate butyl ester, ricinoleate methylacetyl ester, sebacate dibutyl ester, triacetin, tributyrin, butyl phthalylbutyl glycolate, ethyl phthalylethyl glycolate, methyl phthalylethyl glycolate, and butyl phthalylbutyl glycolate. The plasticizer for use in accordance with the invention is preferably selected from these plasticizers listed above. Further, the plasticizer is preferably (di)pentaerythritol esters, glycerol esters and diglycerol esters.

### [Release-Accelerating Agents]

The peel-off-accelerating agents include for example ethyl esters of citric acid.

### [Infrared Absorbents]

Additionally, the infrared absorbents are those described in for example JP-A-2001-194522.

### [Timing for Addition, and Others]

As to the timing for adding these additives, the additives may be added at any step of preparing the dope. To the final preparation step in the process of dope preparation, a step for adding the additives for the preparation may be added. Still further, the amounts of individual materials to be added are not specifically limited as long as their functions can be exerted at those amounts.

Additionally in case that the cellulose acylate film is in a multilayer, the types and amounts of additives to be added to the individual layers may be variable. These are techniques known in the related art, as described in for example JP-A-2001-151902.

By selecting the types and amounts of these additives to be added, the larger elastic modulus of the cellulose acylate film as measured with a tensile tester “Strograph-R2” (manufactured by Toyo Seiki Co., Ltd.) is preferably preset at 2000 to 8000 MPa, more preferably 3000 to 7000 MPa, still more preferably 3500 to 6000 MPa. Further, the glass transition temperature Tg of the cellulose acylate film as measured with a dynamic viscoelastometer “Vibron:DVA-225” (manufactured by IT Control Corporation) is preferably preset at 70 to 150° C., more preferably 80 to 135° C. In other words, the cellulose acylate film preferable for use in accordance with the invention has a glass transition temperature “Tg” and an elastic modulus within the respective ranges described above, so as to allow the cellulose acylate film to be suitable for the steps for processing a polarizing plate and assembling a liquid crystal display device.

Furthermore, additives described in detail in the Japan Institute of Invention and Innovation (JIII), Journal of Technical Disclosure (Kokai Gihou), Technical No. 2001-1745 (issued on Mar. 15, 2001), page 16 and thereafter may appropriately be used as such additives.

### [Retardation-Reducing Agents]

Retardation-reducing agents for use in reducing the optical anisotropy of the cellulose acylate film are now described below.

Using a compound suppressing the alignment of cellulose acylate in the film in the in-plane and thickness directions, the optical anisotropy can be reduced sufficiently, to adjust the Re and Rth values to zero or a value close to zero. Therefore, a compound for reducing optical anisotropy is sufficiently compatible with cellulose acylate, so that the compound per se is not in a bar-like structure or a plane structure, advantageously. When the compound has plural plane functional groups such as aromatic group, specifically, these functional groups are not on the same plane but are in a non-plane conformation.

### (LogP Value)

So as to prepare the cellulose acylate film with a low level of optical anisotropy, preference is given to a compound with an octanol/water partition coefficient (logP value) of 0 to 7 among such compounds for reducing optical anisotropy by suppressing the alignment of cellulose acylate in the film in the in-plane and thickness directions. When the logP value of such compound is 7 or less, preferably, the compound is highly compatible with cellulose acylate, hardly involving disadvantages such as the occurrence of film opaqueness and powdery state.

When the logP value of the compound is 0 or more, preferably, the hydrophilicity of the compound is never at a too high level leading to the deterioration of the water resistance of cellulose acylate film. The logP value is within a range of preferably 1 to 6, particularly preferably 1.5 to 5.

The octanol/water partition coefficient (logP value) is measured by the flask shaking method described in JIS Z-7260-107 (2000). Additionally, the octanol/water partition coefficient (logP value) can be estimated by computation approaches or empirical processes.

As the computation approaches, the Crippens fragmentation method [“J. Chem. Inf. Comput. Sci.”, Vol. 27, p 21 (1987)], the Viswanadhan's fragmentation method [“J. Chem. Inf. Comput. Sci.”, Vol. 29, p 163 (1989)], the Broto's fragmentation method [“Eur. J. Med. Chem.-Chim. Theor.”, Vol. 19, p 71 (1984)] are preferably used. The alignment of cellulose acylate in the film in the in-plane and thickness directions is more preferable. The Crippens fragmentation method [“J. Chem. Inf. Comput. Sci.”, Vol. 27, p 21 (1987)] is more preferable.

When the logP value of a compound varies in a manner dependent on the measuring method or the computation method, preferably, the Crippens fragmentation method is used for determining whether or not the compound is within the ranges described above.

### (Physico-Chemical Properties of Compound for Reducing Optical Anisotropy)

The compound for reducing optical anisotropy may or may not contain an aromatic group. The compound for reducing optical anisotropy is of a molecular weight of preferably 150 or more to 3000 or less, more preferably 170 or more to 2000 or less, particularly preferably 200 or more to 1000 or less. Within the molecular weight ranges, the compound may satisfactorily be in a specific monomer structure or in an oligomer structure or polymer structure comprising a plurality of the monomer unit bound together.

The compound for reducing optical anisotropy is preferably a liquid at 25° C. or a solid with a melting point of 25 to 250° C., more preferably a liquid at 25° C. or a solid with a melting point of 25 to 200° C. Preferably, the compound for reducing optical anisotropy never evaporates during the steps of dope casting and drying in the course of preparing the cellulose acylate film.

The compound for reducing optical anisotropy is added at an amount of preferably 0.01 to 30% by mass, more preferably 1 to 25% by mass, particularly preferably 5 to 20% by mass of cellulose acylate.

The compound for reducing optical anisotropy may be used singly or may be used in combination of a mixture of two types or more of such compound at an appropriate ratio.

The compound for reducing optical anisotropy may be added in any timing during the dope preparation step or finally in the dope preparation step.

The mean content of the compound for reducing optical anisotropy in a region from the surface on at least one of the sides to 10% of the total film thickness is preferably 80 to 99% of the mean content of the compound in the center of the cellulose acylate film. The amount of the existing compound for reducing optical anisotropy can be determined by measuring the amount of the compound on the surface and in the center by such a method using IR absorption spectrum as described in JP-A-Hei 8-57879 and the like.

### [Dyes]

In accordance with the invention, a dye for controlling the tint may satisfactorily be added. The content of such dye is preferably 10 to 1000 ppm, more preferably 50 to 500 ppm on a mass basis of cellulose acylate. By allowing the cellulose acylate to contain such dye, the light piping of the cellulose acylate film can be reduced, to improve the yellow tone. These compounds may be added together with cellulose acylate and a solvent in preparing a cellulose acylate solution, or during or after the preparation of the solution. Additionally, such dye may be added to an ultraviolet absorbent solution to be added in-line. Dyes described in JP-A-Hei 5-34858 may be used.

### [Microparticles as Mat Agent]

Microparticles are preferably added as a mat agent to the cellulose acylate film preferable for use in accordance with the invention. The microparticles for use in accordance with the invention include silicone dioxide, titanium dioxide, aluminium oxide, zirconium oxide, calcium carbonate, talc, clay, sintered kaolin, sintered calcium silicate, hydrated calcium silicate, aluminium silicate, magnesium silicate and calcium phosphate. Microparticles containing silicone are preferable because such microparticles can yield low turbidity. Particularly, silicone dioxide is preferable.

Microparticles of silicone dioxide are of a primary mean particle size of 20 nm or less and with an apparent specific density of 70 g/L or more. When the mean particle size of the primary particle is as small as 5 to 16 nm, such particles preferably can reduce the haze of the film. The apparent specific density is preferably 90 to 200 g/L or more, more preferably 100 to 200 g/L or more. A larger apparent specific density makes a higher concentration of a dispersion solution, preferably leading to the improvement of the haze and aggregates.

The amount of silicone dioxide microparticles when used as a mat agent is an amount corresponding to 0.01 to 0.3 part by mass to 100 parts by mass of the polymer components including the cellulose acylate.

These microparticles generally form a secondary particle of a mean particle size of 0.1 to 3.0 μm. In the film, nonetheless, the secondary particle exists in an aggregate of the primary particle, to form protrusions and recesses of 0.1 to 3.0 μm on the film surface. The mean particle size of the secondary particle is preferably 0.2 μm or more to 1.5 μm or less, more preferably 0.4 μm or more to 1.2 μm or less, most preferably 0.6 μm or more to 1.1 μm or less. When the mean particle size is 1.5 μm or less, the resulting haze is not at a too high level. When the mean particle size is 0.2 μm or more, preferably, such particles can sufficiently exert an effect of preventing creaking.

The primary and secondary particle sizes of such particles can be determined by measuring the diameter of a circle circumscribed to the particles under observation of the particles in the film with a scanning electron microscope. Under observation of 200 particles in a different zone, the sizes are determined to calculate the average as mean particle size.

As the microparticles of silicone dioxide, for example, commercially available products such as “Aerosil” R972, R972V, R974, R812, 200, 200V, 300, R202, OX50, and TT600 [manufactured by Japan Aerosil Co., Ltd.] may be used. Microparticles of zirconium oxide are commercially available for example under the trade names of “Aerosil” R976 and R811 [manufactured by Japan Aerosil Co., Ltd.]. They may also be used.

Among them, “Aerosol 200V” and “Aerosil R972V” are silicone dioxide microparticles of a mean primary particle size of 20 nm or less and with an apparent specific density of 70 g/L or more, which are particularly preferable since the microparticles have a large effect on the reduction of friction coefficient while the microparticles can retain the turbidity of the optical film at a low level.

In accordance with the invention, various methods may be adopted to prepare a dispersion solution of microparticles, so as to obtain the cellulose acylate film containing particles of a small mean secondary particle size. For example, a method is listed, comprising preliminarily preparing a dispersion solution of microparticles by mixing a solvent with microparticles under agitation, dissolving the dispersion solution of microparticles in a small volume of a cellulose acylate solution by adding the dispersion solution to the cellulose acylate solution, and then mixing the resulting solution with the main cellulose acylate dope solution. The method is a preferable preparative method because the dispersibility of silicone dioxide microparticles is so high that the silicone dioxide microparticles hardly aggregate again. An additional method comprises adding a small amount of cellulose ester to a solvent, for dissolution and agitation, adding then the microparticles to the resulting solution for dispersion with a dispersing machine, to prepare a microparticle-added solution, and sufficiently mixing the microparticle-added solution with a dope solution with an in-line mixer. In accordance with the invention, any method is applicable with no limitation to the methods described above. The concentration of silicone dioxide in mixing silicone dioxide microparticles with a solvent and the like for dispersion is at preferably 5 to 30% by mass, more preferably 10 to 25% by mass and most preferably 15 to 20% by mass.

At a higher concentration of the dispersion, preferably, the solution turbidity gets lower for the addition amount thereof, so that the haze and aggregates are improved. The final amount of a mat agent to be added to the cellulose acylate in the dope solution is preferably 0.01 to 1.0 g, more preferably 0.03 to 0.3 g, most preferably 0.08 to 0.16 g per 1 m².

The solvent for use includes for example lower alcohols preferably including methyl alcohol, ethyl alcohol, propyl alcohol, isopropyl alcohol and butyl alcohol. Solvents other than lower alcohols include but are not limited to solvents for use in making cellulose ester film.

The organic solvent for dissolving cellulose acylate, preferable for use in accordance with the invention is now described below.

In accordance with the invention, chlorine-series solvents mainly using chlorine-series organic solvents and non-chlorine-series solvents are both used as the organic solvent described above.

### [Chlorine-Series Solvents]

In preparing a cellulose acylate solution preferable for use in accordance with the invention, a chlorine-series organic solvent is preferably used as the main solvent. In accordance with the invention, any types of chlorine-series organic solvents with no specific limitation may be used within a range such that cellulose acylate can be dissolved, cast and filmed therein, as long as the chlorine-series organic solvents can attain the objects of the invention. These chlorine-series organic solvents are preferably dichloromethane and chloroform. Dichloromethane is particularly preferable. Additionally, organic solvents other than chlorine-series organic solvents may be mixed without any problem. In that case, dichloromethane is preferably used at least at 50% by mass in the total amount of organic solvents.

Other organic solvents for use in combination with chlorine-series organic solvents are described below in accordance with the invention.

In other words, other preferable organic solvents are selected from esters, ketones, ethers, alcohols and hydrocarbons with 3 to 12 carbon atoms. Esters, ketones, ethers and alcohols may contain a cyclic structure. A compound with two or more of ester-, ketone- and ether functional groups (namely, —O—, —CO— and —COO—) may also be used as the solvent. The organic solvents may simultaneously contain for example other functional groups such as alcoholic hydroxyl group. In case of a solvent with two types or more functional groups, the number of carbon atoms thereof may satisfactorily be within a range defined for a compound with any of the functional groups. Esters with 3 to 12 carbon atoms include for example ethyl formate, propyl formate, pentyl formate, methyl acetate, ethyl acetate and pentyl acetate. Ketones with 3 to 12 carbon atoms include for example acetone, methyl ethyl ketone, diethyl ketone, diisobutyl ketone, cyclopentanone, cyclohexanone and methylcyclohexanone. Ethers with 3 to 12 carbon atoms include for example diisopropyl ether, dimethoxymethane, dimethoxyethane, 1,4-dioxane, 1,3-dioxolane, tetrahydrofuran, anisole and phenetole. The organic solvent with two types or more of functional groups includes for example 2-ethoxyethyl acetate, 2-methoxyethanol and 2-butoxyethanol.

Alcohol for use in combination with the chlorine-series organic solvent is preferably linear, branched or cyclic. Among them, saturated aliphatic hydrocarbon is preferable as the alcohol. The alcohol may be primary, secondary or tertiary in terms of the hydroxyl group therein. The alcohol includes for example methanol, ethanol, 1-propanol, 2-propanol, 1-butanol, 2-butanol, t-butanol, 1-pentanol, 2-methyl-2-butanol and cyclohexanol. As the alcohol, fluorine-series alcohol may also be used. For example, such alcohol includes for example 2-fluoroethanol, 2,2,2-trifluroethanol, and 2,2,3,3-tetrafluoro-1-propanol. Further, the hydrocarbon may be linear, branched or cyclic. Any of aromatic hydrocarbons and aliphatic hydrocarbons may be used. The aliphatic hydrocarbon may be saturated or unsaturated. The hydrocarbon includes for example cyclohexane, hexane, benzene, toluene and xylene.

Combination examples of the chlorine-series organic solvent and another organic solvent include but are not limited to those of the following compositions.
Dichloromethane/methanol/ethanol/butanol=80/10/5/5 (parts by mass).
Dichloromethane/acetone/methanol/propanol=80/10/5/5 (parts by mass).
Dichloromethane/methanol/butanol/cyclohexane=80/10/5/5 (parts by mass).
Dichloromethane/methyl ethyl ketone/methanol/butanol=80/10/5/5 (parts by mass).
Dichloromethane/acetone/methyl ethyl ketone/ethanol/isopropanol=75/8/5/5/7 (parts by mass).
Dichloromethane/cyclopentanone/methanol/isopropanol=80/7/5/8 (parts by mass).
Dichloromethane/methyl acetate/butanol=80/10/10 (parts by mass).
Dichloromethane/cyclohexanone/methanol/hexane=70/20/5/5 (parts by mass).
Dichloromethane/methyl ethyl ketone/acetone/methanol/ethanol=50/20/20/5/5 (parts by mass).
Dichloromethane/1,3-dioxolane/methanol/ethanol=70/20/5/5 (parts by mass).
Dichloromethane/dioxane/acetone/methanol/ethanol=60/20/10/5/5 (parts by mass).
Dichloromethane/acetone/cyclopentanone/ethanol/isobutanol/cyclohexane=65/10/10/5/5/5 (parts by mass).
Dichloromethane/methyl ethyl ketone/acetone/methanol/ethanol=70/10/10/5/5 (parts by mass).
Dichloromethane/acetone/ethyl acetate/ethanol/butanol/hexane=65/10/10/5/5/5 (parts by mass).
Dichloromethane/methyl acetoacetate/methanol/ethanol=65/20/10/5 (parts by mass).
Dichloromethane/cyclopentanone/ethanol/butanol=65/20/10/5 (parts by mass).

### [Non-Chlorine-Series Solvents]

A non-chlorine-series organic solvent preferable for use in preparing a cellulose acylate solution in accordance with the invention is now described. In accordance with the invention, any types of non-chlorine-series organic solvents with no specific limitation may be used within a range such that cellulose acylate can be dissolved, cast and filmed therein, as long as the non-chlorine-series organic solvents can attain the objects of the invention. The non-chlorine-series organic solvents for use in accordance with the invention are preferably solvents selected from esters, ketones and ethers with 3 to 12 carbon atoms. The esters, ketones, and ethers may contain a cyclic structure. A compound with two or more of ester-, ketone- and ether functional groups (namely, —O—, —CO— and —COO—) may also be used as the main solvent. The organic solvents may simultaneously contain for example other functional groups such as alcoholic hydroxyl group. In case of a main solvent with two types or more functional groups, the number of carbon atoms thereof may satisfactorily be within a range defined for a compound with any of the functional groups. Esters with 3 to 12 carbon atoms include for example ethyl formate, propyl formate, pentyl formate, methyl acetate, ethyl acetate and pentyl acetate. Ketones with 3 to 12 carbon atoms include for example acetone, methyl ethyl ketone, diethyl ketone, diisobutyl ketone, cyclopentanone, cylohexanone, methylcyclohexanone and methyl acetoacetate. Ethers with 3 to 12 carbon atoms include for example diisopropyl ether, dimethoxymethane, dimethoxyethane, 1,4-dioxane, 1,3-dioxolane, tetrahydrofuran, anisole and phenetole. The organic solvent with two types or more functional groups includes for example 2-ethoxyethyl acetate, 2-methoxyethanol and 2-butoxyethanol.

The non-chlorine-series organic solvent for use for cellulose acylate as described above is selected from the aforementioned standpoints. Nonetheless, the non-chlorine-series organic solvent is preferably as follows.

In other words, the non-chlorine-series organic solvent is preferably a mix solvent containing the non-chlorine-series organic solvent as the main solvent and additionally three different types of solvents, where a first solvent is at least one selected from methyl acetate, ethyl acetate, methyl formate, ethyl formate, acetone, dioxolane and dioxane or a mix solution thereof; a second solvent is selected from ketones or acetoacetate esters with 4 to 7 carbon atoms; and a third solvent is an alcohol or a hydrocarbon with one to 10 carbon atoms, more preferably an alcohol with one to 8 carbon atoms. When the first solvent is a mix solution of two types or more solvents, the second solvent may not be necessary. The first solvent is more preferably methyl acetate, acetone, methyl formate, ethyl formate or a mixture thereof, while the second solvent is preferably methyl ethyl ketone, cyclopentanone, cyclohexanone and methyl acetoacetate or a mix solvent thereof.

In the third solvent alcohol, the hydrocarbon chain may be linear, branched or cyclic. Among them, the alcohol is preferably a saturated aliphatic hydrocarbon chain. The alcohol may be primary, secondary or tertiary in terms of the hydroxyl group therein. Examples of the alcohol include methanol, ethanol, 1-propanol, 2-propanol, 1-butanol, 2-butanol, t-butanol, 1-pentanol, 2-methyl-2-butanol and cyclohexanol. As the alcohol, herein, fluorine-series alcohols prepared by substituting a part or all of the hydrogens in the hydrocarbon chain with fluorine may also be used. For example, such alcohols include for example 2-fluoroethanol, 2,2,2-trifluroethanol, and 2,2,3,3-tetrafluoro-1-propanol.

Further, the hydrocarbon may be linear, branched or cyclic. Any of aromatic hydrocarbons and aliphatic hydrocarbons may be used. The aliphatic hydrocarbon may be saturated or unsaturated. The hydrocarbon includes for example cyclohexane, hexane, benzene, toluene and xylene.

The alcohol and the hydrocarbon as the third solvent may be used singly or in combination of two types or more thereof in mixture. As the third solvent, preferable compounds specifically include for example methanol, ethanol, 1-propanol, 2-propanol, 1-butanol, 2-butanol and cyclohexanol as the alcohol, while as the hydrocarbon, preferable compounds specifically include cyclohexane and hexane. Particularly preferable are methanol, ethanol, 1-propanol, 2-propanol and 1-butanol.

In the total amount of a mixture solvent of the aforementioned three types of solvents, the first solvent is at a mix ratio of preferably 20 to 95% by mass; the second solvent, 2 to 60% by mass; and the third solvent, 2 to 30% by mass. More preferably, the first solvent is at a mix ratio of preferably 30 to 90% by mass; the second solvent, 3 to 50% by mass; and the third solvent, 3 to 25% by mass. Particularly, the first solvent is at a mix ratio of preferably 30 to 90% by mass; the second solvent, 3 to 30% by mass; and the third solvent, 3 to 15% by mass.

The non-chlorine-series organic solvent for use in accordance with the invention as described above is described in detail in the Japan Institute of Invention and Innovation (JIII), Journal of Technical Disclosure (Kokai Gihou), Technical No. 2001-1745 (issued on Mar. 15, 2001), page 12 to page 16.

Preferable combinations of non-chlorine-series organic solvents in accordance with the invention are listed below but are not limited to them.
Methyl acetate/acetone/methanol/ethanol/butanol=75/10/5/5/5 (parts by mass).
Methyl acetate/acetone/methanol/ethanol/propanol=75/10/5/5/5 (parts by mass).
Methyl acetate/acetone/methanol/butanol/cyclohexane=75/10/5/5/5 (parts by mass).
Methyl acetate/acetone/ethanol/butanol=81/8/7/4 (parts by mass).
Methyl acetate/acetone/ethanol/butanol=82/10/4/4 (parts by mass).
Methyl acetate/acetone/ethanol/butanol=80/10/4/6 (parts by mass).
Methyl acetate/methyl ethyl ketone/methanol/butanol=80/10/5/5 (parts by mass).
Methyl acetate/acetone/methyl ethyl ketone/ethanol/isopropanol=75/8/5/5/7 (parts by mass).
Methyl acetate/cyclopentanone/methanol/isopropanol=80/7/5/8 (parts by mass).
Methyl acetate/acetone/butanol=85/10/5 (parts by mass).
Methyl acetate/cyclopentanone/acetone/methanol/butanol=60/15/14/5/6 (parts by mass).
Methyl acetate/cyclohexanone/methanol/hexane=70/20/5/5 (parts by mass).
Methyl acetate/methyl ethyl ketone/acetone/methanol/ethanol=50/20/20/5/5 (parts by mass).
Methyl acetate/1,3-dioxolane/methanol/ethanol=70/20/5/5 (parts by mass).
Methyl acetate/dioxane/acetone/methanol/ethanol=60/20/10/5/5 (parts by mass).
Methyl acetate/acetone/cyclopentanone/ethanol/isobutanol/cyclohexane=65/10/10/5/5/5 (parts by mass).
Methyl formate/methyl ethyl ketone/acetone/methanol/ethanol=50/20/20/5/5 (parts by mass).
Methyl formate/acetone/ethyl acetate/ethanol/butanol/hexane=65/10/10/5/5/5 (parts by mass).
Acetone/methyl acetoacetate/methanol/ethanol=65/20/10/5 (parts by mass).
Acetone/cyclopentanone/ethanol/butanol=65/20/10/5 (parts by mass). Acetone/1,3-dioxolane/ethanol/butanol=65/20/10/5 (parts by mass).
1,3-Dioxolane/cyclohexanone/methyl ethyl ketone/methanol/butanol=55/20/10/5/5/5 (parts by mass).

A cellulose acylate solution prepared by the following methods may also be used:

a method comprising preparing a cellulose acylate solution at a ratio of methyl acetate/acetone/ethanol/butanol=81/8/7/4 (parts by mass) followed by filtration and concentration, and additionally adding 2 parts by mass of butanol;

a method comprising preparing a cellulose acylate solution at a ratio of methyl acetate/acetone/ethanol/butanol=84/10/4/2 (parts by mass) followed by filtration and concentration, and additionally adding 4 parts by mass of butanol; and

a method comprising preparing a cellulose acylate solution at a ratio of methyl acetate/acetone/ethanol=84/10/6 (parts by mass) followed by filtration and concentration, and additionally adding 5 parts by mass of butanol.

The dope for use in accordance with the invention may contain dichloromethane at 10% by mass of the total amount of the organic solvents in accordance with the invention, other than the non-chlorine organic solvents in accordance with the invention.

### [Properties of Cellulose Acylate Solution]

The cellulose acylate solution is a solution of cellulose acylate dissolved in the organic solvent. The concentration thereof is preferably within a range of 10 to 30% by mass in view of the suitable properties for filming and casting. More preferably, the concentration is 13 to 27% by mass, particularly preferably 15 to 25% by mass.

A method for adjusting the cellulose acylate solution to such concentration range comprises adjusting the solution to a given concentration at the stage of dissolution, or comprises preliminarily preparing a solution at a low concentration (for example at 9 to 14% by mass) and subsequently adjusting the resulting solution to a given high concentration at the concentration step described below. Further, the cellulose acylate solution is preliminarily prepared at a high concentration, which is subsequently prepared at a given low concentration by adding various additives. By any of such methods, the cellulose acylate solution is adjusted to a concentration preferable for use in accordance with the invention, with no specific problem.

In accordance with the invention, further, the molecular weight of associated cellulose acylate in the cellulose acylate solution when diluted to 0.1 to 5% by mass with an organic solvent of the same composition is 150000 to 15000000, preferably in terms of the solvent solubility. The molecular weight of associated cellulose acylate is more preferably 180000 to 9000000. The molecular weight of associated cellulose acylate can be determined by the static light scattering process. The associated cellulose acylate solution is preferably dissolved to an inertia radius of 10 to 200 nm, which is determined simultaneously. Further, the inertia radius is more preferably 20 to 200 nm. Still further, the associated cellulose acylate is dissolved to a second virial coefficient of preferably −2×10⁻⁴ to +4×10⁻⁴, more preferably −2×10−4 to +2×10⁴.

The definition of the molecular weight of associated cellulose acylate as well as the definitions of inertia radius and second virial coefficient are described below. According to the following methods, these are measured using the static light scattering process. The measurement is done in a diluted zone for the convenience of such apparatus. However, the resulting measured values reflect the dope performance in the high concentration region in accordance with the invention.

First, cellulose acylate is dissolved in a solvent for use in doping, to prepare solutions at 0.1, 0.2, 0.3, and 0.4% by mass. So as to avoid hygroscopicity, cellulose acylate is dried at 120° C. for 2 hours and then weighed at 25° C. and 10% RH. According to the methods for dissolving dope (dissolution method at ambient temperature, cooling dissolution method, and dissolution method at high temperature), the dope is dissolved. Continuously, these solutions and the solvent are filtered through a 0.2-μm Teflon (under trade name) filter. Then, the static light scattering of the filtered solutions is measured at 25° C., and at an interval of 10° C. from 30° C. to 140° C., using a light scattering measuring apparatus “DLS-700” (manufactured by Otsuka Electronics Co., Ltd.). The resulting data are analyzed by the BERRY plot method. As the refractive index needed for the analysis, the refractive index value of the solvent as determined with an Abbe refractometer is used. Using a differential refractometer “DRM-1021” (manufactured by Otsuka Electronics Co, Ltd.), the refractive index on concentration gradient (dn/dc) is measured using the solvent and the solutions used for the light scattering measurement.

### [Dope Preparation]

The preparation of a solution (dope) for cellulose acylate casting and filming is now described below.

Cellulose acylate may be dissolved by any method including for example dissolution method at ambient temperature, cooling dissolution method or high-temperature dissolution method, or a combination thereof with no specific limitation. Concerning them, preparative methods of cellulose acylate solutions are described in individual official gazettes of for example JP-A-Hei 5-163301, JP-A-Sho 61-106628, JP-A-Sho 58-127737, JP-A-Hei 9-95544, JP-A-Hei 10-95854, JP-A-Hei 10-45950, JP-A-2000-53784, JP-A-Hei 11-322946, JP-A-Hei 11-322947, JP-A-Hei 2-276830, JP-A-2000-273239, JP-A-Hei 11-71463, JP-A-Hei 04-259511, JP-A-2000-273184, JP-A-Hei 11-323017 and JP-A-Hei 11-302388.

These methods for dissolving cellulose acylate in the organic solvent as described above are also applicable in accordance with the invention, as long as the methods are within the scope of the invention. The details thereof, particularly the details of the non-chlorine-series solvents are described in the Japan Institute of Invention and Innovation (JIII), Journal of Technical Disclosure (Kokai Gihou), Technical No. 2001-1745 (issued on Mar. 15, 2001), page 22 to page 25. According to the method, cellulose acylate can be dissolved in such non-chlorine-series organic solvents. The dope solution of cellulose acylate preferable for use in accordance with the invention is generally concentrated and filtered. The details thereof are also described in the Japan Institute of Invention and Innovation (JIII), Journal of Technical Disclosure (Kokai Gihou), Technical No. 2001-1745 (issued on Mar. 15, 2001), page 25. In case of the dissolution at high temperature, the high temperature is mostly the boiling point of an organic solvent used or higher. In that case, therefore, the dissolution is done at a state under pressure.

The cellulose acylate solution within the following ranges of the solution viscosity and the dynamic storage elastic modulus is preferable because the cellulose acylate solution can readily be cast. These values are measured using a sample solution of 1 mL and a rheometer “CLS 500” with “Steel Cone” of a diameter 4 cm/2° (both manufactured by TA Instruments). The measurement conditions are as follows. With Oscillation Step/Temperature Ramp, the range of 40° C. to −10° C. is made adjustable at 2° C./min, for the measurement. Then, the static non-Newton viscosity n^{#}″(Pa·s) at 40° C. and the storage elastic modulus “G′” at −5° C. are determined. Herein, the sample solution is preliminarily kept warm at a constant liquid temperature, namely the temperature for starting the measurement.

In accordance with the invention, preferably, the viscosity at 40° C. is 1 to 400 Pa·s and the dynamic storage elastic modulus at 15° C. is 500 Pa or more. More preferably, the viscosity at 40° C. is 10 to 200 Pa·s and the dynamic storage elastic modulus at 15° C. is 100 to 1000000 Pa. A larger dynamic storage elastic modulus at low temperature is more preferable. For a cast support at −5° C., for example, the dynamic storage elastic modulus thereof at −5° C. is preferably 10000 to 1000000 Pa. For a cast support at −50° C., for example, the dynamic storage elastic modulus thereof at −50° C. is more preferably 10000 to 5000000 Pa.

In accordance with the invention, a high-concentration dope is obtained because the specific cellulose acylate is used. Thus, a cellulose acylate solution at a high concentration and great stability can be obtained with no use of any concentration method. For readier dissolution, a solution dissolved at a low concentration may be concentrated, using a concentration method. The concentration method includes for example but is not limited to a method comprising introducing a low-concentration solution in between the cylinder body and the rotation locus of the outer periphery of a rotation wing rotating in the periphery direction inside the cylinder, concurrently giving a temperature difference from the solution to evaporate the solvent to obtain a high-concentration solution (for example, JP-A-Hei 4-259511); a method comprising blowing a heated low-concentration solution from a nozzle into the inside of a container, making the solvent flush-evaporate between the nozzle and the inner container wall, simultaneously drawing the solvent vapor out of the container, and drawing the resulting high-concentration solution from the bottom of the container (methods described in for example the individual specifications of U.S. Pat. Nos. 2,541,012, 2,858,229, 4,414,341, and 4,504,355).

Using an appropriate filter material such as metal net or flannel, non-dissolved matters or exogenous matters such as liter or impurities are preferably filtered off prior to casting. For filtration of the cellulose acylate solution, a filter with an absolute filtration precision of preferably 0.1 to 100 μm, more preferably 0.5 to 25 μm is used. The thickness of such filter is preferably 0.1 to 10 mm, more preferably 0.2 to 2 mm. In that case, the filtration pressure is preferably 1.6 MPa or less, more preferably 1.2 MPa or less, still more preferably 1.0 MPa or less, particularly preferably 0.2 MPa or less. As the filtration material, materials known in the art such as glass fiber, cellulose fiber, filter paper, and fluorine resins such as tetrafluoroethylene resin are preferably used. For example, ceramics and metals are particularly preferably used. The viscosity of the cellulose acylate solution just before filming is satisfactorily any viscosity within a range with a casting possibility during filming. Generally, the viscosity thereof is prepared within a range of preferably 10 Pa·s to 2000 Pa·s, more preferably 30 Pa·s to 1000 Pa·s, still more preferably 40 Pa·s to 500 Pa·s. Additionally, the temperature then is satisfactorily the temperature during casting, with no specific limitation. The temperature is preferably −5 to +70° C., more preferably −5 to +55° C.

### [Film Preparation]

The cellulose acylate film preferable for use in accordance with the invention can be obtained by making the film using the cellulose acylate solution (dope). As the filming method and a facility therefor, solution casting filming methods for producing cellulose triacetate film in the related art and solution casting filming apparatuses therefor may be used. A dope (cellulose acylate solution) prepared from a dissolving machine (caldron) is once stored in a storage caldron, to remove foam contained in the dope for final preparation. The dope is transferred from a dope discharge outlet through for example a pressure-type quantitative gear pump capable of constantly transferring a preset volume of a solution at high precision, owing to the rotation number, to a pressure-type die, where the dope is cast uniformly from the orifice (slit) of the pressure-type die onto a metal support at a cast part endlessly running; a semi-dried dope film (sometimes called web) is peeled off from the metal support at a peel-off point, where the metal support makes an almost round-trip. Both ends of the resulting web are held with clips; while retaining the width, the web is transferred with a tenter for drying; continuously, the web is transferred with a group of rolls of a drying apparatus, where the drying is completed; and then, the web is rolled with a roller to a given length. A combination of the tenter and the drying apparatus with a group of rolls varies, depending on the object. For the solution casting filming method for use in producing functional protective films for use in electronic displays, frequently, a coating apparatus for film surface treatment for preparing for example an underlining layer, an antistatic layer, a halation-preventing layer and a protective layer is needed in addition to the solution casting filming apparatus. The individual production steps are briefly described below but in no way for limitation.

For preparing a cellulose acylate film by the solvent cast method, first, the prepared cellulose acylate solution (dope) is cast on a drum or a band, for evaporating the solvent therein to form a film. The concentration of the dope before casting is preferably adjusted to a solid content of 5 to 40% by mass. Preferably, the surface of the drum or the band is finally finished to a mirror state. A method comprising casting the dope on a drum or a band at a surface temperature of 30° C. or less is preferably adopted. The temperature of a metal support in particular is preferably within a range of −10 to 20° C. In accordance with the invention, methods described in the individual official gazettes of JP-A-2000-301555, JP-A-2000-301558, JP-A-Hei 7-032391, JP-A-Hei 03-193316, JP-A-Hei 05-086212, JP-A-Sho 62-037113, JP-A-Hei 02-276607, JP-A-Sho 55-014201, JP-A-Hei 02-111511, and JP-A-Hei 02-208650 may be used.

### [Overlay Casting]

The cellulose acylate solution may be cast in a monolayer solution on a smooth band or drum as a metal support, or two layers or more of plural cellulose acylate solutions may be cast thereon. In case of casting plural cellulose acylate solutions, solutions containing cellulose acylate are individually cast thereon from plural cast ports arranged at an interval in the direction for the metal support to move, to prepare a film in the course of lamination. Methods described for example in the individual official gazettes of JP-A-Sho 61-158414, JP-A-Hei 1-122419 and JP-A-Hei 11-198285 are applicable. By casting cellulose acylate solutions from two cast ports, additionally, a film can be prepared by methods described in for example the individual official gazettes of JP-B-Sho 60-27562, JP-A-Sho 61-94724, JP-A-Sho 61-947245, JP-A-Sho 61-104813, JP-A-Sho 61-158413, and JP-A-Hei 6-134933. Furthermore, a cellulose acylate cast method described in the official gazette of JP-A-Sho 56-162617 may be satisfactory, which comprises enveloping the flow of a cellulose acylate solution at a high viscosity with a cellulose acylate solution at a low viscosity, and simultaneously extruding these cellulose acylate solutions at the high and low viscosities. Preferable embodiments are additionally described in the individual official gazettes of JP-A-Sho 61-94724 and JP-A-Sho 61-94725, where an outer solution contains alcohol components as poor solvents at a higher level than an inner solution does. Otherwise, a film in plural layers can be prepared using two cast ports, for example by a method described in the official gazette of JP-B-Sho 44-20235, comprising peeling off a film formed from a first cast port on a meal support, and subsequently progressing second casting on the side of the resulting film in contact to the metal support face. The cellulose acylate solutions for casting may be the same solution or different cellulose acylate solutions, with no specific limitation. So as to allow such plural cellulose acylate layers to have functions, a cellulose acylate solution with one of the functions may satisfactorily be extruded from the individual cast ports. Further, such cellulose acylate solutions may be cast together with other functional layers (for example, an adhesive layer, a dye layer, an antistatic layer, an anti-halation layer, a UV absorption layer, and a polarizing layer).

So as to prepare a required film thickness, a high concentration of a cellulose acylate solution at a high viscosity should be extruded when the cellulose acylate solution is only one solution as in the related art. In that case, the stability of the cellulose acylate solution is likely deteriorated frequently, leading to the occurrence of solids to cause disadvantageously boot disorders or a poor plane level. A method for overcoming the disadvantages comprises casting relatively small amounts of plural cellulose acylate solutions from plural cast ports to extrude simultaneously the solutions at high viscosities onto a metal support, so that the plane level can be improved not only to prepare a film in a plane form but also to attain the reduction of the load during drying due to the use of thick cellulose acylate solutions, leading to the elevation of the film through-put.

In case of co-casting, the outer-layer thickness and the inner-layer thickness are with no specific limitation. Nonetheless, the outer-layer thickness is preferably 1 to 50%, more preferably 2 to 30% of the total film thickness. In case of co-casting three layers or more, the thickness of a layer in contact to a metal support and the thickness of a layer in contact to air in total are defined outer-layer thickness. In case of co-casting, cellulose acylate solutions with different concentrations of additives such as the plasticizer, the UV absorbent and the mat agent may be cast concurrently, for preparing a cellulose acylate film in a multilayer structure. For example, a cellulose acylate film in a composition of skin layer/core layer/skin layer may be prepared. For example, the mat agent is contained more in a skin layer or is contained in a skin layer alone. The plasticizer and the UV absorbent may be contained in a skin layer than in a core layer, or may be contained in the core layer alone. Additionally, different types of the plasticizer and the UV absorbent may be contained in a core layer and a skin layer. For example, at least one of a poorly vaporizable plasticizer or a UV absorbent is contained in a skin layer, while a plasticizer with great plasticizing ability or a UV absorbent with a high UV absorbing potency may be added to a core layer. Furthermore, it is a preferable embodiment where a peel-off-promoting agent is contained in the skin layer alone on the side of the metal support. So as to permit the gelation of a solution by cooling a metal support by a cold drum method, furthermore, alcohol as a poor solvent is added at a high level preferably in the skin layer than in the core layer. The Tg of the skin layer may satisfactorily differ from the Tg of the core layer. Preferably, the Tg of the core layer is lower than the Tg of the skin layer. Still further, the viscosity of a solution containing cellulose acylate may differ between the skin layer and the core layer. Preferably, the viscosity of the skin layer is lower than the viscosity of the core layer. Nonetheless, the viscosity of the core layer may satisfactorily be lower than the viscosity of the skin layer.

### [Casting Method]

Solution cast methods include for example a method comprising uniformly extruding a prepared dope from pressure die onto a metal support; a method with a doctor blade, comprising adjusting the film thickness of a dope cast on a metal support with the blade; and a method with a reverse roll coater comprising adjusting the film thickness with a roll rotating in an inverse direction. The method with a pressure die is preferable. The pressure die includes for example dies of coat hanger type and T die type. Any of such dies may preferably be used. Other than the methods described above, various filming methods by casting a cellulose triacetate solution as known in the related art may also be used as such methods. Taking account of the difference in for example the boiling point of a solvent for use, individual conditions are preset to obtain the same effects as described in the contents of the individual official gazettes.

As the metal support running in an endless manner for use in producing the cellulose acylate film preferable in accordance with the invention, a drum with mirror-finished surface with chromium plating or a stainless steel belt (may be called band) with mirror-finished surface prepared by surface polishing is used. The pressure die for use may be one unit or two units or more arranged above the metal support. Preferably, the pressure die is one unit or two units. In case of arranging two units or more, the amount of the dope to be cast may satisfactorily be divided at a different ratio in the individual dies. At the individual ratios, the dope is transferred from plural high-precision quantitative gear pumps to the dies. The temperature of the cellulose acylate solution for use in casting is preferably −10 to 55° C., more preferably 25 to 50° C. In that case, the solutions at all steps may be at the same temperature or the solutions may be at different temperatures at individual steps. In case of the solutions at different temperatures, each of the solutions should be at a desired temperature just before casting.

### [Drying]

In producing a cellulose acylate film, the dope is dried on a metal support, generally by a method comprising applying hot air from the side of the surface of the metal support (drum or belt), namely the surface of the web on the metal support, and a back face liquid heat transfer method comprising putting a temperature-controlled liquid in contact with a drum or a belt from the back face of the belt or the drum, which is the opposite side against the dope casting side, to heat the drum or the belt via heat transfer to control the surface temperature. The back face liquid heat transfer method is preferable. The surface temperature of the meal support before casting may be any temperature below the boiling points of solvents used in the doping. So as to accelerate drying or to lose the fluidity on the metal support, however, the temperature is preferably preset to a temperature lower by 1 to 10° C. than the lowest boiling point among the boiling points of solvents used. Herein, the presetting of the temperature is not essentially required when the cast dope is cooled and peeled off without drying.

So as to suppress optical slip when the polarizing plate is observed in a slanting direction, the transmission axis of a polarizer is required to be arranged in parallel to the slow axis of the in-plane cellulose acylate film. Since the transmission axis of a continuously produced polarizer in a roll-film shape is generally parallel to the width direction of the roll film, the in-plane slow axis of the protective film in a roll-film shape is essentially parallel to the film width direction, so as to continuously attach a protective film comprising a cellulose acylate film in a roll-film shape onto the polarizer in the roll-film shape. Thus, the film is preferably stretched more in the width direction. Additionally, the stretch process may be done intermediately in the filming process or may be done using a rolled film. In the former case, the film may be stretched at a state of the film containing the residual solvent, preferably at an amount of the residual solvent corresponding to 2 to 30% by mass.

The cellulose acylate film obtained after drying, which is preferable for use in accordance with the invention, is at a film thickness varying in a manner dependent on the object of the use thereof. Generally, the film thickness is within a range of preferably 5 to 500 μm, more preferably 20 to 300 μm, particularly preferably 30 to 150 μm. Additionally, the film thickness is preferably 40 to 110 μm for use in optical applications, particularly VA liquid crystal display devices. The film thickness can be adjusted to a desired thickness by adjusting for example the concentration of solids contained in the dope, the slit gap of an orifice of a die, the extrusion pressure from a die and the velocity of a metal support.

The width of the cellulose acylate film obtained in the manner described above is preferably 0.5 to 3 m, more preferably 0.6 to 2.5 m, still more preferably 0.8 to 2.2 m. As to the length of the film, the film is rolled to a length of 100 to 10000 m, more preferably 500 to 7000 m, still more preferably 1000 to 6000 m per one roll. In rolling the film, preferably, knurling is provided at least at one of the ends. The width of the knurling is preferably 3 mm to 50 mm, more preferably 5 mm to 30 mm, while the height thereof is preferably 0.5 to 500 μm, more preferably I to 200 μm. This may be embossed on a single one side or both the sides.

### [Melt Filming]

The method for producing an optical film in accordance with the invention may comprise melt filming. The raw material polymer and raw materials such as additives are first melted under heating, for filming via extrusion injection molding or may be inserted in between two heated plates, for pressing and filming.

The temperature for melting under heating is any temperature for the raw material polymers to melt uniformly, with no specific limitation. Specifically, the raw material is heated to a temperature of the melting point or more or the softening point or more. So as to obtain a uniform film, the raw material is heated to a temperature higher than the melting point of the raw material polymer, preferably higher by 5 to 40° C. than the melting point, particularly preferably higher by 8 to 30° C. than the melting point.

### [Alignment Film]

An optically compensatory film may contain an alignment film between the optical film of the invention (preferably, cellulose acylate film) and an optically anisotropic layer. Additionally, an alignment film is only used in preparing an optically anisotropic layer, to prepare an optically anisotropic layer on the alignment film. Subsequently, only the optically anisotropic layer is transferred onto the cellulose acylate film.

In accordance with the invention, the alignment film preferably comprises a layer comprising a crosslinked polymer. As the polymer for use in the alignment film, a polymer crosslinkable per se or a polymer crosslinkable with a crosslinking agent may be used. The alignment film can be prepared by reacting together a polymer with a functional group or a polymer introduced with a functional group therein, via light, heat or pH change. By using a crosslinking agent as a highly reactive compound to introduce a binding group derived from the crosslinking agent in between polymers, otherwise, the polymers can be crosslinked together, to prepare the alignment film.

The alignment film comprising the crosslinked polymer can be formed for example by coating a coating solution comprising the polymer or a mixture of the polymer and a crosslinking agent on a support and subsequently heating the support. So as to suppress dusting from the alignment film at the rubbing process described below, the crosslinking degree is preferably raised. Provided that the crosslinking degree is defined as a value [1−(Ma/Mb)] obtained by determining the ratio (Ma/Mb) of the amount of a crosslinking agent remaining even after crosslinking (Ma) to the amount of the crosslinking agent added to the coating solution (Mb) and subtracting the ratio from 1, the crosslinking degree is preferably 50% to 100%, more preferably 65% to 100%, most preferably 75% to 100%.

In accordance with the invention, the polymer for use in the alignment film may be a crosslinkable polymer per se or a polymer crosslinkable with a crosslinking agent. It is needless to say that a polymer with both the functions may be used, satisfactorily. Examples of the polymer include polymers such as polymethyl methacrylate, acrylic acid/methacrylic acid copolymer, styrene/maleimide copolymer, polyvinyl alcohol and modified polyvinyl alcohol, poly(N-methylol acrylamide), styrene/vinyl toluene copolymer, chlorosulfonated polyethylene, nitrocellulose, polyvinyl chloride, chlorinated polyolefin, polyester, polyimide, vinyl acetate/vinyl chloride copolymer, ethylene/vinyl acetate copolymer, carboxymethyl cellulose, gelatin, polyethylene, polypropylene and polycarbonate, as well as compounds such as silane coupling agents. Preferable such polymer includes for example water-soluble polymers such as poly(N-methylol acrylamide), carboxymethyl cellulose, gelatin, polyvinyl alcohol and modified polyvinyl alcohol, more preferably gelatin, polyvinyl alcohol and modified polyvinyl alcohol, particularly preferably polyvinyl alcohol and modified polyvinyl alcohol.

For directly coating polyvinyl alcohol and modified polyvinyl alcohol on the cellulose acylate film of the invention, a hydrophilic undercoating layer is arranged or a saponification process is preferably used.

Among the polymers, polyvinyl alcohol or modified polyvinyl alcohol is preferable.

The polyvinyl alcohol is at a saponification level within a range of for example 70 to 100%, generally preferably 80 to 100%, more preferably 82 to 98%. The polymerization degree is within a range of preferably 100 to 3000.

The modified polyvinyl alcohol includes for example modified products of polyvinyl alcohol, such as those modified by copolymerization (modifying groups for example COONa, Si(OX)₃, N(CH₃)₃*Cl, C₉H₁₉COO, SO₃Na, and C₁₂H₂₅ have been introduced therein); those modified through chain transfer (modifying groups including for example COONa, SH and SC₁₂H₂₅ have been introduced therein); and those modified by block polymerization (modifying groups for example COOH, CONH₂, COOR, and C₆H₅ have been introduced therein). The polymerization degree is preferably within a range of 100 to 3000. Among them, unmodified or modified polyvinyl alcohol with a saponification degree of preferably 80 to 100%, more preferably 85 to 95% is satisfactory.

So as to provide adhesiveness between the cellulose acylate film and an optically anisotropic layer, a crosslinking group or polymerization-reactive group is preferably introduced in the polyvinyl alcohol. Preferable examples thereof are described in detail in the official gazette of JP-A-Hei 8-338913.

In case of using a hydrophilic polymer such as polyvinyl alcohol in the alignment film, the moisture ratio is preferably controlled in view of film hardness level. The moisture ratio is preferably 0.4% to 2.5%, more preferably 0.6% to 1.6%. The moisture ratio can be measured with a moisture meter commercially available according to the Karl Fisher's method.

The alignment film is preferably of a film thickness of 10 microns or less.

### [Polarizing Plate]

In accordance with the invention, a polarizing plate is provided, which comprises a polarizing film and a pair of protective films holding the polarizing film in between the protective films, where at least one of the protective films is the optical film (preferably, cellulose acylate film). A polarizing plate can be used, as prepared for example by dying a polarizing film comprising polyvinyl alcohol film with iodine, followed by stretching, and laminating the protective films on both the faces thereof. The polarizing plate is arranged outside the liquid crystal cell. A pair of polarizing plates each comprising a polarizing film and a pair of protective films holding the polarizing film in between the protective films are arranged in such a manner that the polarizing plates hold a liquid crystal cell in between them. Further, the protective film arranged on the side of the liquid crystal cell is preferably the optical film of the invention (preferably, cellulose acylate film) or an optically compensatory film.

### <Adhesive>

The adhesive for the polarizing film and the protective films includes for example but is not specifically limited to polyvinyl alcohol (PVA)-series resins (including PVA modified with for example acetoacetyl group, sulfonic group, carboxyl group, and oxyalkylene group) and aqueous solutions of boron compounds. Among them, PVA-series resins are preferable. After drying, the thickness of an adhesive layer is preferably 0.01 to 10 microns, particularly preferably 0.05 to 5 microns.

### <Consistent Process of Producing Polarizing Film and Protective Film>

The polarizing plate for use in accordance with the invention may be produced by a process comprising a drying step of stretching a film for a polarizing film, subsequently shrinking the film to reduce the ratio of an evaporating fraction, preferably additionally comprising a post-heating step of attaching the protective film on at least one of the faces after or during drying and subsequently heating the protective film. A specific process of attaching the protective film comprises attaching the protective film on the polarizing film using an adhesive during the film drying step at a state of both the ends held, and subsequently cutting both the ends. Otherwise, the film for use as a polarizing film is removed from the part to hold both the ends, after drying, from which both the ends are cut out. Then, a protective film is attached on the resulting film. As a method for cutting off ends, general techniques including a cutting method with a cutter such as blade and a laser method can be used. So as to dry the adhesive after the attachment and to improve the polarizing performance, heating is preferably done. Depending on the adhesive, a heating condition varies. In case of aqueous adhesive-series, heating is done at preferably 30° C. or more, more preferably 40° C. to 100° C., still more preferably 50° C. to 90° C. These steps are done in a consistent line, preferably in terms of performance and production efficiency.

### <Performance of Polarizing Plate>

The polarizing plate of the invention has optical properties and durability (storability for a short term and a long term) at the same levels as or at higher levels than those of commercially available super-high contrast products (for example, HLC2-5618 manufactured by SANRITZ Co., Ltd.). Specifically, the polarizing plate has the following properties. The transmission rate of visible ray is 42.5% or more; the polarization degree of [(Tp−Tc)/(Tp+Tc)]×½≧0.9995 (provided that Tp represents parallel transmission ratio; Tc represents orthogonal transmission ratio); the differential change of the transmission ratio before and after the polarizing plate is left to stand alone in atmosphere at 60° C. and a humidity of 90% RH for 500 hours and then in dry atmosphere at 80° C. for 500 hours is 3% or less, preferably 1% or less on the basis of the absolute value. The differential change of the polarization degree is 1% or less, preferably 0.1% or less on the basis of the absolute value.

### [Surface Treatment of Cellulose Acylate Film]

The cellulose acylate film preferable for use in accordance with the invention is sometimes treated of the surface, to achieve the improvement of the adhesion between the cellulose acylate film and the individual functional layers (for example, undercoat layer and back layer). The surface treatment is done by using for example glow discharge treatment, ultraviolet irradiation treatment, corona treatment, flame treatment and treatment with acids or alkalis. Herein, the term “glow discharge treatment” includes treatment with low-temperature plasma emerging in low-pressure gas at 10⁻³ to 20 Torr, and additionally includes plasma treatment at atmospheric pressure. The plasma-excitable gas means a gas excitable with plasma under such conditions as described above and includes for example argon, helium, neon, krypton, xenon, nitrogen, carbon dioxide, freons such as tetrafluoromethane and mixtures thereof. These are described in detail in the Japan Institute of Invention and Innovation (JIII), Journal of Technical Disclosure (Kokai Gihou), Technical No. 2001-1745 (issued on Mar. 15, 2001), page 30 to page 32. Plasma treatment at atmospheric pressure has increasingly drawn attention in recent years. For the plasma treatment, irradiation energy of 20 to 500 kGy at for example 10 to 1000 keV is used. More preferably, irradiation energy of 20 to 300 kGy at for example 30 to 500 keV is used. Among them, an alkali saponification treatment is particularly preferable and is very effective as a surface treatment of the cellulose acylate film.

### [Alkali Saponification Treatment]

The alkali saponification treatment is preferably done by a process of directly immersing the cellulose acylate film in a tank containing a saponification solution or by a process of coating a saponification solution onto the cellulose acylate film. The coating method includes for example dip coating method, curtain coating method, extrusion coating method, bar coating method and E-type coating method. As the solvent in the coating solution for the alkali saponification treatment, preferably, a solvent with great wettability and with an ability to keep the surface state at a fine state without any occurrence of protrusions or recesses on the surface of the cellulose acylate film with the solvent in the saponification solution, so as to coat the saponification solution on the cellulose acylate film. Specifically, alcohol-series solvents are preferable. Isopropyl alcohol is particularly preferable. Additionally, an aqueous solution of a surfactant may be used as such solvent. The alkali in the coating solution for alkali saponification is preferably an alkali dissolvable in the solvent. KOH and NaOH are more preferable. The coating solution for saponification is at preferably pH 10 or more, more preferably pH 12 or more. The reaction conditions for alkali saponification are ambient temperature for a period of preferably one second or more to 5 minutes or less, more preferably 5 seconds or more to 5 minutes or less, particularly preferably 20 seconds or more to 3 minutes or less. After the reaction for alkali saponification, the surface coated with the saponification solution is washed in water, or washed in an acid and then rinsed in water.

Additionally, an optically anisotropic layer is preferably arranged on the protective film on the polarizing plate for use in accordance with the invention.

An optically anisotropic layer comprises a liquid crystal compound, a non-liquid crystal compound, an inorganic compound, and an organic/inorganic complex compound, with no specific limitation to the materials therefor. As the liquid crystal compound, there may be used a product prepared by aligning a low-molecular compound with a polymerizable group and subsequently fixing the aligned state via polymerization with light or heat, and a product prepared by aligning a liquid crystal polymer via heating, subsequently cooling the resulting product, and then fixing the aligned state at a glass state. As the liquid crystal compound, liquid crystal compounds in discotic structures, bar-like structures and structures with optical biaxiality may be used. As the non-liquid crystal compound, there may be used polymers with aromatic rings, such as polyimide and polyester.

The optically anisotropic layer may be formed by using various methods such as coating, deposition and sputtering.

In case that an optically anisotropic layer is to be arranged on the protective film on the polarizing plate, the adhesive layer is arranged outside the optically anisotropic layer outside the polarizer.

Preferably, the polarizing plate in accordance with the invention additionally comprises at least one layer of a hard-coat layer, a glare-shielding layer, or a reflection-preventing layer on the surface of a protective film on at least one of the sides of the polarizing plate. During the use of the polarizing plate in a liquid crystal display device, a functional film such as reflection-preventing film is preferably arranged on a protective film arranged on the opposite side of the liquid crystal cell. As such functional film, preferably, at least one layer of a hard-coat layer, a glare-shielding layer or a reflection-preventing layer is arranged. Further, the individual layers are not necessarily arranged as individually separated layers. By allowing a reflection-preventing layer and a hard coat layer to have a glare shielding function, instead of arranging two layers of a reflection-preventing layer and a glare-shielding layer, the resulting layer can function as a glare-shielding, reflection-preventing layer.

### [Reflection-Preventing Layer]

On the protective film of the polarizing plate in accordance with the invention, a reflection-preventing layer comprising at least a light scattering layer and a layer with a low refractive index laminated in this order or a reflection-preventing layer comprising a layer with a medium refractive index, a layer with a high refractive index, and a layer with a low refractive index laminated in this order is preferably arranged. Preferable examples thereof are described below. In the former composition, generally, the degree of reflection on the mirror surface is 1% or more. Thus, the film is called low reflection (LR) film. In the latter composition, the degree of reflection on the mirror surface below 0.5% can be achieved. The film is called anti-reflection (AR) film.

### [LR Film]

Preferable examples of the reflection-preventing layer with a light scattering layer and a layer with a low refractive index as arranged on the protective film on the polarizing plate (LR film) are now described below.

In the light scattering layer, preferably, a mat particle is dispersed. Materials other than the mat particle in the light scattering layer are at a refractive index within a range of preferably 1.50 to 2.00. The refractive index of the layer with a low refractive index is within a range of preferably 1.20 to 1.49. In accordance with the invention, the light scattering layer has a combination of the glare-shielding property and the hard-coat property. The light scattering layer may be a monolayer or comprises plural layers, for example two to four layers.

The reflection-preventing layer is arranged in such a manner that the mean roughness Ra along the center line is 0.08 to 0.40 μm; the mean roughness Rz at 10 points is 10-fold Ra or less; the mean distance Sm between protrusions and recesses is 1 to 100 μm; the standard deviation of the heights of protrusions from the largest depth in the protrusions or the recesses is 0.5 μm or less; the standard deviation of the mean distance between protrusions and recesses Sm is 20 μm or less; the surface at an inclined angle of 0 to 5° occupies 10% or more. Thus, sufficient glare-shielding properties and uniform mat property under visual observation can be attained, preferably.

When the color of reflected light in a light source “C” is at an a* value of −2 to 2 and a b* value of −3 to 3 and the degree of reflection within a range of 380 nm to 780 nm is at a ratio of 0.5 to 0.99 as the ratio of the minimum value to the maximum value, the color of the reflected light is preferably neutral. By adjusting the b* value of the transmitted light in the “C” light source to 0 to 3, the yellowish tint in white display when applied to a display apparatus is reduced, preferably. Additionally when a lattice of 120 μm×40 μm is inserted in between the surface light source and the reflection-preventing layer and the standard deviation of the brightness distribution is 20 or less when the brightness distribution is measured on the film, glare can be reduced preferably when the polarizing plate of the invention is applied to a high-precision panel.

The optical properties of the reflection-preventing layer for use in accordance with the invention are adjusted to a reflection ratio on mirror surface being 2.5% or less, a transmission ratio of 90% or more, and a 60° gloss degree of 70% or less, so that the layer can suppress the reflection of extraneous light, preferably, to improve the visibility. Particularly, the reflection ratio on mirror surface is more preferably 1% or less, most preferably 0.5% or less. By adjusting the layer to a 20%-50% haze, a 0.3-1 ratio as the inner haze/total haze ratio, a decrease of the haze value after forming a layer with a low refractive index from the haze value up to the light scattering layer within 15%, a 20%-50% sharpness of transmission image at a comb width of 0.5 mm, a 1.5 to 5.0 transmission ratio as the ratio of vertically transmitting light/transmitting light in a direction slanting at 2° toward the vertical direction, preferably, glare can be prevented on the high-precision LCD panel while blurring of characters and the like can be reduced.

### (Layer With a Low Refractive Index)

The refractive index of a layer with a low refractive index for use in accordance with the invention is within a range of preferably 1.20 to 1.49, more preferably 1.30 to 1.44. Further, the layer with a low refractive index preferably satisfies the following formula (19) in terms of preparing a film with a small reflection ratio.

(m/4)λ×0.7<n_{L}d_{L}<(m/⁴)λ×1.3 Formula (19):

In the formula, “m” is a positive odd number; “n_{L}” represents the refractive index of a layer with a low refractive index; and “d_{L}” represents the film thickness (nm) of the layer with a low refractive index. Additionally, “λ” represents a wavelength within a range of 500 to 550 nm.

The material for forming a layer with a low refractive index is now described below.

The layer with a low refractive index preferably contains a fluorine-containing polymer as a binder with a low refractive index.

The fluorine-containing polymer is preferably a fluorine polymer with a dynamic friction coefficient of 0.03 to 0.20, a contact angle to water being 90 to 120°, and a slip-off angle of pure water being 70° or less, which is crosslinkable with heat or ionizing radiation. When the polarizing plate of the invention is arranged in an imaging apparatus, a lower peel-off strength of the polarizing plate with a commercially available adhesive tape is preferable because seals or memo pads affixed thereon are then readily peeled off. When the peel-off strength is measured with a tensile tester, the peel-off strength is preferably 500 gf or less, more preferably 300 gf or less, most preferably 100 gf or less. At a higher surface hardness as measured with a hardness micrometer, additionally, damages more scarcely occur. The surface hardness is preferably 0.3 GPa or more, more preferably 0.5 GPa or more.

The fluorine-containing polymer for use in the layer with a low refractive index includes for example hydrolyzed products and dehydrated condensates of perfluoroalkyl group-containing silane compounds [for example, (heptadecafluoro-1,1,2,2-tetrahydrodecyl)triethoxysilane] and additionally includes for example fluorine-containing polymers comprising a fluorine-containing monomer unit and a structural unit for giving a crosslinking reactivity as structural components.

The fluorine-containing monomer specifically includes for example fluoroolefins (for example, fluoroethylene, vinylidene fluoride, tetrafluoroethylene, perfluorooctyl ethylene, hexafluoropropylene, perfluoro-2,2-dimethyl-1,3-dioxonol), partially or completely fluorinated alkyl ester derivatives of (meth)acrylic acid [for example, “Viscoat 6FM”, manufactured by Osaka Organic Chemical Industry, Ltd. and “M-2020” manufactured by Daikin Industry, Ltd.], and completely or partially fluorinated vinyl ethers. Preferably, the fluorine-containing monomer includes perfluoroolefins. From the standpoints of refractive index, solubility, transparency, availability, etc., hexafluoropropylene is particularly preferable.

The structural unit for giving a crosslinking reactivity includes for example a structural unit obtained by polymerizing a monomer originally having a self-crosslinkable functional group within the molecule, such as glycidyl (meth)acrylate, and glycidyl vinyl ether; a structural unit obtained by polymerizing a monomer with carboxyl group, hydroxyl group, amino group or sulfo group [for example, (meth)acrylic acid, methylol(meth)acrylate, hydroxyalkyl(meth)acrylate, allyl acrylate, hydroxyethyl vinyl ether, hydroxybutyl vinyl ether, maleic acid, crotonic acid, etc.); and structural units obtained by introducing a crosslinking group such as (meth)acryloyl group via a polymer reaction into these structural units (for example by a process comprising reacting acrylyl chloride with hydroxyl group).

Other than the fluorine-containing monomer unit and the structural unit for giving a crosslinking reactivity, a monomer without any fluorine atom may be copolymerized from the respect of the solvent solubility and the film transparency. The monomer concurrently usable includes for example but is not limited to olefins (for example, ethylene, propylene, isoprene, vinyl chloride, and vinylidene chloride), acrylate esters (for example, methyl acrylate, ethyl acrylate, and acrylate 2-ethylhexyl ester), methacrylate esters (for example, methyl methacrylate, ethyl methacrylate, butyl methacrylate, and ethylene glycol dimethacrylate), styrene derivatives (for example, styrene, divinyl benzene, vinyl toluene, and α-methyl styrene), vinyl ethers (for example, methyl vinyl ether, ethyl vinyl ether, and cyclohexyl vinyl ether), vinyl esters (for example, vinyl acetate, vinyl propionate, and vinyl cinnamate), acrylamides (for example, N-t-butyl acrylamide, and N-cyclohexyl acrylamide), methacrylamides, and acrylonitrile derivatives.

As described in the individual official gazettes of JP-A-Hei 10-25388 and JP-A-Hei 10-147739, satisfactorily, setting agents may appropriately be added to the polymer.

### (Light Scattering Layer)

A light scattering layer is formed for the purpose of giving a film a light scattering property via at least one of surface scattering and inner scattering along with a hard-coat property for improving the wear resistance of the film. Thus, the light scattering layer contains a binder for giving the hard-coat property, a mat particle for giving light dispersibility, and an inorganic filler if necessary for preparing a film with a high refractive index, for preventing the crosslinking and shrinkage of the film and for preparing a film with a high intensity. By arranging such light scattering layer, further, the light scattering layer also functions as a glare-shielding layer. Consequently, a glare-shielding layer is preliminarily contained in the resulting polarizing plate.

For the purpose of giving the hard-coat property, the film thickness of the light scattering layer is preferably 1 to 10 μm, more preferably 1.2 to 6 μm. When the film thickness of the light scattering layer is at the lower limit or exceeds the limit, problems such as insufficient hard property rarely occur. The film thickness thereof at the upper limit or below the upper limit preferably rarely involves inconveniences such as insufficient processing suitability due to the deterioration of curl or brashness.

The binder in the light scattering layer is preferably a polymer with a saturated hydrocarbon chain or a polyether chain as the main chain, more preferably a polymer with a saturated hydrocarbon chain as the main chain. Additionally, such binder polymer preferably is in a crosslinked structure. The binder polymer with a saturated hydrocarbon chain as the main chain is preferably a polymer of an ethylenic unsaturated monomer. A binder polymer with a saturated hydrocarbon chain as the main chain and with a crosslinked structure is preferably a copolymer of a monomer with two or more ethylenic unsaturated groups. So as to give a high refractive index to a binder polymer, there may also be selected a polymer containing an aromatic ring and at least one atom selected from halogen atoms except fluorine, sulfur atom, phosphorus atom and nitrogen atom in the monomer structure.

The monomer with two or more ethylenic unsaturated groups include for example esters of polyhydric alcohols and (meth)acrylic acid [for example, ethylene glycol di(meth)acrylate, butanediol di(meth)acrylate, hexanediol di(meth)acylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, and polyester polyacrylate], ethylene oxide-modified products of those described above, vinyl benzene and its derivatives (for example, 1,4-divinyl benzene, 4-vinyl benzoate-2-acryloylethyl ester, and 1,4-divinylcyclohexanone), vinyl sulfone (for example, divinyl sulfone), acrylamide (for example, methylene bisacrylamide) and methacrylamide. These monomers may also be used in combination of two or more thereof.

The monomer with a high refractive index specifically includes for example bis(4-methacryloylthiophenyl)sulfide, vinyl naphthalene, vinyl phenyl sulfide, 4-methacryloxyphenyl-4′-methoxyphenyl thio ether. These monomers may also be used in combination of two or more thereof.

These monomers with ethylenic unsaturated groups can be polymerized in the presence of a photo-radical initiator or a thermo-radical initiator through the irradiation of ionizing radiation or through heating. Thus, a reflection-preventing layer can be formed by preparing a coating solution containing a monomer with an ethylenic unsaturated group, a photo-radical initiator or a thermoradical initiator, a mat particle and an inorganic filler, coating then the coating solution on the protective film, and subsequently setting the layer by a polymerization reaction with ionizing radiation or heat. As such photo-radical initiator and the like, known photo-radical initiators and others may be used.

A polymer containing polyether as the main chain is preferably a ring-opened polymer of a polyfunctional epoxy compound. The ring opening and polymerization of a polyfunctional epoxy compound is done in the presence of an optical acid generator or a thermal acid generator under irradiation of ionizing radiation or under heating. Thus, a reflection-preventing layer can be formed by preparing a coating solution containing a polyfunctional epoxy compound, an optical acid generator or a thermal acid generator, a mat particle and an inorganic filler, coating then the coating solution on the protective film, and subsequently setting the layer by a polymerization reaction with ionizing radiation or heat.

In place of or in addition to a monomer with two or more ethylenic unsaturated groups, a monomer with a crosslinking functional group is used to introduce the crosslinking group into a polymer. Then, a crosslinked structure may be introduced into a binder polymer through the reaction of the crosslinking functional group.

The crosslinking functional group includes for example isocyanate group, epoxy group, aziridine group, oxazoline group, aldehyde group, carbonyl group, hydrazine group, carboxyl group, methylol group and active methylene group. Vinyl sulfonic acid, acid anhydrides, cyanoacrylate derivatives, melamine, etherified methylol, ester and urethane, and tetramethoxysilane and metal alkoxide may also be used as the monomer for introducing a crosslinking structure. A functional group exerting a crosslinking potential as a consequence of decomposition reaction, like block isocyanate group, may also be used satisfactorily. In other words, the crosslinking functional group in accordance with the invention may exert the reactivity as a consequence of the decomposition even when the crosslinking functional group never exerts any reactivity as it is.

A binder polymer with such crosslinking functional group is coated and heated, to form a crosslinked structure.

For the purpose of giving a glare-shielding property to the light scattering layer, a mat particle for example an inorganic compound in particles or a resin particle is contained in the light scattering layer, where the mean particle size is 1 to 10 μm, preferably 1.5 to 7.0 μm, larger than the filler particle size. The mat particle specifically includes for example particles of inorganic compounds, such as silica particle and TiO₂ particle; and resin particles such as acryl particle, crosslinked acryl particle, polystyrene particle, crosslinked styrene particle, melamine resin particle, and benzoguanamine resin particle, which are preferable for use. Among them, crosslinked styrene particle, crosslinked acryl particle, crosslinked acrylstyrene particle and silica particle are preferable. Any shape of the mat particle, including sphere and amorphous shape may be used.

Additionally, mat particles of two types or more with different particle sizes may be used in combination. A mat particle with a larger particle size can provide a glare-shielding property, while a mat particle with a smaller particle size can provide another optical property.

As to the particle size distribution of the mat particle, the mat particle may most preferably be a monodispersion. The particle sizes of the individual particles may be closer to each other, more preferably. Provided that a particle of a particle size larger by 20% or more than the mean particle size is defined large particle, the ratio of the large particle is preferably 1% or less, more preferably 0.1% or less, still more preferably 0.01% or less of the number of total particles. After general synthetic reaction and subsequent sieving, the mat particle with such particle size distribution can be obtained through sieving. By raising the number of sieving and the level thereof, a mat agent of a more preferable distribution can be obtained.

The mat particle is contained in the light scattering layer at such a content that the amount of the mat particle in the formed light scattering layer is at preferably 10 to 1000 mg/m², more preferably 100 to 700 mg/m².

The particle size distribution of the mat particle is measured by the Coulter Counter method and is then corrected on a particle number distribution basis.

So as to raise the refractive index of the light scattering layer, the layer preferably contains an inorganic filler comprising an oxide of at least one metal selected from titanium, zirconium, aluminium, indium, zinc, tin and antimony, where the mean particle size is 0.2 μm or less, preferably 0.1 μm or less, more preferably 0.06 μm or less, in addition to the mat particle.

So as to elevate the difference in refractive index from a mat particle when the mat particle used in the light scattering layer is of a high refractive index, alternatively, a silicone oxide is preferably used so as to retain the refractive index of the light scattering layer at a low level. The particle size is preferably the same as described above about the inorganic filler.

Specific examples of the inorganic filler for use in the light scattering layer include TiO₂, ZrO₂, Al₂O₃, In₂O₃, ZnO, SnO₂, Sb₂O₃, ITO and SiO₂. TiO₂ and ZrO₂ are particularly preferable owing to the preparation of high refractive index. The surface of the inorganic filler is preferably treated with a silane coupling process or a titanium coupling process. For the process, a surface treating agent with a functional group capable of reacting with a binder species is preferably used on the filler surface.

Such inorganic filler is added at an amount of preferably 10 to 90%, more preferably 20 to 80%, particularly preferably 30 to 75% of the total mass of the light scattering layer.

Further, such filler never causes scattering because of the sufficiently smaller particle size than light wavelength. A preparation of the filler dispersed in a binder polymer functions as an optically uniform substance.

The bulk refractive index of the mixture of a binder and an inorganic filler in the light scattering layer is preferably 1.50 to 2.00, more preferably 1.51 to 1.80. So as to adjust the refractive index to the range, the types of the binder and the inorganic filler and the ratio in amount thereof are appropriately selected. The selection of the types and the ratio can readily be determined at preliminary experiments.

So as to securely retain the surface uniformity without particular uneven coating, uneven drying or spot defects in the light scattering layer, a coating composition for forming the light scattering layer contains any surfactant of fluorine series and silicone series or both. Particularly, a fluorine-series surfactant when added at a smaller amount can effectively improve surface disorders such as uneven coating, uneven drying or spot defects in the reflection-preventing layer preferable for use in accordance with the invention. Thus, such surfactant is preferably used. By permitting a high-speed coating property while raising the surface uniformity, the productivity can be raised.

### [AR Film]

Descriptions are now made about a reflection-preventing layer (AR film) in a layer composition of a layer with a medium refractive index, a layer with a high refractive index and a layer with a low refractive index laminated in this order on the protective film.

A reflection-preventing layer (AR film) in a layer composition of at least a layer with a medium refractive index, a layer with a high refractive index and a layer with a low refractive index (the utmost outer layer) in this order on the protective film is designed in such a manner that the refractive indices therein might satisfy the following relationships.

The refractive index of a layer with a high refractive index>the refractive index of a layer with a medium refractive index>the refractive index of the protective film>the refractive index of a layer with a low refractive index.

Additionally, a hard coat layer may also be arranged in between the protective film and the layer with a medium refractive index. Further, the reflection-preventing layer may comprise a hard coat layer with a medium refractive index, a layer with a high refractive index and a layer with a low refractive index. Such reflection-preventing layer includes for example reflection-preventing layers described in the official gazettes of JP-A-Hei 8-122504, JP-A-Hei 8-110401, JP-A-Hei 10-300902, JP-A-2000-243906 and JP-A-2000-111706.

Still further, other functions may be given to the individual layers, for example anti-stain resistance given to a layer with a low refractive index, and an antistatic property given to a layer with a high refractive index (for example, JP-A-Hei 10-206603 and JP-A-2002-243906).

The haze of a reflection-preventing layer is preferably 5% or less, more preferably 3% or less. Additionally, the surface strength of the film is preferably at H or more, more preferably 2H or more, most preferably 3H or more at a pencil hardness test according to JIS K-5400.

### (Layer With High Refractive Index and Layer With Medium Refractive Index)

A layer with a high refractive index in the reflection-preventing layer comprises a set film containing at least an inorganic compound particle with a high refractive index and of a mean particle size of 100 nm or less and a matrix binder.

The inorganic compound particle with a high refractive index includes for example inorganic compounds with a refractive index of 1.65 or more, preferably 1.9 or more, which includes for example oxides of for example Ti, Zn, Sb, Sn, Zr, Ce, Ta, La and In and complex oxides containing these metal atoms.

So as to prepare such microparticle, for example, the particle surface is treated with a surface-treating agent (for example with silane coupling agents, etc. described in JP-A-Hei 11 -295503, JP-A-Hei 11 -153703 and JP-A-2000-9908; anionic compounds or organic metal coupling agents described in JP-A-2001-310432, etc.); or the particle is prepared into a core shell structure where a particle with a high refractive index is used as the core (JP-A-2001-166104, etc.); combined uses of specific dispersants (described in for example JP-A-Hei 11-153703, U.S. Pat. No. 6,210,858, JP-A-2002-277609, etc.) may also be satisfactory.

A material for forming the matrix includes for example thermoplastic resins and setting resin films known in the art.

Preferable such material includes at least one composition selected from compounds containing polyfunctional compounds with two or more of at least any one of radical polymerizable and cation polymerizable groups; compositions containing organic metal compounds with hydrolysable groups, and compositions containing partial condensates thereof. The preferable such material includes for example compounds described in JP-A-2000-47004, JP-A-2001-315242, JP-A-2001-31871, and JP-A-2001-296401.

Additionally, setting films obtained from colloidal metal oxides obtained from hydrolyzed condensates of metal alkoxides and metal alkoxide compositions are also preferable, which are described in for example the official gazette of JP-A-2001-293818.

The refractive index of a layer with a high refractive index is preferably 1.70 to 2.20. The thickness of a layer with a high refractive index is preferably 5 nm to 10 μm, more preferably 10 nm to 1 μm.

The refractive index of a layer with a medium refractive index is adjusted to a value between the refractive index of a layer with a low refractive index and the refractive index of a layer with a high refractive index. The refractive index of a layer with a medium refractive index is preferably 1.50 to 1.70. Additionally, the thickness is preferably 5 nm to 10 μm, more preferably 10 m to 1 μm.

### (Layer With a Low Refractive Index)

The layer with a low refractive index is serially laminated on the layer with a high refractive index. The refractive index of a layer with a low refractive index is preferably 1.20 to 1.55, more preferably 1.30 to 1.50.

The layer with a low refractive index is preferably constructed as the utmost outer layer with wear resistance and stain resistance. As an approach for highly improving the wear resistance, the surface is effectively provided with a lubricating property. For that purpose, an approach for preparing a thin film layer comprising introducing silicone or fluorine as known in the art is applicable.

The fluorine-containing compound is a compound with a crosslinking or polymerizable functional group, which contains fluorine atom within a range of 35 to 80% by mass and includes for example compounds described in the official gazette of JP-A-Hei 9-222503, Column Nos. [0018] to [0026]; the official gazette of JP-A-Hei 11-38202, Column Nos. [0019] to [0030]; the official gazette of JP-A-2001-40284, Column Nos. [0027] to [0028]; and JP-A-2000-284102.

The refractive index of the fluorine-containing compound is preferably 1.35 to 1.50, more preferably 1.36 to 1.47.

The silicone compound is preferably a compound with a polysiloxane structure, containing a setting functional group or a polymerizable functional group in the polymer chain and having a bridged structure in the film. The silicone compound includes for example reactive silicone [for example, “SILAPLANE” manufactured by Chisso Corporation] and polysiloxane containing a silanol group at both the ends (JP-A-Hei 11-258403).

The crosslinking or polymerization reaction of at least any of fluorine-containing polymers and siloxane polymers with a crosslinking or polymerizable group is done by photoirradiation or heating, simultaneously with or after the coating of a coating composition for forming the utmost outerlayer containing for example a polymerization initiator and an enhancer to form a layer with a low refractive index.

Additionally, an organic metal compound such as a silane coupling agent and a silane coupling agent containing a specific hydrocarbon group containing fluorine are set via a condensation reaction in the co-presence of a catalyst, preferably, to prepare a sol/gel set film.

They includes for example polyfluoroalkyl group-containing silane compounds or partially hydrolyzed condensates (compounds described in for example the official gazettes of JP-A-Sho 58-142958, JP-A-Sho 58-147483, JP-A-Sho 58-147484, JP-A-Hei 9-157582, and JP-A-Hei 11-106704), and silyl compounds containing poly(perfluoroalkyl ether) group as a fluorine-containing long chain group (compounds described in the official gazettes of JP-A-2000-117902, JP-A-2001-48590, and JP-A-2002-53804).

Other than the additives described above, the layer with a low refractive index may contain a filler [for example, inorganic compounds with a low refractive index and of a 1-150 nm mean particle size of primary particles such as silicone dioxide (silica) and fluorine-containing particles (magnesium fluoride, calcium fluoride and barium fluoride); and organic microparticles described in the official gazette of JP-A-Hei 11-3820, Column Nos. [0020] to [0038]], silane coupling agents, lubricants, surfactants and the like.

In case that the layer with a low refractive index is placed in the lower layer of the utmost outer layer, the layer with a low refractive index may satisfactorily be formed by gas-phase methods (vacuum deposition method, sputtering method, ion plating method, plasma CVD method and the like). For the standpoint of production at low cost, the coating method is preferable.

The film thickness of the layer with a low refractive index is preferably 30 to 200 nm, more preferably 50 to 150 nm, most preferably 60 to 120 nm.

### (Hard Coat Layer)

SO as to give a physical strength to the protective film with a reflection-preventing layer arranged thereon, a hard coat layer is arranged on the surface of the protective film. Particularly, the hard coat layer is preferably arranged in between the protective film and the layer with a high refractive index. The hard coat layer is preferably formed by a crosslinking reaction of a photosetting compound and/or a thermosetting compound or a polymerization reaction. The setting functional group in the setting compound is preferably a photopolymerizable functional group. Additionally, organic metal compounds containing hydrolysable functional groups and organic alkoxysilyl compounds are also preferable.

These compounds specifically include for example those listed for the layer with a high refractive index.

Specific structural compositions for the hard coat layer are described in the official gazettes of JP-A-2002-144913 and JP-A-2000-9908 and the pamphlet of the International Publication No. 00/46617.

The layer with a high refractive index may also function as the hard coat layer. In that case, microparticles are dispersed finely using the approach described for the layer with a high refractive index to allow the resulting dispersion to be contained in the hard coat layer. In such manner, the aforementioned layer can be formed.

The hard coat layer may contain a particle of a mean particle size of 0.2 to 10 μm to have an additional function as a glare-shielding layer with a glare-shielding function (anti-glare function).

The film thickness of the hard coat layer can be designed appropriately, depending on the use. The film thickness of the hard coat layer is preferably 0.2 to 10 μm, more preferably 0.5 to 7 μm.

The surface strength of the hard coat layer is at preferably H or more, more preferably 2H or more, most preferably 3H or more at a pencil hardness test according to JIS K-5400. Additionally, the wear level of a test piece before and after a taper test according to JIS K-5400 is preferably smaller.

### (Other Layers in Reflection-Preventing Layer)

Furthermore, a front scattering layer, a primer layer, an antistatic layer, an undercoat layer, a protective layer and the like may also be arranged.

### (Antistatic Layer)

So as to arrange an antistatic layer, preferably, a conductivity at a volume resistance ratio of 10⁻⁸ Ωcm³ or less is given. The volume resistance ratio of 10⁻⁸ Ωcm³ can be given using a hygroscopic substance, a water-soluble inorganic salt, a certain type of surfactants, a cation polymer, an anion polymer, and colloidal silica. However, the resulting antistatic layer is highly dependent on temperature and humidity. At low humidity, thus, sufficient conductivity cannot be attained, disadvantageously. Therefore, a metal oxide is preferable as a conductive layer material. Some metal oxides are originally colored. When these metal oxides are used as conductive layer materials, the resulting film is wholly colored, unpreferably. The metal forming colorless metal oxides includes for example Zn, Ti, Sn, Al, In, Si, Mg, Ba, Mo, W or V. Metal oxides containing such metals as described above as the main components may preferably be used.

Specific examples of the metal oxides include for example ZnO, TiO₂, SnO₂, Al₂O₃, In₂O₃,SiO₂, MgO, BaO, MoO₃, WO₃, and V₂O₅, and complex oxides thereof. ZnO, TiO₂ and SnO₂ are particularly preferable. Examples thereof additionally containing different atoms include ZnO with for example Al or In added thereto, SnO₂ with for example Sb, Nb, and halogen atoms added thereto, and TiO₂ with for example Nb and Ta added thereto. These atoms added are effective.

As described in JP-B-Sho 59-6235, further, materials prepared by depositing the aforementioned metal oxides on other crystallizable metal particles or fibrous substances (for example, titanium oxide) may also be used. Additionally, the volume resistance value and the surface resistance value are different physico-chemical values, so these values cannot be compared with each other in a simple manner. So as to securely attain the conductivity of 10⁻⁸ Ωcm⁻³ or less as the volume resistance value, the antistatic layer may satisfactorily have a surface resistance value of approximately 10⁻¹⁰ Ω/□ or less, preferably 10⁻⁸ Ω/□ or less. The surface resistance value of the antistatic layer is required to be measured as the value where the antistatic layer is arranged at the utmost surface layer. In a step of forming a laminate film, intermediately, the surface resistance value can be measured.

### [Liquid Crystal Display Device]

The optical film described above (preferably, cellulose acylate film) or the polarizing plate obtained by attaching the optical film onto the polarizing film is advantageously used in liquid crystal display devices, particularly transmission liquid crystal display device.

A transmission liquid crystal display device comprises a liquid crystal cell and two sheets of a polarizing plate arranged on both the sides. Each polarizing plate comprises a polarizing film and two sheets of a transparent protective film arranged on both the sides. The liquid crystal cell retains a liquid crystal in between two sheets of electrode substrates.

The polarizing plate of the invention is arranged on one side of the liquid crystal cell or two such polarizing plates are arranged on both the sides of the liquid crystal cell.

The liquid crystal cell is preferably of the VA mode, the OCB mode and the IPS mode.

In the liquid crystal cell of the VA mode, a bar-like liquid crystal molecule is substantially vertically aligned at a time without any voltage applied.

The liquid crystal cell of the VA mode includes those described below:
(1) a liquid crystal cell of the VA mode, in the narrow sense, where a bar-like liquid crystal molecule is substantially vertically aligned (in homeotropic alignment) without any voltage applied but is substantially aligned horizontally (in homogenous alignment) with voltage application (JP-A-Hei 2-176625);
(2) a liquid crystal cell of multi-domain VA mode (MVA mode) for enlarging viewing angle (SID 97, described in the Digest of Tech. Papers (Preliminary Report Issue), 28 (1997) 845);
(3) a liquid crystal cell of a mode (n-ASM mode) where a bar-like liquid crystal molecule is substantially vertically aligned without any voltage applied but is aligned in a twisted multi-domain mode at a time of voltage application (described in the Preliminary Report Issue, 58-59 (1998)); and
(4) a liquid crystal cell of SURVIVAL mode (presented at the LCD International 98).

In case of the liquid crystal display device of the VA mode and when only one sheet of the polarizing plate of the invention is used, the polarizing plate is preferably used on the side of the backlight.

The liquid crystal cell of the OCB mode is a liquid crystal cell of a bend alignment mode where a bar-like liquid crystal molecule is aligned in substantially inverse directions (symmetrically) in the top and bottom of the liquid crystal. The liquid crystal display device using the liquid crystal cell of the bend alignment mode is disclosed in the individual specifications of U.S. Pat. No. 4,583,825 and U.S. Pat. No. 5,410,422. Because a bar-like liquid crystal molecule is aligned symmetrically in the top and bottom of the liquid crystal cell, the liquid crystal cell of the bend alignment mode has an optically self-compensatory function.

Therefore, the liquid crystal mode is called OCB (optically compensatory bend). The liquid crystal apparatus of the bend alignment mode has an advantage that the response speed thereof is fast.

The optical film of the invention is advantageously used as a support for the optically compensatory sheet in the IPS-type liquid crystal display device with a liquid crystal cell of the IPS mode or as a protective film for the polarizing plate, in particular. In these modes, liquid crystal materials are aligned approximately in parallel during black display. By aligning liquid crystal molecules in parallel with the substrate face at a state with no voltage application, black is displayed. In these modes, the polarizing plate using the optical film of the invention makes contributions to the enlargement of the viewing angle and the elevation of the contrast.

### EXAMPLES

The invention is now described in Examples and Comparative Examples. The invention is not limited to the following examples.

### Examples 1-01 and 1-02 and Comparative Example 1-01

### [Production of Cellulose Acylate Film]

### (1) Cellulose Acylate

Using a cellulose acylate type at an acetyl substitution degree of 2.79 and DS6/(DS2+DS3+DS6)=0.322, the following dope is prepared.

Herein, the cellulose acylate type at the acyl substitution degree is obtained by adding sulfuric acid as a catalyst and adding carboxylic acid as a raw material for the acyl substituent for acylation. Then, the type and amount of carboxylic acid are selected to adjust the type and substitution degree of the acyl group.

### (2) Dope Preparation

### <1-1> Cellulose Acylate Solution

The following composition is charged and agitated in a mixing tank, for dissolving the individual components, followed by filtration to prepare a uniform dope solution.

| Cellulose acylate solution | |
|---|---|
| Cellulose acylate | 100.0 parts by mass |
| Triphenyl phosphate | 8.0 parts by mass |
| Biphenyldiphenylphosphate | 4.0 parts by mass |
| Methylene chloride | 403.0 parts by mass |
| Methanol | 60.2 parts by mass |

### <1-2> Dispersion Solution of Mat Agent

The following composition containing the cellulose acylate solution prepared by the method is then charged in a dispersing machine, to prepare a dispersion solution of a mat agent.

Dispersion solution of mat agent

| | |
|---|---|
| Silica particle of mean particle size of 16 nm | 2.0 parts by mass |
| (Aerosil R972 manufactured by | |
| Nippon Aerosil Co., Ltd.) | |
| Methylene chloride | 72.4 parts by mass |
| Methanol | 10.8 parts by mass |
| Cellulose acylate solution | 10.3 parts by mass |

### <1-3> Retardation Developer Solution

The following composition containing the cellulose acylate solution prepared by the method is charged and agitated under heating in a mixing tank, for dissolution, to prepare a retardation developer solution A.

| Retardation developer solution A | |
|---|---|
| Retardation developer A | 20.0 parts by mass |
| Methylene chloride | 58.3 parts by mass |
| Methanol | 8.7 parts by mass |
| Cellulose acylate solution | 12.8 parts by mass |

100 parts by mass of the cellulose acylate solution, 1.35 parts by mass of the dispersion solution of the mat agent, and the retardation developer solution A at an amount corresponding to the final 5.1 parts by mass of the retardation developer A in the cellulose acylate film are mixed together, to prepare a dope for film production.

### Retardation Developer A

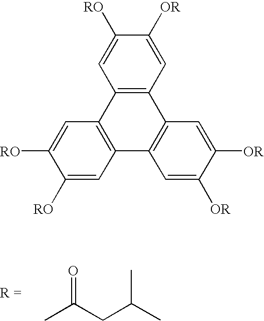

### (Casting)

The dope is cast with a band cast apparatus with a continuous metal support substrate. The dope is dried in hot air at a charged gas temperature of 70° C. for 3 minutes; the film peeled off from the metal support is transferred and dried with hot air at a charged gas temperature of 100° C. for 10 minutes, and then dried in hot air at a charged gas temperature of 140° C. for 20 minutes, to produce a cellulose acylate film of a film thickness of 100 μm.

While holding the film at four points with a biaxial stretch tester (manufactured by Toyo Seiki Co., Ltd.), the film is subjected to a stretch and shrink process under the conditions shown in Table 1. Before stretching, the film is preliminarily heated under the common conditions of charged gas temperatures defined in the individual Examples for 3 minutes. Then, it is confirmed that the temperature of the film surface as measured with a non-contact infrared thermometer is within each charged gas temperature ±1° C. After stretching, the film is cooled in air purging for 5 minutes, while the film is held with the clips. The term “MD” in the table means the cast direction during casting onto a glass plate, while the term “TD” means the width direction orthogonal to the cast direction.

### <Measuring X-Ray Diffraction Intensity>

By the method described in the section [X-ray diffraction measurement of optical film], X-ray diffraction intensity is measured, to calculate the ratio. The results are shown in Table 1.

### <Re and Rth of Film at Wavelengths 450, 550 and 650 nm>

The Re and Rth of the film at wavelengths 450, 550 and 650 nm are measured with KOBRA 21ADH (manufactured by Oji Scientific Instruments Co., Ltd.) according to the method described above.

The results are shown in Table 1. Table 1 shows that the Re and Rth of the cellulose acylate film produced by the method of the invention at wavelengths 450, 550 and 650 nm satisfy all the relationships represented by the formulas (I) to (III).

### <Preparation of Polarizing Plate>

Iodine is adsorbed onto the stretched cellulose acylate film, to prepare a polarizing film.

Using a polyvinyl alcohol-series adhesive, the cellulose acylate films prepared in Example 1-01, 1-02 and Comparative Example 1-01 are attached on one side of the polarizing film. Herein, the saponification process is done under the following conditions.

An aqueous sodium hydroxide solution at 1.5 mols/liter is prepared and kept at 55° C. A dilute aqueous sulfuric acid solution at 0.01 mol/liter is prepared and kept at 35° C. After the prepared cellulose acylate film is immersed in the aqueous sodium hydroxide solution for 2 minutes and then immersed in water, the aqueous sodium hydroxide solution is thoroughly rinsed off from the film. Subsequently, the film is immersed in the dilute aqueous sulfuric acid solution for one minute and immersed in water, from which the dilute aqueous sulfuric acid is rinsed off sufficiently. Finally, the sample is thoroughly dried at 120° C.

A commercially available cellulose triacylate film (Fujitac TD80UL manufactured by Fuji Film Corporation) is treated for saponification in the same manner as described above; using then a polyvinyl alcohol-series adhesive, the film is attached on the opposite side of a polarizer, for drying at 70° C. for 10 minutes or longer.

The cellulose acylate film is arranged in such a manner that the transmission axis of the polarizing film and the slow axis of the prepared cellulose acylate film might be parallel. The cellulose triacylate film is arranged in such a manner that the transmission axis of the polarizing film and the slow axis of the commercially available cellulose triacylate film are orthogonal to each other.

### <Preparation of Liquid Crystal Cell>

A liquid crystal cell is prepared by defining the cell gap between the substrates as 3.6 μm, dropwise injecting a liquid crystal material with a negative dielectric anisotropy [“MLC6608” manufactured by Merck] in between the substrates before sealing, to prepare a liquid crystal layer between the substrates. The retardation of the liquid crystal layer (namely, the product Δnd provided that “d” (μm) means the thickness of liquid crystal layer and Δn means the anisotropy in refractive index) is 300 nm. Herein, the liquid crystal material is aligned in a homeotropic alignment.

### <Mounting on VA Panel>

As the upper polarizing plate in the liquid crystal display device using the liquid crystal cell of the vertical alignment type as described above (on the observer side), a commercially available super-high contrast product (HLC2-5618 manufactured by SANRITZ) is used. As the lower polarizing plate (on the backlight side), a polarizing plate equipped with the cellulose acylate film prepared in any one of Examples 1-01 and 1-02 and Comparative Example 1-01 is arranged while the cellulose acrylate film is on the side of the liquid crystal cell. The upper polarizing plate and the lower polarizing plate are attached through an adhesive onto the liquid crystal cell. These polarizing plates are arranged in a cross-Nicolle arrangement in such a manner the transmission axis of the upper polarizing plate is in the up-and-down direction, while the transmission axis of the lower polarizing plate is in the right-and-left direction.

A rectangular-wave voltage of 55 Hz is applied to the liquid crystal cell. The normally black mode of white display at 5 V and black display at 0 V is preset. The black display transmission ratio (%) at a viewing angle in a direction at an azimuthal angle of 5° and a polar angle of 60° for black display, as well as the color shift Ax as the difference on the x coordinate on the xy chromaticity chart between the 45° azimuthal angle/60° polar angle and the 180° azimuthal angle/60° polar angle is determined. Additionally, the ratio of the transmission ratios of white display and black display is defined as contrast ratio. Using a meter (EZ-Contrast 160D, ELDIM Co. Ltd.), the viewing angle (within a polar angle range at a contrast ratio of 10 or more and without gradation inversion on the black side) is measured at eight grades of black display (L1) to white display (L8). The results are shown in Table 1-1. The prepared liquid crystal display devices are observed. Consequently, it is shown that neutral black display is attained in any of the front direction and the direction of the viewing angle.

Viewing angle (within a polar angle range at a contrast ratio of 10 or more and without gradation inversion on the black side)

A: a polar angle of 80° or more in all of the directions of up, down, right, and left

B: a polar angle of 80° or more in three of the directions of up, down, right, and left

C: a polar angle of 80° or more in two of the directions of up, down, right, and left

D: a polar angle of 80° or more in none or one of the directions of up, down, right, and left

Color shift (Δx)

A: less than 0.2

B: 0.02 to 0.06

C: 0.06 or more

TABLE 1

| | | Sample No. | | | | | | |
|---|---|---|---|---|---|---|---|---|
| | | Example | Example | Comparative | | Comparative | Comparative | Comparative |
| | | 1-01 | 1-02 | Example 1-01 | Example 1-11 | Example 1-11 | Example 1-02 | Example 1-03 |
| Stretch ratio | | 33% | 33% | 33% | 20% | 20% | 12% at | 33% |
| (direction) | | (TD) | (MD) | (TD) | (TD) | (TD) | maximum | (TD) |
| | | | | | | | (TD) | |
| Shrink ratio | | Shrinking by | Shrinking by | No Shrinking | Shrinking by | No Shrinking | Shrinking by | Shrinking by |
| | | 30% | 30% | | 10% | | 5% | 5% |
| X-ray diffraction | | 2.64 | 2.49 | 1.32 | 1.95 | 1.46 | 1.28 | 1.45 |
| intensity ratio | | | | | | | | |
| (stretch direction/ | | | | | | | | |
| vertical direction) | | | | | | | | |
| Film thickness before | | 100 | 100 | 100 | 60 | 60 | 30 | 160 |
| stretching (μm) | | | | | | | | |
| Optical | Re(nm) | 65 | 64 | 63 | 30 | 30 | 16 | 110 |
| properties | Rth(nm) | 175 | 188 | 185 | 105 | 118 | 85 | 271 |

| | | | | | | | |
|---|---|---|---|---|---|---|---|
| Value of the Formula | 0.71 | 0.71 | 1.00 | 0.89 | 1.01 | 0.99 | 0.85 |
| (I)*¹ | | | | | | | |
| Value of the Formula | 1.25 | 1.26 | 1.01 | 1.11 | 1.01 | 1.01 | 1.12 |
| (I)*² | | | | | | | |
| Value of the Formula | 0.82 | 0.74 | 1.06 | 0.93 | 1.03 | 0.99 | 0.88 |
| (II) | | | | | | | |
| Value of the Formula | 1.21 | 1.16 | 0.96 | 1.16 | 0.98 | 1.01 | 1.2 |
| (III) | | | | | | | |
| Viewing angle | A | A | A | A | A | D | D |
| Color shift | A | A | C | A | C | C | C |

In Table 1, Re and Rth individually mean Re(550) and Rth(550), respectively. The value of the formula (I)*¹ is the value of [(Re(450)/Rth(450))/(Re(550)/Rth(550))]; and the value of the formula (I)*² is the value of [(Re(650)/Rth(650))/(Re(550)/Rth(550))].

### Example 1-1 and Comparative Example 1-11

Using cellulose acylate with an acetyl substitution degree of 2.00, a propionyl substitution degree of 0.60, and a viscosity average polymerization degree of 350, 100 parts by mass of the cellulose acylate, 5 parts by mass of ethyl phthalylethyl glycolate, 3 parts by mass of triphenylphosphate, 290 parts by mass of methylene chloride and 60 parts by mass of ethanol are placed in a sealed container; the resulting mixture is dissolved under gradual agitation; and the resulting dope is filtered.

Alternatively, 5 parts by mass of the cellulose acylate, 5 parts by mass of TINUVIN 109 (Chiba Speciality Chemicals Co., Ltd.), 15 parts by mass of TINUVIN 326 (Chiba Speciality Chemicals Co., Ltd.), and 0.5 part by mass of AEROSIL R972V (manufactured by Nippon Aerosil Co., Ltd.) are mixed with and dissolved in 94 parts by mass of methylene chloride and 8 parts by mass of ethanol under agitation, to prepare an ultraviolet absorbent solution. R972V is preliminarily dispersed in the ethanol and then used for mixing.

To 100 parts by mass of the dope, the ultraviolet absorbent solution is added at a ratio of 6 parts by mass, for sufficient mixing with a static mixer.

### (Casting)

The dope thus prepared is cast in the same manner as described in the section “Casting” in Example 1-01, to prepare a cellulose acylate film of a film thickness of 60 μm. The film is held of its four sides with a biaxial stretch tester by the same method as described above in the section “Casting”, for promoting the stretch and shrink process under the conditions in Table 1.

Using the film after the stretch and shrink process in such manner, Re and Rth are measured according to the methods described in Example 1-01 about <Re and Rth of film at wavelength of 450, 550 and 650 nm> and <Preparation of polarizing plate>, along with the preparation of a polarizing plate. By the same procedures as described in Example 1-01 about <Preparation of liquid crystal cell> and <Mounting onto VA panel>, a liquid crystal cell is mounted for assessment. The results are shown in Table 1.

### Comparative Example 1-02

In the same manner as in Example 1-01 for preparing the cellulose acylate film except for the film thickness of 30 μm before stretching, a film was prepared. The film was stretched and shrinked under the same conditions as in Example 1-01. Due to the small film thickness before stretching, the film was broken so that the stretch ratio could only be raised up to 12%, at best. The shrink ratio then was 5%. The X-ray diffraction intensity of the film was measured in the same manner. Due to the insufficient stretch ratio, no desired diffraction intensity ratio could be yielded. Due to the insufficient film thickness before stretching leading to the insufficient stretch ratio, additionally, the optical properties of the resulting film never reached the levels of the optical properties of the film of the Example in accordance with the invention. In evaluating the film by mounting the film onto the VA panel, both the viewing angle and color shift of the film were poorer than those of the film of the Example in accordance with the invention.

### Comparative Example 1-03

In the same manner as in Example 1-01 for preparing the cellulose acylate film except for the film thickness of 160 μm before stretching, a film was prepared. The film was stretched and shrinked under the same conditions as in Example 1-01. Because the resulting film insufficiently shrank, the shrink ratio could only be raised up to 5%, at best. It may be due to the too large film thickness before stretching leading to no generation of any shrink stress inside the film. The X-ray diffraction intensity of the film was measured in the same manner. Due to the insufficient shrink ratio, no desired diffraction intensity ratio could be yielded. Due to the too large film thickness before stretching, additionally, values expressing the optical properties were too large. In evaluating the film by mounting the film onto the VA panel, both the viewing angle and color shift of the film were poorer than those of the film of the Example in accordance with the invention.

The properties of the samples of Comparative Examples 1-02 and 1-03 were verified. The results are shown in Table 1.

### Example 1-13

### <Mounting on OCB Panel for Assessment>

### (Alkali Treatment)

The cellulose acylate film prepared in Example 1-01 is coated with a potassium hydroxide solution of 1.0 mol/L (solvent: water/isopropyl alcohol/propylene glycol=69.2 parts by mass/15 parts by mass/15.8 parts by mass) to 10 cc/m²; then, the cellulose acylate film is retained at that state at about 40° C. for 30 seconds, from which the alkali solution is scraped off. Subsequently, the film is washed in pure water, from which water droplets are removed with an air knife. Thereafter, the film is dried at 100° C. for 15 seconds.

The contact angle of the alkali-treated surface to pure water is measured. The contact angle is 42°.

### (Formation of Alignment Film)

A coating solution of an alignment film in the following composition is coated on the alkali-treated surface with a #16 wire bar coater to 28 ml/m². The coated surface is dried in hot air at 60° C. for 60 seconds and then in hot air at 90° C. for 150 seconds, to form an alignment film.

Composition of coating solution of alignment film

| | | |
|---|---|---|
| Modified polyvinyl alcohol of the following | 10 | parts by mass |
| composition | | |
| Water | 371 | parts by mass |
| Methanol | 119 | parts by mass |
| Glutaraldhyde (crosslinking agent) | 0.5 | part by mass |
| Citrate ester (AS3, manufactured by Sankyo | 0.35 | part by mass |
| Chemical Co., Ltd.) | | |

### Modified Polyvinyl Alcohol

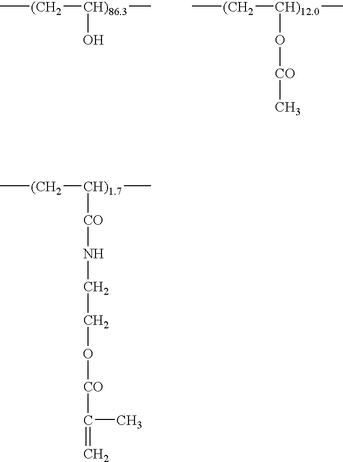

### (Rubbing Treatment)

The resulting transparent support with the alignment film formed thereon is transferred at a velocity of 20 m/min. By presetting a rubbing roll (a diameter of 300 mm) to a rubbing angle of 45° toward the longitudinal direction, the roll is rotated at 650 rpm, to treat the alignment film-formed surface of the transparent support by the rubbing process. The length of the transparent support in contact with the rubbing roll is preset to 18 mm.

### (Formation of Another Optically Anisotropic Layer)

41.01 kg of a discotic liquid crystal compound (the following discotic liquid crystal compound), 4.06 kg of ethylene oxide-modified trimethylol propane triacrylate (V#360, manufactured by Osaka Organic Chemical Industry, Ltd.), 0.35 kg of cellulose acetate butylate (CAB531-1, manufactured by Eastman Kodak), 1.35 kg of a photo-polymerization initiator (Irgacure 907 manufactured by Chiba Geigy), and 0.45 kg of an enhancer (Kayacure DETX manufactured by Nippon Kayaku Co., Ltd.) are dissolved in 102 kg of methyl ethyl ketone. 0.1 kg of a fluoro-aliphatic group-containing copolymer (MEGAFAC F780, manufactured by Dainippon Ink and Chemicals, Incorporated) is added to the resulting solution, to prepare a coating solution. The coating solution is continuously coated on the alignment film surface of the transparent support in transfer at 20 m/min, while rotating a #3.2-wire bar at 391 rpm in the same direction as the film transfer direction.

Discotic Liquid Crystal Compound

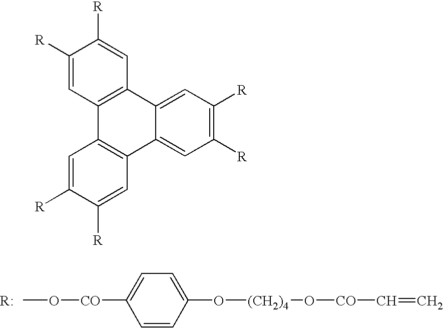

By heating the transparent support continuously from ambient temperature to 100° C., the solvent is dried. Subsequently, the discotic optically anisotropic layer is heated in a drying zone at 130° C. for about 90 seconds to a wind velocity of 2.5 m/sec on the film surface of the discotic optically anisotropic layer, to align the discotic liquid crystal compound. Transferring the film to a drying zone at 80° C., the film is irradiated with an ultraviolet radiation at a 600-mW intensity of illumination from an ultraviolet irradiation apparatus (UV lamp: output at 160 W/cm and an emission length of 1.6 m) for 4 seconds while the film is at the surface temperature of about 100° C., to progress crosslinking reactions to fix the discotic liquid crystal compound at the aligned state. Then, the film is cooled to ambient temperature and rolled up in a cylinder shape, to prepare the film in a roll-like shape. In such manner, a roll-like optically compensatory film (KH-1-3) is prepared.

The viscosity of the optically anisotropic layer is measured at the film surface temperature of 127° C. The viscosity is 695 cp. The viscosity is obtained from results of measurement of the viscosity of a liquid crystal layer of the same composition as that of the optically anisotropic layer (excluding the solvents) with a heating-type viscometer of Type E.

The prepared roll-like optically compensatory film KH-1-3 is partially cut into a piece, which is used as a sample for measuring the optical profile. The Re retardation value of the optically anisotropic layer as measured at a wavelength of 546 nm is 38 nm. The angle (slanting angle) of the disk surface of the discotic liquid crystal compound in the optically anisotropic layer toward the support surface continuously varied in the layer depth direction. The mean is 28°. Further, only the optically anisotropic layer is peeled off from the sample, to measure the mean direction of the molecular symmetric axis of the optically anisotropic layer. The mean direction is 45° toward the longitudinal direction of the optically compensatory film.

### (Preparation of Polarizing Plate)

A polarizing film is prepared by allowing iodine to be adsorbed onto the stretched polyvinyl alcohol film. Using then a polyvinyl alcohol-series adhesive, the prepared film (KH-1-3) is attached on one side of the polarizing film. The film is arranged in such a manner that the transmission axis of the polarizing film might be parallel to the slow axis of the optically compensatory film (KH-1-3).

A commercially available cellulose triacylate film (Fujitac TD80UL manufactured by Fuji Film Corporation) is treated for saponification in the same manner as described above; using then a polyvinyl alcohol-series adhesive, the film is attached on the opposite side of a polarizer. In such manner, a polarizing plate is prepared.

### <Preparation of Bend-Aligned Liquid Crystal Cell>

A polyimide film is mounted as an alignment film onto glass substrates with an ITO electrode, for treating the alignment film with a rubbing process. The resulting two glass substrates are faced to each other in an arrangement such that the rubbing directions thereof might be parallel, while the cell gap is preset to 4.7 μm. Injecting a liquid crystal compound with Δn of 0.1396 (ZLI1132 manufactured by Merck) into the cell gap, a bend-aligned liquid crystal cell is prepared.

Two sheets of the polarizing plate prepared by the aforementioned method are attached onto the bend-aligned cell in such a manner that the resulting bend-aligned cell might be placed between the plates. The cell, the polarizing plate and the like are arranged in such a manner that the optically anisotropic layer of the polarizing plate faced the cell substrate, while the rubbing direction of the liquid crystal cell is anti-parallel to the rubbing direction of “the other” optically anisotropic layer facing the cell.

A rectangular-wave voltage of 55 Hz is applied to the liquid crystal cell. The normally black mode of white display at 2 V and black display at 5 V is preset. A voltage with the smallest transmission ratio in the front, namely black voltage is applied, to observe the prepared liquid crystal display device. In any of the front direction and the viewing angle direction, neutral black display could be attained. [Examples 2-01 and 2-02 and Comparative Example 2-01]

### [Preparing Cellulose Acylate Film]

### (1) Cellulose Acylate

Using a cellulose acylate type at an acetyl substitution degree of 2.79 and DS6/(DS2+DS3+DS6)=0.322, the following dope is prepared.

### (2) Dope Preparation

### <1-1> Cellulose Acylate Solution

The following composition is charged and agitated in a mixing tank, for dissolving the individual components, followed by filtration to prepare a uniform dope solution.

| Cellulose acylate solution | |
|---|---|
| Cellulose acylate | 100.0 parts by mass |
| Triphenylphosphate | 8.0 parts by mass |
| Biphenyldiphenylphosphate | 4.0 parts by mass |
| Methylene chloride | 403.0 parts by mass |
| Methanol | 60.2 parts by mass |

### <1-2> Dispersion Solution of Mat Agent

The following composition containing the cellulose acylate solution prepared by the method is then charged in a dispersing machine, to prepare a dispersion solution of a mat agent.

Dispersion solution of mat agent

| | |
|---|---|
| Silica particle of mean particle size of 16 nm | 2.0 parts by mass |
| (Aerosil R972 manufactured by Nippon Aerosil | |
| Co., Ltd.) | |
| Methylene chloride | 72.4 parts by mass |
| Methanol | 10.8 parts by mass |
| Cellulose acylate solution | 10.3 parts by mass |

### <1-3> Retardation Developer Solution

The following composition containing the cellulose acylate solution prepared by the method is charged and agitated under heating in a mixing tank, for dissolution, to prepare a retardation developer solution A.

| Retardation developer solution A | |
|---|---|
| Retardation developer A | 20.0 parts by mass |
| Methylene chloride | 58.3 parts by mass |
| Methanol | 8.7 parts by mass |
| Cellulose acylate solution | 12.8 parts by mass |

100 parts by mass of the cellulose acylate solution, 1.35 parts by mass of the dispersion solution of the mat agent, and the retardation developer solution A at an amount corresponding to the final 5.1 parts by mass of the retardation developer A in the cellulose acylate film are mixed together, to prepare a dope for film production.

### Retardation Developer A

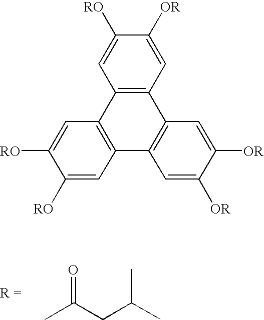

### (Casting)

The dope is cast with a band cast apparatus with a continuous metal support substrate. The dope is dried in hot air at a charged gas temperature of 70° C. for 3 minutes; the film peeled off from the metal support is transferred and dried with hot air at a charged gas temperature of 100° C. for 10 minutes, and then dried in hot air at a charged gas temperature of 140° C. for 20 minutes, to produce a cellulose acylate film of a film thickness of 100 μm.

While holding the film at four points with a biaxial stretch tester (manufactured by Toyo Seiki Co., Ltd.), the film is subjected to a stretch and shrink process under the conditions shown in Table 2-1. Before stretching, the film is preliminarily heated under the common conditions of charged gas temperatures defined in the individual Examples for 3 minutes. Then, it is confirmed that the temperature of the film surface as measured with a non-contact infrared thermometer is within each charged gas temperature ±1° C. After stretching, the film is cooled in air purging for 5 minutes, while the film is held with the clips. The term “MD” in the table means the casting direction during casting onto a glass plate, while the term “TD” means the width direction orthogonal to the casting direction.

### <Measuring Tensile Elastic Modulus>

The resulting individual films are measured according to the method for measuring <elastic modulus of optical film>.

### <Re and Rth of Film at Wavelengths 450, 550 and 650 nm>

The Re and Rth of the film at wavelengths 450, 550 and 650 nm are measured with KOBRA 21ADH (manufactured by Oji Scientific Instruments Co., Ltd.) according to the method described above.

The results are shown in Table 2. Table 2 shows that the Re and Rth of the cellulose acylate film produced by the method of the invention at wavelengths 450, 550 and 650 nm satisfy all the relationships represented by the formulas (I) to (III).

<Preparation of Polarizing Plate>

Iodine is adsorbed onto the stretched cellulose acylate film, to prepare a polarizing film.

Using a polyvinyl alcohol-series adhesive, the cellulose acylate films prepared in Examples 2-01 and 2-02 and Comparative Example 2-01 are attached on one side of the polarizing film. Herein, the saponification process is done under the following conditions.

An aqueous sodium hydroxide solution at 1.5 mols/liter is prepared and kept at 55° C. A dilute aqueous sulfuric acid solution at 0.01 mol/liter is prepared and kept at 35° C. After the prepared cellulose acylate film is immersed in the aqueous sodium hydroxide solution for 2 minutes and then immersed in water, the aqueous sodium hydroxide solution is thoroughly rinsed off from the film. Subsequently, the film is immersed in the dilute aqueous sulfuric acid solution for one minute and immersed in water, from which the dilute aqueous sulfuric acid is rinsed off sufficiently. Finally, the sample is thoroughly dried at 120° C.

A commercially available cellulose triacylate film (Fujitac TD80UL manufactured by Fuji Film Corporation) is treated for saponification; using then a polyvinyl alcohol-series adhesive, the film is attached on the opposite side of a polarizer, for drying at 70° C. for 10 minutes or longer.

The cellulose acylate film is arranged in such a manner that the transmission axis of the polarizing film and the slow axis of the prepared cellulose acylate film might be parallel. The commercially available cellulose triacylate film is arranged in such a manner that the transmission axis of the polarizing film and the slow axis of the cellulose triacylate film are orthogonal to each other.

### <Preparation of Liquid Crystal Cell>

A liquid crystal cell is prepared by defining the cell gap between the substrates as 3.6 μm, dropwise injecting a liquid crystal material with a negative dielectric anisotropy [“MLC6608” manufactured by Merck] in between the substrates before sealing, to prepare a liquid crystal layer between the substrates. The retardation of the liquid crystal layer (namely, the product Δn·d provided that “d” (μm) means the thickness of liquid crystal layer and Δn means the anisotropy in refractive index) is 300 nm. Herein, the liquid crystal material is aligned to a homeotropic alignment.

### <Mounting on VA Panel>

As the upper polarizing plate in the liquid crystal display device using the liquid crystal cell of the vertical alignment type as described above (on the observer side), a commercially available super-high contrast product (HLC2-5618 manufactured by SANRITZ) is used. As the lower polarizing plate (on the backlight side), a polarizing plate equipped with the cellulose acylate film prepared in any one of Examples 2-01 and 2-02 and Comparative Example 2-01 is arranged while the cellulose acylate film is on the side of the liquid crystal cell. The upper polarizing plate and the lower polarizing plate are attached through an adhesive onto the liquid crystal cell. These polarizing plates are arranged in a cross-Nicolle arrangement in such a manner that the transmission axis of the upper polarizing plate is in the up-and-down direction, while the transmission axis of the lower polarizing plate is in the right-and-left direction.

A rectangular-wave voltage of 55 Hz is applied to the liquid crystal cell. The normally black mode of white display at 5 V and black display at 0 V is preset. The black display transmission ratio (%) at a viewing angle in a direction at an azimuthal angle of 45° and a polar angle of 60° for black display, as well as the color shift Ax as the difference on the x coordinate of the xy chromaticity chart between the 45° azimuthal angle/60° polar angle and the 180° azimuthal angle/60° polar angle, is determined.

Additionally, the ratio of the transmission ratios of white display and black display is defined as contrast ratio. Using a meter (EZ-Contrast 160D, ELDIM Co. Ltd.), a viewing angle (within a polar angle range at a contrast ratio of 10 or more and without gradation inversion on the black side) is measured at eight grades of black display (L1) to white display (L8).

The results are shown in Table 2. The prepared liquid crystal display devices are observed. Consequently, it is shown that neutral black display is attained at any of the front direction and the direction of the viewing angle in Examples 2-01 and 2-02.

Viewing angle (within a polar angle range at a contrast ratio of 10 or more and without gradation inversion on the black side)

A: a polar angle of 80° or more in all of the directions of up, down, right, and left

B: a polar angle of 80° or more in three of the directions of up, down, right, and left

C: a polar angle of 80° or more in two of the directions of up, down, right, and left

D: a polar angle of 80° or more in none or one of the directions of up, down, right, and left

Color shift (Δx)

A: less than 0.2

B: 0.02 to 0.06

C: 0.06 or more

TABLE 2

| | | Sample No. | | | | | | |
|---|---|---|---|---|---|---|---|---|
| | | Example | Example | Comparative | | Comparative | Comparative | Comparative |
| | | 2-01 | 2-02 | Example 2-01 | Example 2-11 | Example 2-11 | Example 2-02 | Example 2-03 |
| Stretch ratio | | 35% | 35% | 35% | 25% | 25% | 16% at | 35% |
| (direction) | | (TD) | (MD) | (TD) | (TD) | (TD) | maximum | (TD) |
| | | | | | | | (TD) | |
| Shrink ratio | | Shrinking by | Shrinking by | No Shrinking | Shrinking by | No Shrinking | Shrinking by | Shrinking by |
| | | 30% | 30% | | 20% | | 5% | 5% |
| Elastic | Stretch | 4918 | 5360 | 4510 | 3850 | 3530 | 3752 | 5230 |
| modulus | direction | | | | | | | |
| (MPa) | Vertical | 2257 | 2490 | 3851 | 2508 | 2780 | 3283 | 4310 |
| | direction | | | | | | | |
| | Ratio | 2.18 | 2.15 | 1.17 | 1.54 | 1.27 | 1.14 | 1.21 |
| Film thickness before | | 100 | 100 | 100 | 60 | 60 | 35 | 160 |
| stretching (μm) | | | | | | | | |
| Optical | Re(nm) | 65 | 68 | 65 | 32 | 30 | 18 | 118 |
| properties | Rth(nm) | 178 | 185 | 190 | 110 | 120 | 95 | 285 |

| | | | | | | | |
|---|---|---|---|---|---|---|---|
| Value of the Formula | 0.71 | 0.70 | 1.00 | 0.90 | 1.02 | 0.99 | 0.88 |
| (I)*¹ | | | | | | | |
| Value of the Formula | 1.25 | 1.25 | 1.01 | 1.11 | 1.00 | 1.02 | 1.11 |
| (I)*² | | | | | | | |
| Value of the Formula | 0.81 | 0.78 | 1.06 | 0.92 | 1.04 | 0.99 | 0.90 |
| (II) | | | | | | | |
| Value of the Formula | 1.22 | 1.18 | 0.96 | 1.16 | 0.98 | 1.01 | 1.20 |
| (III) | | | | | | | |
| Viewing angle | A | A | A | A | A | D | D |
| Color shift | A | A | C | A | C | C | C |

In Table 2, Re and Rth individually mean Re(550) and Rth(550), respectively. The value of the formula (I)*¹ is the value of [(Re(450)/Rth(450))/(Re(550)/Rth(550))]; and the value of the formula (I)*² is the value of [(Re(650)/Rth(650))/(Re(550)/Rth(550))].

### Example 2-11 and Comparative Example 2-11

Using a cellulose acylate at an acetyl substitution degree of 2.00, a propionyl substitution degree of 0.60, and a viscosity average polymerization degree of 350, 100 parts by mass of the cellulose acylate, 5 parts by mass of ethyl phthalylethyl glycolate, 3 parts by mass of triphenylphosphate, 290 parts by mass of methylene chloride and 60 parts by mass of ethanol are placed in a sealed container; the resulting mixture is dissolved under gradual agitation; and the resulting dope is filtered.

Alternatively, 5 parts by mass of the cellulose acylate, 5 parts by mass of TINUVIN 109 (Chiba Speciality Chemicals Co., Ltd.), 15 parts by mass of TINUVIN 326 (Chiba Speciality Chemicals Co., Ltd.), and 0.5 part by mass of AEROSIL R972V (manufactured by Nippon Aerosil Co., Ltd.) are mixed with and dissolved in 94 parts by mass of methylene chloride and 8 parts by mass of ethanol under agitation, to prepare an ultraviolet absorbent solution. R972V is preliminarily dispersed in the ethanol and then used for mixing.

To 100 parts by mass of the dope, the ultraviolet absorbent solution is added at a ratio of 6 parts by mass, for sufficient mixing with a static mixer.

### (Casting)

The dope thus prepared is cast in the same manner as described in the section “Casting” in Example 2-01, to prepare a cellulose acylate film of a film thickness of 60 μm. The film is held of its four sides with a biaxial stretch tester by the same method as described above in the section “Casting”, for promoting the stretch and shrink process under the conditions in Table 2.

Using the film after the stretch and shrink process in such manner, Re and Rth are measured according to the methods described in Example 2-01 about <Re and Rth of film at wavelength of 450, 550 and 650 nm> and <Preparation of polarizing plate>, along with the preparation of a polarizing plate. By the same procedures as described in Example 2-01 about <Preparation of liquid crystal cell> and <Mounting onto VA panel>, a liquid crystal cell is mounted for assessment. The results are shown in Table 2.

### Comparative Example 2-02

In the same manner as in Example 2-01 for preparing the cellulose acylate film except for the film thickness of 35 μm before stretching, a film was prepared. The film was stretched and shrinked under the same conditions as in Example 2-01. Due to the small film thickness before stretching, the film was broken so that the stretch ratio could only be raised up to 16%, at best. The shrink ratio then was 5%. The elastic modulus of the film was also measured in the same manner. Due to the insufficient stretch ratio, no desired ratio of the elastic moduli in the stretch direction and in the vertical direction was obtained. Due to the insufficient film thickness before stretching and the insufficient stretch ratio, additionally, the optical properties of the resulting film never reached the levels of the optical properties of the film in the Example in accordance with the invention. In evaluating the film by mounting the film onto the VA panel, both the viewing angle and color shift of the film were poorer than those of the film of the Example in accordance with the invention.

### Comparative Example 2-03

In the same manner as in Example 2-01 for preparing the cellulose acylate film except for the final film thickness of 160 μm, a film was prepared. The film was stretched and shrinked under the same conditions as in Example 2-01. The film insufficiently shrank so that the shrink ratio could only be raised up to 5%, at best. It may be due to the too large film thickness before stretching causing no generation of any shrink stress inside the film. The elastic modulus of the film was also measured in the same manner. Due to the insufficient shrink ratio, no desired ratio of the elastic modulus in the stretch direction and in the vertical direction was obtained. Due to the too large film thickness before stretching, additionally, values expressing the optical properties of the resulting film were too large. In evaluating the film by mounting the film onto the VA panel, both the viewing angle and color shift of the film were poorer than those of the film of the Example in accordance with the invention.

The properties of the samples from Comparative Examples 2-02 and 2-03 were verified. The results are shown in Table 2.

### Example 2-13

### <Mounting on OCB Panel for Assessment>

### (Alkali Treatment)

The cellulose acylate film prepared in Example 2-01 is coated with a potassium hydroxide solution of 1.0 mol/L (solvent: water/isopropyl alcohol/propylene glycol=69.2 parts by mass/15 parts by mass/15.8 parts by mass) to 10 cc/m²; then, the cellulose acylate film is retained at that state at about 40° C. for 30 seconds, from which the alkali solution is scraped off. Subsequently, the film is washed in pure water, from which water droplets are removed with an air knife. Thereafter, the film is dried at 100° C. for 15 seconds.

The contact angle of the alkali-treated surface to pure water is measured. The contact angle is 42°.

### (Formation of Alignment Film)

A coating solution of an alignment film in the following composition is coated on the alkali-treated surface with a #16-wire bar coater to 28 ml/m². The coated surface is dried in hot air at 60° C. for 60 seconds and then in hot air at 90° C. for 150 seconds, to form an alignment film.

Composition of coating solution of alignment film

| | | |
|---|---|---|
| Modified polyvinyl alcohol of the following | 10 | parts by mass |
| composition | | |
| Water | 371 | parts by mass |
| Methanol | 119 | parts by mass |
| Glutaraldhyde (crosslinking agent) | 0.5 | part by mass |
| Citrate ester (AS3, manufactured by Sankyo | 0.35 | part by mass |
| Chemical Co., Ltd.) | | |

### Modified Polyvinyl Alcohol

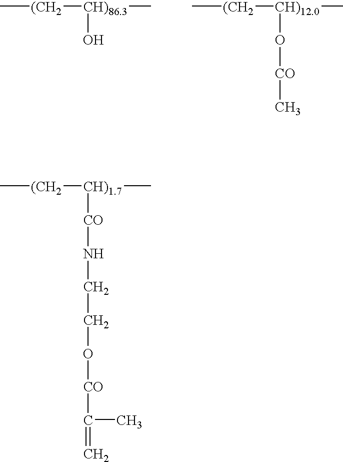

### (Rubbing Treatment)

The resulting transparent support with the alignment film formed thereon is transferred at a velocity of 20 m/min. By presetting a rubbing roll (a diameter of 300 mm) to a rubbing angle of 45° toward the longitudinal direction, the roll is rotated at 650 rpm, to treat the alignment film-formed surface of the transparent support by the rubbing process. The length of the transparent support in contact with the rubbing roll is preset to 18 mm.

### (Formation of Another Optically Anisotropic Layer)

41.01 kg of the discotic liquid crystal compound used in Example 2-01, 4.06 kg of ethylene oxide-modified trimethylolpropane triacrylate (V#360, manufactured by Osaka Organic Chemical Industry, Ltd.), 0.35 kg of cellulose acetate butylate (CAB531-1, manufactured by Eastman Kodak), 1.35 kg of a photo-polymerization initiator (Irgacure 907 manufactured by Chiba Geigy), and 0.45 kg of an enhancer (Kayacure DETX manufactured by Nippon Kayaku Co., Ltd.) are dissolved in 102 kg of methyl ethyl ketone. 0.1 kg of a fluoro-aliphatic group-containing copolymer (MEGAFAC F780, manufactured by Dainippon Ink and Chemicals, Incorporated) is added to the resulting solution, to prepare a coating solution. The coating solution is continuously coated on the alignment film surface of the transparent support in transfer at 20 m/min, while rotating a #3.2-wire bar at 391 rpm in the same direction as the film transfer direction.

By heating the transparent support continuously from ambient temperature to 100° C., the solvent is dried. Subsequently, the discotic optically anisotropic layer is heated in a drying zone at 130° C. for about 90 seconds to a wind velocity of 2.5 m/sec on the film surface of the discotic optically anisotropic layer, to align the discotic liquid crystal compound. Transferring the film into a drying zone at 80° C., the film is irradiated with an ultraviolet radiation at a 600-mW intensity of illumination from an ultraviolet irradiation apparatus (UV lamp: output at 160 W/cm and an emission length of 1.6 m) for 4 seconds while the film is at the surface temperature of about 100° C., to progress crosslinking reactions to fix the discotic liquid crystal compound at the aligned state. Then, the film is cooled to ambient temperature and rolled up in a cylinder shape, to prepare the film in a roll-like shape. In such manner, a roll-like optically compensatory film (KH-2-3) is prepared.

The viscosity of the optically anisotropic layer is measured at the film surface temperature of 127° C. The viscosity is 695 cp. The viscosity is obtained from results of the measurement of the viscosity of a liquid crystal layer of the same composition as that of the optically anisotropic layer (excluding the solvents) with a heating-type viscometer of Type E.

The prepared roll-like optically compensatory film KH-2-3 is partially cut into a piece, which is used as sample for measuring the optical profile. The Re retardation value of the optically anisotropic layer as measured at a wavelength of 546 nm is 38 nm. The angle (slanting angle) of the disk surface of the discotic liquid crystal compound in the optically anisotropic layer toward the support surface continuously varied in the layer depth direction. The mean is 28°. Further, only the optically anisotropic layer is peeled off from the sample, to measure the mean direction of the molecular symmetric axis of the optically anisotropic layer. The mean direction is 45° toward the longitudinal direction of the optically compensatory film.

### (Preparation of Polarizing Plate)

A polarizing film is prepared by allowing iodine to be adsorbed onto the stretched polyvinyl alcohol film. Using then a polyvinyl alcohol-series adhesive, the prepared film (KH-2-3) is attached on one side of the polarizing film. The film is arranged in such a manner that the transmission axis of the polarizing film might be parallel to the slow axis of the retardation plate (KH-2-3).

A commercially available cellulose triacylate film (Fujitac TD80UL manufactured by Fuji Film Corporation) is treated for saponification; using then a polyvinyl alcohol-series adhesive, the film is attached on the opposite side of a polarizer. In such manner, a polarizing plate is prepared.

### <Preparation of Bend-Aligned Liquid Crystal Cell>

A polyimide film is mounted as an alignment film onto glass substrates with an ITO electrode, for treating the alignment film with a rubbing process. The resulting two glass substrates are faced to each other in an arrangement such that the rubbing directions thereof might be parallel, while the cell gap is preset to 4.7 μm. Injecting a liquid crystal compound with Δn of 0.1396 (ZLI1132 manufactured by Merck) into the cell gap, a bend-aligned liquid crystal cell is prepared.

Two sheets of the polarizing plate prepared by the aforementioned method are attached onto the bend-aligned cell in such a manner that the cell might be placed between the plates. The bend-aligned cell, the polarizing plate and the like are aligned in such a manner that the optically anisotropic layer of the polarizing plate faced the cell substrate and the rubbing direction of the liquid crystal cell is anti-parallel to the rubbing direction of “the other” optically anisotropic layer facing the cell.

A rectangular-wave voltage of 55 Hz is applied to the liquid crystal cell. The normally black mode of white display at 2 V and black display at 5 V is preset. A voltage with the smallest transmission ratio in the front, namely black voltage is applied, to observe the prepared liquid crystal display device. In any of the front direction and the viewing angle direction, neutral black display could be attained.

Te liquid crystal display device prepared above is subjected to the following enforced test.

### (High-Temperature Conditions)

A liquid crystal panel of a 20-inch size with the whole surface attached with the polarizing plate is stored under enforced conditions of high temperature conditions (temperature of 80° C. and humidity of 10% or less) for 48 hours. Within 10 minutes, the liquid crystal panel is mounted on the backlight to turn on the backlight.

The level of optical slip then observed in the periphery is used for the assessment.

### (High-Temperature Humidified Conditions)

A liquid crystal panel of a 20-inch size with the whole surface attached with the polarizing plate is stored under high-temperature humidified conditions (temperature of 80° C. and humidity of 90%) for 48 hours and then in environment at a temperature of 25° C. and 60% RH for 24 hours. Thereafter, the liquid crystal panel is mounted on the backlight to turn on the backlight.

The level of optical slip then observed in the periphery is used for assessment.

Compared with a liquid crystal display device equipped with a polarizing plate prepared by using the optical film in the Comparative Example, consequently, optical slip observed in the periphery is reduced in the liquid crystal display device equipped with the polarizing plate prepared by using the optical film of the invention.

In case that a side with a larger tensile elastic modulus in the optical film of the invention is arranged in parallel to the longitudinal direction of the liquid crystal display device, it is found that the effect of reducing optical slip is larger.

### INDUSTRIAL APPLICABILITY

By stretching a film, shrinking the film in a direction approximately vertical to the stretch direction, further adjusting the film thickness just before the stretch step to 40 to 150 μm in accordance with the invention, the X-ray diffraction intensity in the stretch direction on the film plane can be 1.6 fold or more the X-ray diffraction intensity in the vertical direction to the stretch direction, so that the polymer alignment in the film can be enhanced. Therefore, the use of a film at a higher alignment degree in accordance with the invention provides a liquid crystal display device at a uniform display level.

By stretching a film, shrinking the film in a direction approximately vertical to the stretch direction, further adjusting the film thickness just before the stretch step to 40 to 150 μm in accordance with the invention, the tensile elastic modulus in the stretch direction is larger by 1.3 fold or more than the tensile stretch modulus in the direction vertical to the stretch direction, so that the deformation level in the stretch direction can be reduced even when an environmental change of temperature and humidity occurs on the film. Thus, the use of a film at a smaller deformation level in accordance with the invention provides a liquid crystal display device at a uniform display level.

In such manner, the liquid crystal cell can accurately carry out optical compensation, so that the liquid crystal cell can get the improvement in high contrast and color shift depending on the viewing angle direction during black display. Particularly, the invention provides optical films of the VA, IPS and OCB modes, methods for producing such films, and polarizing plates using such optical films. In accordance with the invention, there is provided a liquid crystal display device of VA, IPS and OCB modes in particular, with the improvement in contrast and color shift depending on the viewing angle direction during black display.

What is claimed is:

1. An optical film having a value of 1.6 or more,
wherein the value is obtained by dividing a larger value by a smaller value of the maximum X-ray diffraction intensity within a range 2η=10 to 40° in a longitudinal direction of the film and the maximum X-ray diffraction intensity within a range 20=10 to 40° in a direction approximately vertical to the longitudinal direction of the film.

2. The optical film according to claim 1, which satisfies the following formulas (I) to (III):
0.4<|(Re(450)/Rth(450))/(Re(550)/Rth(550))|<0.95 (I):
and
1.05<{(Re(650)/Rth(650))/(Re(550)/Rth(550))}<1.9
0.1<(Re(450)/Re(550))<0.95 (II):
1.03<(Re(650)/Re(550))<1.93, (III):
wherein Re(λ) represents an in-plane retardation Re (unit: nm) at a λ nm wavelength; and
Rth(λ) represents a retardation in a thickness direction Rth (unit: nm) at a λ nm wavelength.

3. A production method of the optical film according to claim 1, comprising:
a stretch step of stretching a film having a thickness of 40 to 150 μm; and
a shrink step of shrinking the film in a direction approximately vertical to the stretch direction.

4. An optical film produced by the production method according to claim 3, having a value of 1.6 or more,
wherein the value is obtained by dividing a larger value by a smaller value of the maximum X-ray diffraction intensity within a range 20=10 to 40° in a longitudinal direction of the film and the maximum X-ray diffraction intensity within a range 20=10 to 40° in a direction approximately vertical to the longitudinal direction of the film.

5. The optical film according to claim 1,
wherein Re(550) is within a range of 20 to 150 nm; and
Rth(550) is within a range of 100 to 300 nm.

6. An optical film having a value of 1.3 or more,
wherein the value is obtained by dividing a larger value by a smaller value of a tensile elastic modulus in a longitudinal direction of the film and a tensile elastic modulus in a direction approximately vertical to the longitudinal direction of the film.

7. The optical film according to claim 6, which satisfies the following formulas (I) to (III):
0.4<|(Re(450)/Rth(450))/(Re(550)/Rth(550))|<0.95 (I):
and
1.05<{(Re(650)/Rth(650))/(Re(550)/Rth(550))}<1.9
0.1<(Re(450)/Re(550))<0.95 (II):
1.03<(Re(650)/Re(550))<1.93, (III):
wherein Re(λ) represents an in-plane retardation Re (unit: nm) at a λ nm wavelength; and
Rth(λ) represents a retardation in a thickness direction Rth (unit: nm) at a λ nm wavelength.

8. A production method of the optical film according to claim 6, comprising:
a stretch step of stretching a film having a thickness of 40 to 150 μm; and
a shrink step of shrinking the film in a direction approximately vertical to the stretch direction.

9. An optical film produced by the production method according to claim 8, having a value of 1.3 or more,
wherein the value is obtained by dividing a larger value by a smaller value of a tensile elastic modulus in a longitudinal direction of the film and a tensile elastic modulus in a direction approximately vertical to the longitudinal direction of the film.

10. The optical film according to claim 6,
wherein Re(550) is within a range of 20 to 150 nm; and
Rth(550) is within a range of 100 to 300 nm.

11. The optical film according to claim 1, comprising a cellulose acylate.

12. The optical film according to claim 6, comprising a cellulose acylate.

13. The optical film according to claim 11, which satisfies the following formulas (IV) and (V):
2.0≦(DS2+DS3+DS6)≦3.0 (IV):
DS6/(DS2+DS3+DS6)≧0.315, (V):
wherein DS2 represents a degree of substitution of a hydroxyl group by an acyl group at a 2-position in a glucose unit of the cellulose acylate;
DS3 represents a degree of substitution of a hydroxyl group by an acyl group at a 3-position in a glucose unit of the cellulose acylate; and
DS6 represents a degree of substitution of a hydroxyl group by an acyl group at a 6-position in a glucose unit of the cellulose acylate.

14. The optical film according to claim 12, which satisfies the following formulas the following formulas (IV) and (V):
2.0≦(DS2+DS3+DS6)≦3.0 (IV):
DS6/(DS2+DS3+DS6)≧0.315, (V):
wherein DS2 represents a degree of substitution of a hydroxyl group by an acyl group at a 2-position in a glucose unit of the cellulose acylate;
DS3 represents a degree of substitution of a hydroxyl group by an acyl group at a 3-position in a glucose unit of the cellulose acylate; and
DS6 represents a degree of substitution of a hydroxyl group by an acyl group at a 6-position in a glucose unit of the cellulose acylate.

15. The optical film according to claim 11, substantially comprising a cellulose acylate satisfying the formulas (VI) and (VII):
2.0≦A+B≦3.0 (VI):
0<B, (VII):
wherein A represents a degree of substitution of a hydroxyl group by an acetyl group in a glucose unit of the cellulose acylate; and
B represents a degree of substitution of a hydroxyl group by a propionyl group, butyryl group or benzoyl group in a glucose unit of the cellulose acylate.

16. The optical film according to claim 12, substantially comprising a cellulose acylate satisfying the formulas (VI) and (VII):
2.0≦A+B≦3.0 (VI):
0<B, (VII):
wherein A represents a degree of substitution of a hydroxyl group by an acetyl group in a glucose unit of the cellulose acylate; and
B represents a degree of substitution of a hydroxyl group by a propionyl group, butyryl group or benzoyl group in a glucose unit of the cellulose acylate.

17. The optical film according to claim 1, comprising a retardation developer.

18. The optical film according to claim 6, comprising a retardation developer.

19. A polarizing plate comprising:
a pair of protective films; and
a polarizing film sandwiched between the pair of protective films,
wherein at least one of the protective films is the optical film according to claim 1.

20. A polarizing plate comprising:
a pair of protective films; and
a polarizing film sandwiched between the pair of protective films,
wherein at least one of the protective films is the optical film according to claim 6.

21. A liquid crystal display device comprising the optical film according to claim 1.

22. A liquid crystal display device comprising the optical film according to claim 6.

23. A liquid crystal display device of IPS, OCR or VA mode, comprising
a liquid crystal cell; and
a pair of polarizing plates arranged on both sides of the liquid crystal cell,
wherein the pair of the polarizing plates are the polarizing plates according to claim 19.

24. A liquid crystal display device of IPS, OCR or VA mode, comprising
a liquid crystal cell; and
a pair of polarizing plates arranged on both sides of the liquid crystal cell,
wherein the pair of the polarizing plates are the polarizing plates according to claim 20.

25. A liquid crystal display device of VA mode, comprising the polarizing plate according to claim 19 on a backlight side.

26. A liquid crystal display device of VA mode, comprising the polarizing plate according to claim 20 on a backlight side.
